(19) United States
(12) Patent Application Publication
(10) Pub. No.: US 2020/0271247 A1
(43) Pub. Date: Aug. 27, 2020

(54) STEEL SHEET, TAILORED BLANK, HOT STAMPED PRODUCT, STEEL PIPE, HOLLOW HOT STAMPED PRODUCT, METHOD OF MANUFACTURING STEEL SHEET, METHOD OF MANUFACTURING TAILORED BLANK, METHOD OF MANUFACTURING HOT STAMPED PRODUCT, METHOD OF MANUFACTURING STEEL PIPE, AND METHOD OF MANUFACTURING HOLLOW HOT STAMPED PRODUCT

(71) Applicant: NIPPON STEEL CORPORATION, Tokyo (JP)

(72) Inventors: Hiroki FUJIMOTO, Tokyo (JP); Masanori YASUYAMA, Tokyo (JP); Yujiro TATSUMI, Tokyo (JP); Tasuku ZENIYA, Tokyo (JP); Hiroshi FUKUCHI, Tokyo (JP); Yuki SUZUKI, Tokyo (JP); Soshi FUJITA, Tokyo (JP); Shintaro KOBAYASHI, Tokyo (JP)

(73) Assignee: NIPPON STEEL CORPORATION, Tokyo (JP)

(21) Appl. No.: 16/758,244

(22) PCT Filed: Nov. 8, 2018
(86) PCT No.: PCT/JP2018/041553

§ 371 Date: Apr. 22, 2020

(30) Foreign Application Priority Data
Nov. 8, 2017 (JP) 2017-215747
Sep. 6, 2018 (JP) 2018-167169
Oct. 26, 2018 (JP) 2018-202087

(51) Int. Cl. F16L 9/17; B32B 15/01; C22C 38/38; C22C 38/32; C22C 38/28; C22C 38/02; C22C 38/06; C22C 38/00; C21D 9/08; C21D 6/00; F16L 13/02; B21D 35/00

(52) U.S. Cl. CPC F16L 9/17; B23K 2103/18; C22C 38/38; C22C 38/32; C22C 38/28; C22C 38/02; C22C 38/06; C22C 38/002; C22C 38/001; C21D 9/08; C21D 6/008; C21D 6/005; C21D 6/002; F16L 13/02; B21D 35/001; B32B 15/012

(57) ABSTRACT

This steel sheet includes a first coated portion in which an intermetallic compound layer and an aluminum coating layer are provided on a surface of a base steel sheet in order from the base steel sheet, the first exposed portion in which the base steel sheet is exposed, and a second coated portion in which the intermetallic compound layer and the aluminum coating layer are provided on the surface of the base steel sheet in order from the base steel sheet, in which in a first direction which is perpendicular to a thickness direction of the steel sheet and is directed from the first coated portion to one end edge of the steel sheet, the first coated portion, the first exposed portion, the second coated portion, and the end edge of the steel sheet are disposed in this order on at least one surface of the base steel sheet, and wherein at least the first coated portion, the first exposed portion, and the end edge of the steel sheet are disposed in this order on the other surface of the base steel sheet in the first direction.

### TECHNICAL FIELD OF THE INVENTION

The present invention relates to a steel sheet, a tailored blank, a hot stamped product, a steel pipe, a hollow hot stamped product, a method of manufacturing a steel sheet, a method of manufacturing a tailored blank, a method of manufacturing a hot stamped product, a method of manufacturing a steel pipe, and a method of manufacturing a hollow hot stamped product.

The present application claims the priority based on Japanese Patent Application No. 2017-215747, filed on Nov. 8, 2017, Japanese Patent Application No. 2018-167169, filed on Sep. 6, 2018, and Japanese Patent Application No. 2018-202087, filed on Oct. 26, 2018, the contents of which are incorporated herein by reference.

### RELATED ART

In recent years, in order to protect the global environment by reducing the emission amount of CO₂ gas, in the automotive field, the weight reduction of vehicle bodies has been an urgent problem. In order to solve this problem, studies on the application of high strength steel sheets have been actively carried out. The strength of steel sheets (coated steel sheets) has been gradually increasing.

As one of techniques for forming vehicle members, hot pressing (hereinafter sometimes referred to as “hot stamping”) has attracted attention. In hot stamping, a steel sheet is heated to a high temperature and is press-formed in a temperature range of Ara transformation temperature or higher. Further, in the hot stamping, the press-formed steel sheet is rapidly cooled through heat transfer using a die, and transformation is caused simultaneously with forming in a state of application of a pressing pressure. The hot stamping is a technique capable of manufacturing a hot stamped product (hereinafter, sometimes referred to as “hot-stamping formed article”) having high strength and excellent shape fixability by the above steps.

In addition, in order to improve the yield and functionality of press-formed articles for vehicle members, a tailored blank obtained by butting the end surfaces of at least two steel sheets and joining the end surfaces of the steel sheets by laser welding, plasma welding, or the like is suitably applied as a material for pressing. Since a plurality of steel sheets are joined according to the purpose in the tailored blank, the use of the tailored blank enables free change in the sheet thickness or the strength in a single product. As a result, the functionality of the vehicle member can be improved and the number of parts in the vehicle member can be reduced by using the tailored blank. In addition, it is possible to manufacture a high strength press-formed article in which the sheet thickness, strength, and the like are freely changed by performing hot stamping on the tailored blank.

In a case where a vehicle member is formed by hot stamping using a tailored blank as a material for pressing, the tailored blank is heated in a temperature range of, for example, 800° C. to 1000° C. Therefore, as the tailored blank for hot stamping, a coated steel sheet coated with an aluminum coating such as Al—Si having a high coating boiling point is often used.

Until now, as a steel sheet for forming a tailored blank, for example, a steel sheet for butt welding having a coating layer has been studied in various ways (for example, refer to Patent Documents 1 to 5).

Steel sheets for butt welding disclosed in Patent Documents 1 to 5 each have a base steel sheet, an aluminum coating layer provided on both surfaces of the base steel sheet, and an intermetallic compound layer formed between the base steel sheet and the aluminum coating layer.

In the steel sheet for butt welding disclosed in Patent Document 1, the aluminum coating layer is removed in a predetermined range from the end edge of the steel sheet for butt welding, and the intermetallic compound layer remains in the predetermined range. Then, a first coated portion in which the intermetallic compound layer and the aluminum coating layer are provided on the base steel sheet is formed adjacent to the predetermined range. The aluminum coating layer is removed using laser processing.

In the steel sheets for butt welding disclosed in Patent Documents 2 and 4, the aluminum coating layer and the intermetallic compound layer in the predetermined range are removed by a brush or laser processing.

In the steel sheet for butt welding disclosed in Patent Document 3, since a flat notch surface is formed on the steel sheet for butt welding, the thickness is gradually reduced from the middle portion of the steel sheet for butt welding to the end edge of the steel sheet for butt welding such that the thickness of the aluminum coating layer is first reduced and subsequently, the thickness of the intermetallic compound layer is reduced. As a result, at the end edge of the steel sheet for butt welding, the base steel sheet is exposed to the outside.

In the steel sheet for butt welding disclosed in Patent Document 5, the aluminum coating layer and the intermetallic compound layer are removed such that an angle β formed between the normal line of the surface of the base steel sheet and the end surface of the aluminum coating layer and the intermetallic compound layer is 0° to 80°. At the end edge of the steel sheet for butt welding, the base steel sheet is exposed to the outside. The aluminum coating layer and the intermetallic compound layer are removed using laser processing.

In this kind of steel sheet for butt welding, the end portions from which the predetermined range is removed in the steel sheet for butt welding are butt-welded to manufacture a tailored blank, a steel pipe, and the like. The tailored blank is processed into a hot stamped product, a hollow hot stamped product, and the like.

For example, paragraph [0062] of Patent Document 1 discloses that a welded semi-processed article has corrosion resistance after a heat treatment.

### PRIOR ART DOCUMENT

### [Patent Document]

[Patent Document 1] Published Japanese Translation No. 2009-534529 of the PCT International Publication

[Patent Document 2] Published Japanese Translation No. 2015-525677 of the PCT International Publication

[Patent Document 3] Published Japanese Translation No. 2015-523210 of the PCT International Publication

[Patent Document 4] Published Japanese Translation No. 2015-536246 of the PCT International Publication

[Patent Document 5] Chinese Patent Application, Publication No. 106334875

### DISCLOSURE OF THE INVENTION

### Problems to be Solved by the Invention

However, when a tailored blank is formed of a hot-dip aluminum coated steel sheet, a hard and brittle intermetallic compound layer exists in the coating layer and thus there is an influence of the intermetallic compound layer remaining at the boundary (stress concentration portion) between a weld metal portion and a welded heat-affected zone. Therefore, when a hot stamped product formed using the tailored blank receives a repeated load, the fatigue strength of the weld metal portion is deteriorated. Further, when a large amount of Al in the hot-dip aluminum coated steel sheet is dispersed into the weld metal portion, the corrosion resistance is deteriorated, which is a problem.

On the other hand, in the steel sheets for butt welding in Patent Documents 2 to 5, the aluminum coating layer and the intermetallic compound layer in a welding scheduled portion to be welded are removed. Therefore, when coating is performed on a hot stamped product manufactured from the steel sheet for butt welding, the adhesion of a coating to the surface of the weld metal portion is deteriorated, and the corrosion resistance of the weld metal portion after coating is deteriorated.

An object of the present invention is to provide a steel sheet for butt welding in which deterioration in fatigue strength is suppressed while maintaining the corrosion resistance after coating of a weld metal portion formed during butt welding, a tailored blank, a hot stamped product, a steel pipe, a hollow hot stamped product, a method of manufacturing a steel sheet for butt welding, a method of manufacturing a tailored blank, a method of manufacturing a hot stamped product, a method of manufacturing a steel pipe, and a method of manufacturing a hollow hot stamped product.

### Means for Solving the Problem

Means for solving the above problems include the following aspects.

<1> A steel sheet including: a first coated portion in which an intermetallic compound layer and an aluminum coating layer are provided on a surface of a base steel sheet in order from the base steel sheet; a first exposed portion in which the base steel sheet is exposed; and a second coated portion in which the intermetallic compound layer and the aluminum coating layer are provided on a surface of the base steel sheet in order from the base steel sheet, wherein in a first direction which is perpendicular to a thickness direction of the steel sheet and is directed from the first coated portion to one end edge of the steel sheet, the first coated portion, the first exposed portion, the second coated portion, and the end edge of the steel sheet are disposed in this order on at least one surface of the base steel sheet, and wherein at least the first coated portion, the first exposed portion, and the end edge of the steel sheet are disposed in this order on the other surface of the base steel sheet in the first direction.

<2> The steel sheet according to <1>, in which the first coated portion, the first exposed portion, the second coated portion, and the end edge of the steel sheet are disposed in this order on the other surface of the base steel sheet in the first direction.

<3> The steel sheet according to <1> or <2>, in which in the first direction, the second coated portion exists in a range of 0.5 mm from the end edge of the steel sheet.

<4> The steel sheet according to any one of <1> to <3>, in which the base steel sheet includes, as a chemical composition, % by mass, C: 0.02% to 0.58%, Mn: 0.20% to 3.00%, Al: 0.005% to 0.20%, Ti: 0% to 0.20%, Nb: 0% to 0.20%, V: 0% to 1.0%, W: 0% to 1.0%, Cr: 0% to 1.0%, Mo: 0% to 1.0%, Cu: 0% to 1.0%, Ni: 0% to 1.0%, B: 0% to 0.0100%, Mg: 0% to 0.05%, Ca: 0% to 0.05%, REM: 0% to 0.05%, Bi: 0% to 0.05%, Si: 0% to 2.00%, P: 0.03% or less, S: 0.010% or less, N: 0.010% or less, and a remainder: Fe and impurities.

<5> The steel sheet according to any one of <1> to <4>, in which an average thickness of the aluminum coating layer at the first coated portion is 8 μm to 40 μm, and an average thickness of the intermetallic compound layer at the first coated portion is 3 μm to 10 μm.

<6> The steel sheet according to any one of <2> to <4>, in which the second coated portion is provided on only one surface of the steel sheet, and a width c μm of the second coated portion in the first direction and a thickness f μm of the aluminum coating layer in the second coated portion satisfy Expression (1).

385.48f^{-0.914}≤c≤500 (1)

<7> The steel sheet according to any one of <2> to <4>, in which the second coated portion is provided on each of both surfaces of the steel sheet, and a width of c μm of the second coated portion in the first direction and a thickness of f μm of the aluminum coating layer in the second coated portion satisfy Expression (2).

359.65f^{-1.129}≤c≤9368f^{-0.904} (2)

<8> The steel sheet according to any one of <1> to <7>, in which in the first direction, a width of the second coated portion is smaller than a width of the first exposed portion.

<9> The steel sheet according to any one of <1> to <8>, in which the second coated portion is provided in a lower region on the surface of the base steel sheet located on an inner side of the base steel sheet in a thickness direction from a virtual plane obtained by extending a surface of the first exposed portion in the first direction.

<10> The steel sheet according to any one of <1> to <9>, in which the end edge of the steel sheet and the second coated portion are adjacent to each other in the first direction.

<11> The steel sheet according to any one of <1> to <9>, in which in the first direction, a second exposed portion in which the base steel sheet is exposed is provided between the end edge of the steel sheet and the second coated portion.

<12> The steel sheet according to <11>, in which in the first direction, a width of the second exposed portion is smaller than a width of the first exposed portion.

<13> The steel sheet according to <11> or <12>, in which in the first direction, a width of the second exposed portion is 0.01 mm or more, and a width of the first exposed portion is 0.05 mm or more.

<14> A tailored blank including: a first weld metal portion; and at least two steel sheet portions connected to each other through the first weld metal portion, in which each of the at least two steel sheet portions includes a first coated portion in which an intermetallic compound layer and an aluminum coating layer are provided on a surface of a base steel sheet in order from the base steel sheet, and a first exposed portion in which the base steel sheet is exposed, and wherein in each of the steel sheet portions, in a second direction which is perpendicular to a thickness direction of each steel sheet portion and is directed from the first coated portion to the first weld metal portion, the first coated portion, the first exposed portion, and the first weld metal portion are disposed in this order on the same plane on both surfaces of the base steel sheet.

<15> The tailored blank according to <14>, in which a concentration of aluminum contained in the first weld metal portion is 0.05% by mass to 1% by mass.

<16> A hot stamped product including: a first intermetallic compound portion in which a first intermetallic compound layer is provided on a surface of a first base steel sheet; a third exposed portion in which the first base steel sheet is exposed; a second weld metal portion in which a concentration of aluminum contained is 0.05% by mass to 1% by mass; a fourth exposed portion in which a second base steel sheet is exposed; and a second intermetallic compound portion in which a second intermetallic compound layer is provided on a surface of the second base steel sheet, in which the first intermetallic compound portion, the third exposed portion, the second weld metal portion, the fourth exposed portion, and the second intermetallic compound portion are disposed in this order along the surface of the first base steel sheet and the surface of the second base steel sheet.

<17> A steel pipe including: a third weld metal portion; and a third steel sheet which is formed in an open tubular shape in which two end portions in a circumferential direction face each other, and in which the two end portions are connected to each other through the third weld metal portion, in which each of the two end portions of the third steel sheet includes a first coated portion in which an intermetallic compound layer and an aluminum coating layer are provided on both surfaces of a base steel sheet in order from the base steel sheet, and a first exposed portion in which the base steel sheet is exposed, and wherein in the circumferential direction, the first coated portion, the first exposed portion, and the third weld metal portion are disposed in this order.

<18> The steel pipe according to <17>, in which a concentration of aluminum contained in the third weld metal portion is 0.05% by mass to 1% by mass.

<19> A hollow hot stamped product including: a third intermetallic compound portion in which a third intermetallic compound layer is provided on a surface of a third base steel sheet; a fifth exposed portion in which the third base steel sheet is exposed; a third weld metal portion in which a concentration of aluminum contained is 0.05% by mass to 1% by mass, a sixth exposed portion in which a fourth base steel sheet is exposed, and a fourth intermetallic compound portion in which a fourth intermetallic compound layer is provided on a surface of the fourth base steel sheet, in which the third intermetallic compound portion, the fifth exposed portion, the third weld metal portion, the sixth exposed portion, and the fourth intermetallic compound portion are disposed in this order along each of both surfaces of the third base steel sheet and each of both surfaces of the fourth base steel sheet.

<20> A method of manufacturing a steel sheet for manufacturing a steel sheet, the method comprising: performing a coated steel sheet production step of manufacturing a coated steel sheet in which an intermetallic compound layer and an aluminum coating layer are provided on a surface of a base steel sheet in order from the base steel sheet; and a removal step of forming a first exposed portion in which the base steel sheet is exposed by removing a part of the aluminum coating layer and the intermetallic compound layer, a first coated portion in which the intermetallic compound layer and the aluminum coating layer remain on a surface of the base steel sheet in order from the base steel sheet, and a second coated portion in which the intermetallic compound layer and the aluminum coating layer remain on a surface of the base steel sheet, in which in the removal step, in a first direction which is perpendicular to a thickness direction of the coated steel sheet and is directed from a center portion of the coated steel sheet to one end edge of the coated steel sheet in plan view, the first coated portion, the first exposed portion, the second coated portion, and the end edge of the coated steel sheet are disposed in this order on at least one surface of the base steel sheet, and wherein in the first direction, at least the first coated portion, the first exposed portion, and the end edge of the coated steel sheet are disposed in this order on the other surface of the base steel sheet.

<21> The method of manufacturing a steel sheet according to <20>, in which in the removal step, in the first direction, the first coated portion, the first exposed portion, the second coated portion, and the end edge of the coated steel sheet are disposed on the other surface of the base steel sheet in this order.

<22> The method of manufacturing a steel sheet according to <20> or <21>, in which in the removal step, a step of mechanically removing the aluminum coating layer and the intermetallic compound layer is performed.

<23> The method of manufacturing a steel sheet according to <22>, in which in the step of the mechanically removing the aluminum coating layer and the intermetallic compound layer, an elimination step of eliminating the aluminum coating layer and the intermetallic compound layer by cutting or grinding is performed.

<24> The method of manufacturing a steel sheet according to <23>, in which in the elimination step, the aluminum coating layer and the intermetallic compound layer are removed by cutting using an end mill.

<25> The method of manufacturing a steel sheet according to <23> or <24>, in which in the step of the mechanically removing the aluminum coating layer and the intermetallic compound layer, before the elimination step, a lower portion forming step of forming a lower region on a surface of the base steel sheet of the coated steel sheet by deforming a part of the coated steel sheet by cutting or compressing the coated steel sheet is performed, wherein when a direction which is perpendicular to a thickness direction of the coated steel sheet and is directed from a center portion of the coated steel sheet to one end edge of the coated steel sheet in plan view is set to a first direction, the lower region is a region located on an inner side of the base steel sheet in the thickness direction of the coated steel sheet from a virtual plane obtained by extending a surface of an undeformed portion of the base steel sheet in the first direction, and wherein in the elimination step, at least the aluminum coating layer and the intermetallic compound layer existing on an outer side of the coated steel sheet in the thickness direction from the virtual plane are cut to form the second coated portion on the lower region.

<26> The method of manufacturing a steel sheet according to <25>, in which when a thickness per one surface of the aluminum coating layer is a μm, a thickness per one surface of the intermetallic compound layer is b μm, a thickness of the coated steel sheet is t μm, a deepest lower portion depth of the lower region is x the lower portion depth represents a distance from the virtual plane to the surface of the base steel sheet in the lower region, a depth of a region cut in the elimination step in the thickness direction of the coated steel sheet is y μm, and a distance between the first coated portion and the second coated portion is N μm, Expressions (5) to (9) are satisfied.

10≤a+b<50 (5)

2%≤(x/t)≤15% (6)

a+b<y (7)

(y/t)≤7% (8)

N≥200 (9)

<27> The method of manufacturing a steel sheet according to <25> or <26>, in which in the lower portion forming step, the coated steel sheet is cut by shearing or blanking to form the lower region.

<28> The method of manufacturing a steel sheet according to any one of <25> to <27>, in which in the lower portion forming step, the lower region is formed on each of both surfaces of the coated steel sheet.

<29> A method of manufacturing a tailored blank for manufacturing a tailored blank including at least two steel sheets, at least one of which is the steel sheet according to any one of <1> to <13>, and obtained by butt-welding the at least two steel sheets and connecting the at least two steel sheets through a first weld metal portion, the method including: butt-welding end edges having the second coated portion in the steel sheets, which are the steel sheets, to incorporate the entire second coated portion incited during butt welding in the first weld metal portion.

<30> A method of manufacturing a hot stamped product including: hot press-forming the tailored blank according to <14> or <15> to form a hot stamped product.

<31> A method of manufacturing a steel pipe including: forming the steel sheet according to any one of <1> to <13> into an open tubular shape such that two end portions in a circumferential direction face to each other and the second coated portion is disposed in at least one of the two end portions; and butt-welding the two end portions of the steel sheet to connect the two end portions through a second weld metal portion to incorporate the entire second coated portion melted during butt welding in the second weld metal portion.

<32> A method of manufacturing a hollow hot stamped product including: quenching the steel pipe according to <17> or <18> to manufacture a hollow hot stamped product.

### Effects of the Invention

According to the steel sheet for butt welding, the tailored blank, the hot stamped product, the steel pipe, the hollow hot stamped product, the method of manufacturing a steel sheet for butt welding, the method of manufacturing a tailored blank, the method of manufacturing a hot stamped product, the method of manufacturing a steel pipe, and the method of manufacturing a hollow hot stamped product, it is possible to suppress deterioration in fatigue strength while maintaining corrosion resistance after coating of a weld metal portion formed during butt welding.

### BRIEF DESCRIPTION OF THE DRAWINGS

FIG. 1 is a schematic cross-sectional view showing an example of an end portion having a first exposed portion and a second coated portion of a base steel sheet in a steel sheet for butt welding according to a first embodiment of the present disclosure.

FIG. 2 is a schematic cross-sectional view showing another example of the end portion having the first exposed portion and the second coated portion of the base steel sheet in the steel sheet for butt welding according to the first embodiment of the present disclosure.

FIG. 3 is a schematic cross-sectional view showing still another example of the end portion having the first exposed portion and the second coated portion of the base steel sheet in the steel sheet for butt welding according to the first embodiment of the present disclosure.

FIG. 4 is a cross-sectional image showing an example of the end portion having the first exposed portion and the second coated portion of the base steel sheet in the steel sheet for butt welding according to the first embodiment of the present disclosure.

FIG. 5 is a perspective view of a steel pipe according to the first embodiment of the present disclosure.

FIG. 6 is a schematic plan view showing a method of manufacturing the steel pipe according to the first embodiment of the present disclosure.

FIG. 7 is a schematic perspective view showing the method of manufacturing the steel pipe according to the first embodiment of the present disclosure.

FIG. 8 is a schematic cross-sectional view showing a state in which the two steel sheets for butt welding according to the first embodiment of the present disclosure face each other.

FIG. 9 is a schematic cross-sectional view showing a tailored blank according to the first embodiment of the present disclosure.

FIG. 10 is a view showing a trial calculation result of a concentration of aluminum contained in a first weld metal portion with respect to the width of a second coated portion.

FIG. 11 is a view showing the relationship between the width of the second coated portion and the concentration of aluminum contained in the first weld metal portion in a case where the thickness of an aluminum coating layer provided with the second coated portion formed on only one surface is 13 μm.

FIG. 12 is a view showing the relationship between the thickness of the aluminum coating layer and the width of the second coated portion for setting the concentration of aluminum contained in the first weld metal portion to 0.05% by mass and 1% by mass in a case where the second coated portion is formed on only one surface.

FIG. 13 is a view showing the relationship between the thickness of the aluminum coating layer and the width of the second coated portion for setting the concentration of aluminum contained in the first weld metal portion to 0.05% by mass and 1% by mass in a case where the second coated portion is formed on both surfaces.

FIG. 14 is a cross-sectional image showing an example of a tailored blank after hot press forming.

FIG. 15 is a schematic cross-sectional view showing an example of an end portion having an exposed portion and a second coated portion of a base steel sheet in a steel sheet for butt welding according to a second embodiment of the present disclosure.

FIG. 16 is a schematic cross-sectional view showing another example of the end portion having the exposed portion and the second coated portion of the base steel sheet in the steel sheet for butt welding according to the second embodiment of the present disclosure.

FIG. 17 is a schematic cross-sectional view showing still another example of the end portion having the exposed portion and the second coated portion of the base steel sheet in the steel sheet for butt welding according to the second embodiment of the present disclosure.

FIG. 18 is a cross-sectional image showing an example of the end portion having the exposed portion and the second coated portion of the base steel sheet in the steel sheet for butt welding according to the second embodiment of the present disclosure.

FIG. 19 is a schematic enlarged cross-sectional view showing another example of the end portion having the exposed portion and the second coated portion of the base steel sheet in the steel sheet for butt welding according to the second embodiment of the present disclosure.

FIG. 20 is a schematic cross-sectional view showing an example of a tailored blank according to the second embodiment of the present disclosure.

FIG. 21 is a schematic cross-sectional view showing an example of a tailored blank manufactured by a method of manufacturing a tailored blank according to a third embodiment of the present disclosure.

FIG. 22 is a schematic cross-sectional view showing an example of a steel sheet for butt welding used in the method of manufacturing the tailored blank according to the third embodiment of the present disclosure.

FIG. 23 is a flow chart showing the method of manufacturing the tailored blank according to the third embodiment of the present disclosure.

FIG. 24 is a cross-sectional view explaining a lower portion forming step in the method of manufacturing the tailored blank according to the third embodiment of the present disclosure.

FIG. 25 is a cross-sectional view explaining the lower portion forming step in the method of manufacturing the tailored blank according to the third embodiment of the present disclosure.

FIG. 26 is a cross-sectional image showing an example of a state in which a lower region is formed in a coated steel sheet according to the third embodiment of the present disclosure.

FIG. 27 is a cross-sectional image showing an example of a state in which a first exposed portion and a second coated portion are formed in a steel sheet for butt welding according to the third embodiment of the present disclosure.

FIG. 28 is a cross-sectional image showing an example of a state in which the first exposed portion and the second coated portion are formed in the steel sheet for butt welding according to the third embodiment of the present disclosure.

FIG. 29 is a cross-sectional view explaining a lower portion forming step in a method of manufacturing the tailored blank according to a modification example of the third embodiment of the present disclosure.

FIG. 30 is a cross-sectional view explaining a cutting step in the method of manufacturing the tailored blank according to the modification example of the third embodiment of the present disclosure.

FIG. 31 is a cross-sectional view explaining a lower portion forming step in the method of manufacturing the tailored blank according to the modification example of the third embodiment of the present disclosure.

FIG. 32 is a cross-sectional view explaining a lower portion forming step in the method of manufacturing the tailored blank according to the modification example of the third embodiment of the present disclosure.

FIG. 33 is a cross-sectional view explaining the cutting step in the method of manufacturing the tailored blank according to the modification example of the third embodiment of the present disclosure.

FIG. 34 is a flow chart showing a method of manufacturing a tailored blank according to a modification example of the third embodiment of the present disclosure.

FIG. 35 is a perspective view of the steel sheet for butt welding according to the first embodiment of the present disclosure.

FIG. 36 is a perspective view explaining steps of the method of manufacturing the steel sheet for butt welding according to the first embodiment of the present disclosure.

FIG. 37 is a perspective view explaining other steps of the method of manufacturing the steel sheet for butt welding according to the first embodiment of the present disclosure.

(A) of FIG. 38 is a schematic cross-sectional view of the end portion of the steel sheet for butt welding according to the second embodiment of the present disclosure and (B) of FIG. 38 is a plan view thereof.

FIG. 39 is a schematic cross-sectional view explaining steps of forming the exposed portion and the second coated portion in the steel sheet for butt welding according to the second embodiment of the present disclosure.

### EMBODIMENTS OF THE INVENTION

Hereinafter, an example of a preferable embodiment of the present disclosure will be described in detail.

A steel sheet according to the present disclosure refers to a steel sheet for forming a tailored blank obtained by butt-welding the steel sheet and another steel sheet and is described as a steel sheet for butt welding below.

In the present specification, a numerical range expressed using “to” means a range including numerical values described before and after “to” as the lower limit value and the upper limit value.

In the present specification, regarding the content of a component (element), for example, in a case of C (carbon) content, C content may be expressed as “amount of C”. Moreover, the content of another element may be expressed similarly.

In the present specification, the meaning of the term “step” is not limited to an independent step, but is included in the meaning of the term when the intended purpose of the step is achieved even in a case where the step cannot be clearly distinguished from other steps.

In the present disclosure, the terms “base steel sheet”, “intermetallic compound layer”, and “aluminum coating layer” are described in “Definitions of Ranges of Base Steel Sheet, Intermetallic Compound Layer, and Aluminum Coating Layer”, which will be described in a first embodiment later.

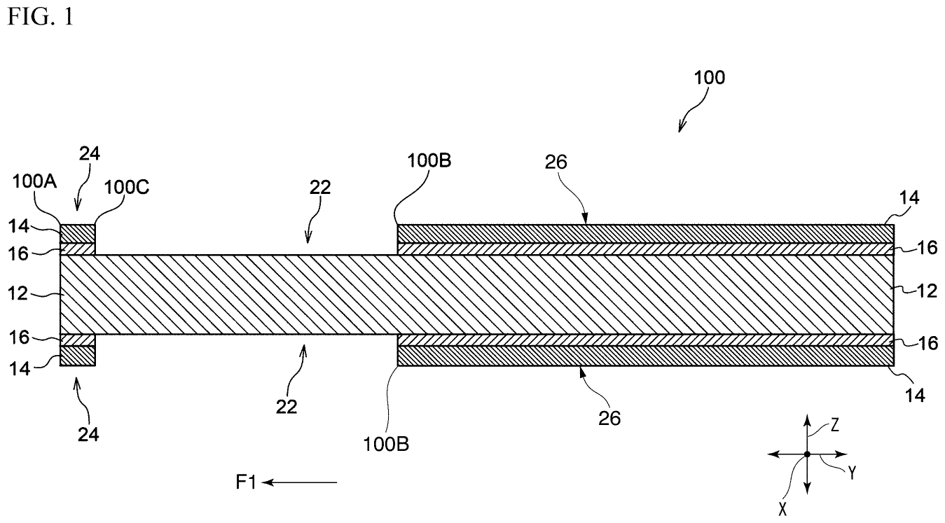

In the present disclosure, the term “cross section” of a steel sheet for butt welding (steel sheet) means a cross section obtained by cutting the steel sheet for butt welding in the thickness (sheet thickness) direction. Specifically, in FIG. 1, a thickness direction of a steel sheet for butt welding 100 is set to Z, and a direction in which a first exposed portion 22 extends (a direction orthogonal to a display surface in FIG. 1) is X. A direction orthogonal to the direction Z and the direction X is Y. At this time, the cross section means a cross section cut along a YZ plane.

In the present disclosure, the term “end surface” of the steel sheet for butt welding means a surface in which a surface in the thickness direction is exposed between surfaces facing the thickness direction side of the steel sheet for butt welding.

In the present disclosure, the term “end edge” of the steel sheet for butt welding means a portion adjacent to the end surface of the steel sheet for butt welding.

In the present disclosure, the term “end portion” of the steel sheet for butt welding is a region located around the steel sheet for butt welding, and is a region in a range of 5% or less from the end surface of the steel sheet for butt welding with respect to a facing width of the steel sheet for butt welding (that is, from the facing end edge to the end edge).

The steel sheet for butt welding of the present disclosure forms a tailored blank by butt-welding the end surface of the end portion thereof and the end surface of another steel sheet for butt welding. Here, an embodiment of two steel sheets for butt welding to be butt-welded may adopt any one of a plurality of embodiments described below.

### First Embodiment

<Steel Sheet for Butt Welding>

The steel sheet for butt welding of the present disclosure has a base steel sheet, an intermetallic compound layer, and an aluminum coating layer. The steel sheet for butt welding of the present disclosure has a first coated portion in which the intermetallic compound layer and the aluminum coating layer are provided on the surface of the base steel sheet in order from the base steel sheet (side). In addition, the steel sheet for butt welding of the present disclosure has a first exposed portion in which the base steel sheet is exposed. In addition, the steel sheet for butt welding of the present disclosure has a second coated portion in which the intermetallic compound layer and the aluminum coating layer are provided on the surface of the base steel sheet in order from the base steel sheet side.

Here, a direction (Y direction) which is perpendicular to the thickness direction of the steel sheet for butt welding and is directed from the first coated portion to one end edge of the steel sheet for butt welding is set to a first direction. In the steel sheet for butt welding of the present disclosure, in the first direction, the first coated portion, the first exposed portion, the second coated portion, and the end edge of the steel sheet for butt welding are provided on at least one surface of the base steel sheet such that the first coated portion, the first exposed portion, the second coated portion, and the end edge of the steel sheet for butt welding are disposed in this order. In addition, in the steel sheet for butt welding of the present disclosure, in the first direction, at least the first coated portion, the first exposed portion, and the end edge of the steel sheet for butt welding are disposed on the other surface of the base steel sheet in this order.

It is preferable that the first coated portion, the first exposed portion, the second coated portion, and the end edge of the steel sheet for butt welding are disposed in this order on the other surface of the base steel sheet in the first direction.

The steel sheet for butt welding of the present disclosure is formed into a tailored blank by butt-welding the end surface of the end portion thereof and the end surface of another steel sheet. The shape of the steel sheet for butt welding is not particularly limited.

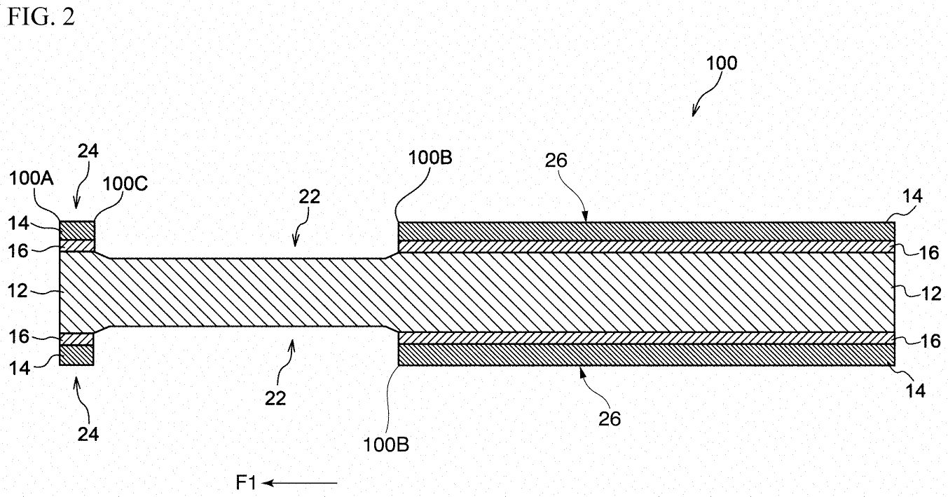

FIG. 1 is a schematic cross-sectional view showing an example of an end portion having a first coated portion, a first exposed portion of a base steel sheet, and a second coated portion in which an intermetallic compound layer and an aluminum coating layer are provided on each of both surfaces of the steel sheet for butt welding of the present disclosure. FIG. 2 is a schematic cross-sectional view showing another example of the end portion having the first coated portion, the first exposed portion of the base steel sheet, and the second coated portion in which an intermetallic compound layer and an aluminum coating layer are provided on each of both surfaces of the steel sheet for butt welding of the present disclosure. That is, in FIGS. 1 and 2, an embodiment in which each of both surfaces of the steel sheet for butt welding has the first coated portion, the first exposed portion, and the second coated portion, and an intermetallic compound layer and an aluminum coating layer are provided in the second coated portion is shown.

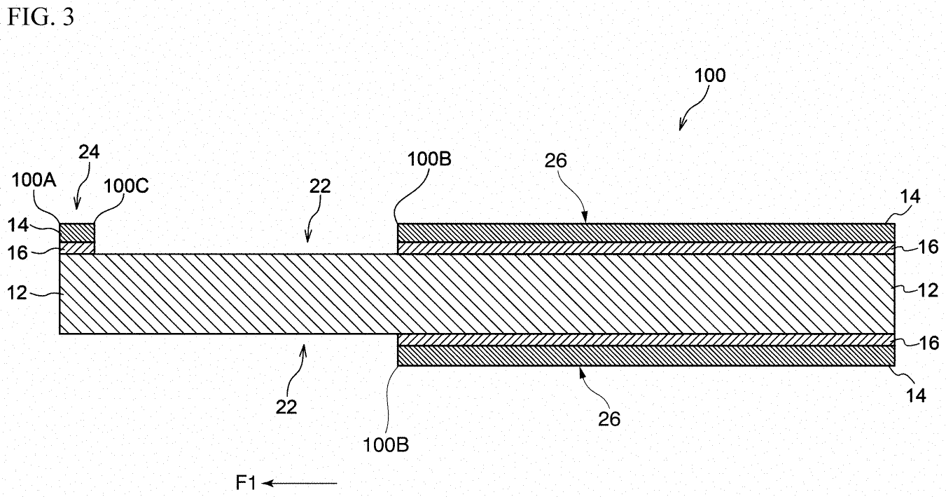

In addition, FIG. 3 is a schematic cross-sectional view showing one example of an end portion in which the first coated portion, the first exposed portion of the base steel sheet, and the second coated portion in which an intermetallic compound layer and an aluminum coating layer are provided are provided on one surface of the steel sheet for butt welding of the present disclosure, and the first coated portion and the first exposed portion are provided on the other surface. That is, in FIG. 3, an embodiment in which one surface of the steel sheet for butt welding has the first coated portion, the first exposed portion, and the second coated portion, and an intermetallic compound layer and an aluminum coating layer are provided in the second coated portion. Further, in the end portion on the other surface of the steel sheet for butt welding shown in FIG. 3, the first coated portion and the first exposed portion are provided. However, the second coated portion is not provided, and the first exposed portion extends to the end edge of the end portion.

In FIGS. 1 to 3, 100 represents a steel sheet for butt welding, 12 represents a base steel sheet, 14 represents an aluminum coating layer, 16 represents an intermetallic compound layer, 22 represents a first exposed portion, 24 represents a second coated portion, and 26 represents a first coated portion.

In addition, 100A represents an end edge of the steel sheet for butt welding 100. 100B represents an end edge of a first coated portion 26 on the boundary between the first coated portion 26 and the first exposed portion 22. 100C represents an end edge of the second coated portion 24 on the boundary between the second coated portion 24 and the first exposed portion 22.

The steel sheet for butt welding 100 of the present disclosure has the base steel sheet 12, the intermetallic compound layer 16, and the aluminum coating layer 14. The steel sheet for butt welding 100 of the present disclosure has the first coated portion 26 in which the intermetallic compound layer 16 and the aluminum coating layer 14 are provided on the surface of the base steel sheet 12 in order from the base steel sheet 12 side. In addition, the steel sheet for butt welding 100 of the present disclosure has the first exposed portion 22 in which the base steel sheet 12 is exposed. In addition, the steel sheet for butt welding 100 of the present disclosure has the second coated portion 24 in which the intermetallic compound layer 16 and the aluminum coating layer 14 are provided on the surface of the base steel sheet 12.

Here, a direction which is perpendicular to the thickness direction of the steel sheet for butt welding 100 and is directed from the first coated portion 26 to one end edge 100A of the steel sheet for butt welding 100 is set to a first direction F1. In the steel sheet for butt welding 100 of the present disclosure, in the first direction F1, the first coated portion 26, the first exposed portion 22, the second coated portion 24, and the end edge 100A of the steel sheet for butt welding 100 are provided such that the first coated portion 26, the first exposed portion 22, the second coated portion 24, and the end edge 100A of the steel sheet for butt welding 100 are disposed in this order on the same surface.

The first exposed portion 22 is formed in a region from an end edge 100B of the first coated portion 26 to an end edge 100C at the boundary between the second coated portion 24 and the first exposed portion 22. The first exposed portion 22 is formed between the first coated portion 26 and the second coated portion 24.

The second coated portion 24 is formed in a region including the end edge 100A of the steel sheet for butt welding 100. In the first direction F1, the end edge 100A of the steel sheet for butt welding 100 and the second coated portion 24 are adjacent to each other. The second coated portion 24 is formed in a region from the end edge 100A of the steel sheet for butt welding 100 to the end edge 100C at the boundary between the second coated portion 24 and the first exposed portion 22.

In the steel sheet for butt welding 100 shown in FIGS. 1 and 2, the second coated portion 24, the first exposed portion 22, and the first coated portion 26 are formed on both surfaces of the end portion of the steel sheet for butt welding 100.

On the other hand, in the steel sheet for butt welding 100 shown in FIG. 3, the second coated portion 24, the first exposed portion 22, and the first coated portion 26 are formed on one surface of the end portion of the steel sheet for butt welding 100, and the first exposed portion 22 and the first coated portion 26 are formed on the other surface of the end portion. That is, in the steel sheet for butt welding 100 shown in FIG. 3, on one surface of the end portion of the steel sheet for butt welding 100, similar to the steel sheet for butt welding 100 shown in FIGS. 1 and 2, the second coated portion 24 and the first exposed portion 22 are formed. In addition, on the other surface of the end portion of the steel sheet for butt welding 100, the first exposed portion 22 is formed in a region from the end edge 100A of the steel sheet for butt welding 100 to the end edge 100B of the first coated portion 26.

In the steel sheet for butt welding 100 of the present disclosure, as shown in FIG. 1, in the end portion of the steel sheet for butt welding 100, the thickness of the base steel sheet 12 in the first exposed portion 22 in which the base steel sheet 12 is exposed may be the same as the thickness of the base steel sheet 12 in the first coated portion 26. In addition, in the steel sheet for butt welding 100 of the present disclosure, as shown in FIG. 2, in the end portion of the steel sheet for butt welding 100, the thickness of the base steel sheet 12 in the first exposed portion 22 in which the base steel sheet 12 is exposed may be smaller than the thickness of the base steel sheet 12 in the first coated portion 26.

The steel sheet for butt welding of the present disclosure has been described above with reference to FIGS. 1 to 3, but the steel sheet for butt welding of the present disclosure is not limited to these examples.

<Base Steel Sheet>

An aluminum coating layer is provided on the surface of the base steel sheet 12. The base steel sheet may be obtained by a common method including a hot rolling step, a cold rolling step, a plating step, and the like, and is not particularly limited. The base steel sheet may be a hot rolled steel sheet or a cold rolled steel sheet.

In addition, the thickness of the base steel sheet 12 may be a thickness set according to the purpose and is not particularly limited. For example, the thickness of the base steel sheet 12 may be such a thickness that the entire thickness of the coated steel sheet after aluminum coating is provided (the steel sheet before the first exposed portion 22 or the like is formed) is 0.8 mm or more, and further, the entire thickness of the steel sheet is 1 mm or more. In addition, the thickness of the base steel sheet 12 may be such a thickness that the entire thickness of the steel sheet is 4 mm or less, and further, the entire thickness of the steel sheet is 3 mm or less.

As the base steel sheet 12, for example, a steel sheet formed to have high mechanical strength (which means, for example, properties related to mechanical deformation and fracture such as tensile strength, yield point, elongation, reduction in area, hardness, impact value, and fatigue strength) may be used.

As an example of a preferable chemical composition of the base steel sheet 12, for example, the following chemical composition may be adopted.

The base steel sheet 12 includes, as a chemical composition, % by mass, C: 0.02% to 0.58%, Mn: 0.20% to 3.00%, Al: 0.005% to 0.20%, Ti: 0% to 0.20%, Nb: 0% to 0.20%, V: 0% to 1.0%, W: 0% to 1.0%, Cr: 0% to 1.0%, Mo: 0% to 1.0%, Cu: 0% to 1.0%, Ni: 0% to 1.0%, B: 0% to 0.0100%, Mg: 0% to 0.05%, Ca: 0% to 0.05%, REM: 0% to 0.05%, Bi: 0% to 0.05%, Si: 0% to 2.00%, P: 0.03% or less, S: 0.010% or less, N: 0.010% or less, and a remainder: Fe and impurities.

Hereinafter, “%” indicating the content of a component (element) means “% by mass”.

(C: 0.02% to 0.58%)

C is an important element that enhances the hardenability of the base steel sheet 12 and mainly determines the strength after hardening. Further, C is an element that lowers an A₃ point and promotes a lowering in a hardening treatment temperature. When the amount of C is less than 0.02%, the effect thereof is not sufficient in some cases. Therefore, the amount of C may be 0.02% or more. On the other hand, when the amount of C is more than 0.58%, the toughness of a hardened portion is significantly deteriorated. Thus, the amount of C may be 0.58% or less. Preferably, the amount of C is 0.45% or less.

(Mn: 0.20% to 3.00%)

Mn is an element that is very effective in enhancing the hardenability of the base steel sheet 12 and stably ensuring the strength after hardening. When the amount of Mn is less than 0.20%, the effect thereof is not sufficient in some cases. Therefore, the amount of Mn may be 0.20% or more. Preferably, the amount of Mn is 0.80% or more. On the other hand, when the amount of Mn is more than 3.00%, the effect thereof is saturated. Further, there are difficulties in ensuring stable strength after hardening in some cases. Thus, the amount of Mn may be 3.00% or less. The amount of Mn is preferably 2.40% or less.

(Al: 0.005% to 0.20%)

Al functions as a deoxidizing element and has a function of rendering the base steel sheet 12 sound. When the amount of Ai is less than 0.005%, it is difficult to obtain the functional effect. Therefore, the amount of Al may be 0.005% or more. On the other hand, when the amount of Al is more than 0.20%, the functional effect is saturated, and thus this is disadvantageous in terms of cost. Thus, the amount of Al may be 0.20% or less.

(Ti: 0% to 0.20%, Nb: 0% to 0.20%, V: 0% to 1.0%, and W: 0% to 1.0%)

Ti, Nb, V, and W are elements that promote mutual diffusion of Fe and Al in the aluminum coating layer and the base steel sheet 12. Accordingly, at least one or two or more of Ti, Nb, V, and W may be contained in the base steel sheet 12. However, 1) when the amount of Ti and the amount of Nb are more than 0.20%, or 2) when the amount of V and the amount of W are more than 1.0%, the functional effect is saturated, and thus this is disadvantageous in terms of cost. Accordingly, the amount of Ti and the amount of Nb may be 0.20% or less and the amount of V and the amount of W may be 1.0% or less. The amount of Ti and the amount of Nb are preferably 0.15% or less, and the amount of V and the amount of W are preferably 0.5% or less. In order to more reliably obtain the functional effect, the lower limit value of the amount of Ti and the amount of Nb is preferably set to 0.01%, and the lower limit value of the amount of V and the amount of W is preferably set to 0.1%.

(Cr: 0% to 1.0%, Mo: 0% to 1.0%, Cu: 0% to 1.0%, Ni: 0% to 1.0%, and B: 0% to 0.0100%)

Cr, Mo, Cu, Ni, and B are elements that are effective in enhancing the hardenability of the base steel sheet 12 and stably ensuring strength after hardening. Accordingly, one or two or more of these elements may be contained in the base steel sheet 12. However, even when the amounts of Cr, Mo, Cu, and Ni are more than 1.0% and the amount of B is more than 0.0100%, the above effect is saturated, and thus this is disadvantageous in terms of cost. Accordingly, the amounts of Cr, Mo, Cu, and Ni may be 1.0% or less. In addition, the amount of B may be 0.0100% or less and is preferably 0.0080% or less. In order to more reliably the above effect, it is preferable that any one of Cr, Mo, Cu, and Ni: 0.1% or more, and B: 0.0010% or more is satisfied.

(Ca: 0% to 0.05%, Mg: 0% to 0.05%, and REM: 0% to 0.05%)

Ca, Mg, and REM function to refine the form of inclusions in the steel and has a function of preventing the occurrence of inclusion-derived cracking during hot press forming. Accordingly, one or more of these elements may be contained in the base steel sheet 12. However, when these elements are added in an excessive amount, the effect of refining the form of inclusions in the base steel sheet 12 is saturated, disadvantageously leading to an increased cost. Accordingly, the amount of Ca is set to 0.05% or less, the amount of Mg is set to 0.05% or less, and the amount of REM is set to 0.05% or less. In order to more reliably obtain the functional effect, it is preferable that any one of Ca: 0.0005% or more, Mg: 0.0005% or more, and REM: 0.0005% or more is satisfied.

Here, REM refers to 17 elements in total of Sc, Y, and lanthanoids, and the amount of REM refers to the total amount of these elements. Lanthanoids are industrially added to the base steel sheet 12 in the form of misch metal.

(Bi: 0% to 0.05%)

Bi is an element that becomes a solidification nucleus in a solidification process of a molten steel and has a function of reducing a secondary arm spacing of dendrite and thus suppressing the segregation of Mn and the like that segregate within the secondary arm spacing of the dendrite. Accordingly, Bi may be contained in the base steel sheet 12. In particular, for steel sheets in which a large amount of Mn is contained, such as steel sheets for hot pressing, Bi is effective in suppressing deterioration in toughness derived from the segregation of Mn. Accordingly, preferably, Bi is contained in such a steel type.

However, when Bi is contained in the base steel sheet 12 in an amount of more than 0.05%, the functional effect is saturated, disadvantageously leading to an increased cost. Accordingly, the amount of Bi is set to 0.05% or less. The amount of Bi is preferably 0.02% or less. In order to more reliably obtain the functional effect, the amount of Bi is preferably 0.0002% or more. The amount of Bi is more preferably 0.0005% or more.

(Si: 0% to 2.00%)

Si is a solid solution strengthening element and when Si is contained in an amount of 2.00%, Si can be effectively used. However, when Si is contained in the base steel sheet 12 in an amount of more than 2.00%, there is concern that defects may occur in coating properties. Accordingly, in a case where the base steel sheet 12 contains Si, the amount of Si may be set to 2.00% or less. The upper limit is preferably 1.40% or less and more preferably 1.00% or less. Although the lower limit is not particularly limited, in order to more reliably obtain the functional effect, the lower limit is preferably 0.01%.

(P: 0.03% or Less)

P is an element that is contained as an impurity. When an excessive amount of P is contained in the base steel sheet, the toughness of the base steel sheet 12 is easily deteriorated. Accordingly, the amount of P may be set to 0.03% or less. The amount of P is preferably 0.01% or less. There is no need to particularly define the lower limit of the amount of P, but from the viewpoint of cost, the lower limit is preferably 0.0002%.

(S: 0.010% or Less)

S is an element that is contained as an impurity. S forms MnS and has a function of rendering the base steel sheet 12 brittle. Accordingly, the amount of S may be set to 0.010% or less. The amount of S is more desirably 0.004% or less. Although there is no need to particularly define the lower limit of the amount of S, from the viewpoint of cost, the lower limit is preferably 0.0002%.

(N: 0.010% or Less)

N is an element that is contained in the base steel sheet 12 as an impurity. Further, N is an element that forms an inclusion in the base steel sheet 12 and deteriorates the toughness after hot press forming. Accordingly, the amount of N may be set to 0.010% or less. The amount of N is preferably 0.008% or less and more preferably 0.005% or less. Although there is no need to particularly define the lower limit of the amount of N, from the viewpoint of cost, the lower limit is preferably 0.0002%.

(Remainder)

The remainder includes Fe and impurities. Here, examples of impurities include components contained in raw materials such as ores or scraps and components to be mixed in the production process. The impurities mean components that are not intentionally contained in the steel sheet.

<Aluminum Coating Layer>

The aluminum coating layer 14 is formed on both surfaces of the base steel sheet 12. The method of forming the aluminum coating layer 14 is not particularly limited. For example, the aluminum coating layer 14 may be formed on both surfaces of the base steel sheet 12 by a hot dip coating method (a method in which the base steel sheet 12 is immersed in a melted metal bath containing aluminum as a main component to form an aluminum coating layer).

Here, aluminum coating layer 14 is a coating layer containing aluminum as a main component, and may contain 50% by mass or more of aluminum. Depending on the purpose, the aluminum coating layer 14 may contain an element other than aluminum (for example, Si), and may contain impurities mixed in the production process. Specifically, the aluminum coating layer 14 may contain, for example, 5% to 12% by mass of Si (silicon) and the remainder may include, as a chemical composition, aluminum and impurities. In addition, the aluminum coating layer 14 may include, as a chemical composition, % by mass, 5% to 12% of Si (silicon) and 2% to 4% of Fe (iron), and the remainder may include, as a chemical composition, aluminum and impurities.

When Si is contained in the aluminum coating layer 14 in the above range, it is possible to prevent workability and corrosion resistance from being lowered. In addition, the thickness of the intermetallic compound layer can be reduced.

The thickness of the aluminum coating layer 14 in the first coated portion 26 is not particularly limited and for example, the average thickness may be 8 μm (micrometers) or more and is preferably 15 μm or more. In addition, regarding the thickness of the aluminum coating layer 14 in the first coated portion 26, for example, the average thickness may be 40 μm or less and is preferably 35 μm or less and more preferably 30 μm or less.

The thickness of the aluminum coating layer 14 represents an average thickness of the steel sheet for butt welding 100 in the second coated portion 24.

The aluminum coating layer 14 prevents the base steel sheet 12 from being corroded. In addition, in a case where the base steel sheet 12 is processed by hot press forming, even when the base steel sheet 12 is heated to a high temperature, scale (iron compound) generated by the oxidation the surface of the base steel sheet 12 is prevented by the aluminum coating layer 14. In addition, in the aluminum coating layer 14, the boiling point and melting point are higher than those of plating coatings of organic materials and plating coatings of other metal materials (for example, zinc-based materials). Therefore, when forming a hot stamped product by hot press forming, the coating does not evaporate, and thus the surface protection effect is high.

The aluminum coating layer 14 can be alloyed with iron (Fe) in the base steel sheet 12 by heating during hot dip coating and hot press forming. Thus, the aluminum coating layer 14 is not necessarily formed of a single layer having a constant component composition, and includes a partially alloyed layer (intermetallic compound layer).

<Intermetallic Compound Layer>

The intermetallic compound layer 16 is a layer formed at the boundary between the base steel sheet 12 and the aluminum coating layer 14 when aluminum coating is applied to the base steel sheet 12. Specifically, the intermetallic compound layer 16 is formed by a reaction of iron (Fe) of the base steel sheet 12 and a metal containing aluminum (Al) in a melted metal bath containing aluminum as a main component. The intermetallic compound layer 16 is mainly formed of a plurality of kinds of compounds represented by FeₓAl_{y} (x and y represent 1 or more). In a case where the aluminum coating layer includes Si (silicon), the intermetallic compound layer 16 is mainly formed of a plurality of kinds of compounds represented by FeₓAl_{y} and FeₓAl_{y}Si_{z} (x, y, and z represents 1 or more).

The thickness of the intermetallic compound layer 16 in the first coated portion 26 is not particularly limited and for example, the average thickness may be 3 μm or more and is preferably 4 μm or more. In addition, regarding the thickness of the intermetallic compound layer 16 in the first coated portion 26 is, for example, the average thickness may be 10 μm or less and is preferably 8 μm or less. The thickness of the intermetallic compound layer 16 represents an average thickness in the second coated portion 24.

The thickness of the intermetallic compound layer 16 can be obtained by controlling the temperature of a melted metal bath containing aluminum as a main component and the immersion time.

Here, the base steel sheet 12, the intermetallic compound layer 16, and the aluminum coating layer 14 are confirmed, and the thicknesses of the intermetallic compound layer 16 and the aluminum coating layer 14 are measured by the following method.

The steel sheet for butt welding 100 is cut so as to expose the cross section and the cross section of the steel sheet for butt welding 100 is polished. The direction of the exposed cross section of the steel sheet for butt welding 100 is not particularly limited. However, the cross section of the steel sheet for butt welding 100 is preferably a cross section orthogonal to a direction in which the first exposed portion 22 extends.

The polished cross section of the steel sheet for butt welding 100 is subjected to line analysis from the surface of the steel sheet for butt welding 100 to the base steel sheet 12 using an electron probe microanalyser (EPMA) to measure the concentration of aluminum and the iron concentration. The concentration of aluminum and the iron concentration are preferably average values measured three times.

The measurement conditions are an acceleration voltage of 15 kV, a beam diameter of about 100 nm, an irradiation time of 1000 ms per point, and a measurement pitch of 60 nm. The measurement distance may be such that the thickness of the coating layer can be measured. For example, the measurement distance is about 30 μm to 80 μm in the thickness direction. The thickness of the base steel sheet 12 is preferably measured with an optical microscope.

<Definition of Ranges of Base Steel Sheet, Intermetallic Compound Layer, and Aluminum Coating Layer>

As the measurement values of the concentration of aluminum of the cross section of the steel sheet for butt welding 100 (coated steel sheet), a region in which the aluminum (Al) concentration is less than 2% by mass is determined as the base steel sheet 12, and a region in which the concentration of aluminum is 2% by mass or more is determined as the intermetallic compound layer 16 or the aluminum coating layer 14. In addition, of the intermetallic compound layer 16 and the aluminum coating layer 14, a region in which iron (Fe) concentration is more than 4% by mass is determined as the intermetallic compound layer 16 and a region in which the iron concentration is 4% by mass or less is determined as the aluminum coating layer 14.

The distance from the boundary between the base steel sheet 12 and the intermetallic compound layer 16 to the boundary between the intermetallic compound layer 16 and the aluminum coating layer 14 is defined as the thickness of the intermetallic compound layer 16. In addition, the distance from the boundary between the intermetallic compound layer 16 and the aluminum coating layer 14 to the surface of the aluminum coating layer 14 is defined as the thickness of the aluminum coating layer 14.

The thickness of the aluminum coating layer 14 and the thickness of the intermetallic compound layer 16 are obtained by performing line analysis from the surface of the steel sheet for butt welding 100 and the surface of the base steel sheet 12 (the boundary between the base steel sheet 12 and the intermetallic compound layer 16) and measuring the thickness as follows.

For example, in a case where the thickness of the second coated portion 24 is measured, in the longitudinal direction of the first exposed portion 22 (for example, an X direction in FIG. 1, hereinafter, referred to as a second direction), the thickness of the aluminum coating layer 14 at positions of five places obtained by dividing the entire length of the second coated portion 24 into five equal parts (the same applies to the following definition of the entire length) is obtained, and the average value of the obtained values is used as the thickness of the aluminum coating layer 14. The thickness is measured at a position that is ½ of the width of the second coated portion in cross-sectional view of five places (hereinafter, the thickness is measured in the same manner). At this time, the thickness of the aluminum coating layer 14 is determined according to the above-described determination criterion. In a case where the first exposed portion is provided to extend on the curve, the thickness may be obtained at places where the entire length along the curve is divided into five equal parts.

Similarly, in a case of measuring the thickness of the intermetallic compound layer 16, in the second direction, the thickness of the intermetallic compound layer 16 at positions of five places obtained by dividing the entire length of the intermetallic compound layer 16 (the same applies to the following definition of the entire length) into five equal parts is obtained and the average value of the obtained values is used as the thickness of the intermetallic compound layer 16. At this time, the thickness of the intermetallic compound layer 16 is determined according to the above-described determination criterion.

<First Exposed Portion>

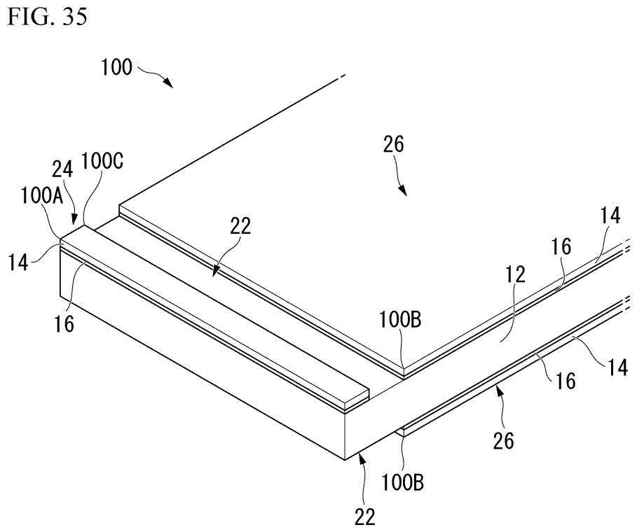

As shown in FIG. 35, the first exposed portion 22 is formed on both surfaces of the end portion where welding of the steel sheet for butt welding 100 is scheduled. Then, the first exposed portion 22 is formed along the end edge 100B of the first coated portion 26. That is, in a case where the second coated portion 24 is formed, the first exposed portion 22 is formed in a range from the end edge at the boundary between the second coated portion 24 and the first exposed portion 22 to the end edge 100B of the first coated portion 26 in the end portion where welding is scheduled. In addition, in a case where the second coated portion 24 is not formed, the first exposed portion 22 is formed in a range from the end edge 100A of the steel sheet for butt welding 100 to the end edge 100B of the first coated portion 26 in the end portion where welding is scheduled.

Here, referring to FIG. 3, in a case where the second coated portion 24 is formed, the first exposed portion 22 is formed in a range from the end edge 100C at the boundary between the second coated portion 24 and the first exposed portion 22 to the end edge 100B of the first coated portion 26. In addition, in a case where the second coated portion 24 is not formed, the first exposed portion 22 is formed in a range from the end edge 100A of the steel sheet for butt welding 100 to the end edge 100B of the first coated portion 26.

The first exposed portions 22 formed on both surfaces of the end portion of the steel sheet for butt welding 100 may be formed as follows. That is, the end portion where welding of the steel sheet for butt welding 100 is scheduled is butt-welded. Then, the first exposed portion 22 is formed at the boundary between a weld metal portion (first weld metal portion) to be formed in the tailored blank (welded joint) and the steel sheet for butt welding 100 so that the aluminum coating layer 14 and the intermetallic compound layer 16 do not remain. To be in this state, the first exposed portion 22 is provided on both surfaces of the end portion of the steel sheet for butt welding 100 along the end edge of the first coated portion 26.

The width of the first exposed portion 22 in the first direction F1 (a distance from the second coated portion 24 to the first coated portion 26 in the first direction F1; hereinafter, also simply referred to as the width of the first exposed portion 22) may be 0.2 mm or more on average. The width of the first exposed portion 22 may be 5.0 mm or less on average. In a case where butt welding is laser welding, the width of the first exposed portion 22 is preferably 0.5 mm or more and the width of the first exposed portion 22 is preferably 1.5 mm or less. In a case where butt welding is plasma welding, the width of the first exposed portion 22 is preferably 1.0 mm or more and the width of the first exposed portion 22 is preferably 4.0 mm or less. By setting the width of the first exposed portion 22 to 0.2 mm or more and the width of the first exposed portion 22 to 4.6 mm or less (on average), deterioration in the fatigue strength of the tailored blank when formed into a hot stamped product is easily suppressed. For example, the width of the exposed portion is measured with a microscope by measuring the width of the exposed portion from a cross section at five places obtained by dividing the entire length of the exposed portion into five equal parts in the direction in which the exposed portion extends (hereinafter, the width is measured in the same manner).

Considering the mechanical strength of the tailored blank, the thickness of the base steel sheet 12 in the first exposed portion 22 is preferably in a range of 90% to 100% as a sheet thickness ratio represented by Expression (11). When the sheet thickness ratio is 90% or more, deterioration in the tensile strength when a hot stamped product is formed using a tailored blank after butt welding is easily suppressed. In addition, similarly, deterioration in fatigue strength is also easily suppressed. The lower limit of the sheet thickness ratio is preferably 92% and more preferably 95%.

The thickness of the base steel sheet 12 at the first exposed portion 22 in the end portion of the steel sheet for butt welding 100 and the thickness of the base steel sheet 12 at the first coated portion 26 are average thicknesses. In addition, the sheet thickness ratio is an average value.

Sheet thickness ratio=(thickness of base steel sheet 12 in first exposed portion 22)/(thickness of base steel sheet 12 in first coated portion 26) (11)

Here, as a method of measuring the sheet thickness ratio from the tailored blank and the hot stamped product, the following method can be used. The sheet thickness ratio can be measured by, for example, observing the first exposed portion 22 of the base steel sheet 12 provided between the weld metal portion and the steel sheet for butt welding 100 and the base steel sheet 12 of the second coated portion 24 in the tailored blank and the hot stamped product.

The thickness of the base steel sheet 12 in the first exposed portion 22 in the end portion of the steel sheet for butt welding 100 and the thickness of the base steel sheet 12 in the first coated portion 26 can be obtained by cutting the steel sheet for butt welding 100 in the thickness direction and observing the cross section with an optical microscope.

Specifically, the thickness of the base steel sheet 12 in the first exposed portion 22 and the thickness of the base steel sheet 12 in the first coated portion 26 are average values obtained at positions of five places obtained by dividing the entire length of the second coated portion 24 into five equal parts along the direction in which the first exposed portion 22 extends, respectively.

<Second Coated Portion>

Similar to the first exposed portion 22, the second coated portion 24 is an end portion where welding of the steel sheet for butt welding 100 is scheduled and is formed in an end portion in which the first exposed portion 22 is provided. Then, the second coated portion 24 is preferably provided in a region on a side closer to the end edge of the steel sheet for butt welding 100 than to the first exposed portion 22 on at least one surface of the end portion located around the steel sheet for butt welding 100 and including the end edge 100A of the steel sheet for butt welding 100. That is, the second coated portion 24 is preferably provided along the end edge 100A of the steel sheet for butt welding 100 in the end portion where welding is scheduled.

The second coated portion 24 formed on at least one surface of the end portion located around the steel sheet for butt welding 100 may be formed as follows. That is, in a state in which the end surfaces of the steel sheet for butt welding 100 having the first exposed portion 22 and the second coated portion 24 are butt-welded, the steel sheets for butt welding 100 are welded. Thereafter, the second coated portion 24 is formed so that the second coated portion 24 does not exist at the boundary between the weld metal portion formed in the tailored blank and the steel sheet for butt welding 100.

That is, the second coated portion 24 is formed in a region including the end edge of the steel sheet for butt welding 100 so as to be included in the weld metal portion after butt welding. To be in this state, the second coated portion 24 is provided on at least one surface of the end portion of the steel sheet for butt welding 100 along the end edge of the steel sheet for butt welding 100.

In the first direction F1, the second coated portion 24 (the entirety thereof) may exist in a range of 0.5 mm from the end edge 100A of the steel sheet for butt welding 100. When the second coated portion 24 exist in this range, the second coated portion 24 is easily included in the weld metal portion after being butt-welded. The second coated portion 24 preferably exists in a range of 0.4 mm from the end edge 100A of the steel sheet for butt welding 100, and more preferably in a range of 0.3 mm from the end edge 100A of the steel sheet for butt welding 100.

In addition, in a case where butt welding is laser welding, the width of the second exposed portion 24 in the first direction F1 (a distance from the end edge 100A of the steel sheet for butt welding 100 to the first exposed portion 22 in the first direction F1; hereinafter, also simply referred to as the width of the second coated portion 24) is preferably 0.1 mm to 0.25 mm. In a case where plasma welding is used, the width of the second coated portion 24 is preferably 0.1 mm to 0.4 mm.

Here, the width of the first exposed portion 22 is an average value obtained by measuring the width of the first exposed portion 22 at five places, and the width of the second coated portion 24 is an average value obtained by measuring the width of the second coated portion 24 at five places. The measurement places of the first exposed portion 22 and the second coated portion 24 are positions of five places obtained by dividing the entire length of the first exposed portion 22 into five equal parts in the direction in which the first exposed portion 22 extends, respectively.

The width of the first exposed portion 22 and the width of the second coated portion 24 are measured as follows.

Samples for measurement including a cross section in which the total width of the first exposed portion 22 and the second coated portion 24 formed in the end portions of the steel sheet for butt welding 100 can be observed (for example, a cross section of the steel sheet for butt welding 100 along the first direction F1 in plan view) are collected at five places. The samples for measurement are collected from positions of five places obtained by dividing the length of the first exposed portion 22 formed along the end edge 100A of the steel sheet for butt welding 100 into five equal parts. Next, the steel sheet for butt welding 100 is cut so as to expose the cross section thereof. Thereafter, each of the cut samples for measurement is embedded in a resin and polished and the cross section is magnified with a microscope. Then, for each sample, the width of the first exposed portion 22 which is a distance from the second coated portion 24 to the first coated portion 26 is measured. In addition, the distance between both end edges in the second coated portion 24 is measured for each sample.

<First Coated Portion>

The first coated portion 26 may have the same structure as the region other than the end portion of the steel sheet for butt welding 100. For example, the thickness of the base steel sheet 12, the thickness of the intermetallic compound layer 16, and the thickness of the aluminum coating layer 14 in the first coated portion 26 may be the same as the thicknesses other than the thickness of the end portion of the steel sheet for butt welding 100, respectively. However, at least a part of the thickness of the aluminum coating layer 14 in the first coated portion 26 may be larger than the thickness of the aluminum coating layer 14 in the end portion of the steel sheet for butt welding 100 in some cases.

Conventionally, a tailored blank is manufactured by butt-welding a coated steel sheet coated with a metal containing aluminum as a main component by a welding method such as laser welding or plasma welding. In the weld metal portion of the butt-welded portion in the tailored blank, a large amount of aluminum derived from the aluminum coating may be mixed in some cases. When the tailored blank thus obtained is hot press-formed, the weld metal portion may be softened in some cases. For example, as a result of the tensile strength test of a portion including the weld metal portion in the tailored blank after hot press forming weld metal portion, an example in which fracture occurs in the weld metal portion has been reported.

From the viewpoint of avoiding fracture in the weld metal portion, for example, Patent Document 1 discloses the steel sheet for butt welding in which the intermetallic compound layer is allowed to remain continuously from the end edge of the steel sheet for butt welding to a region in which the aluminum coating is formed by removing the aluminum coating layer of the welding scheduled portion to be welded. Further, Patent Document 1 discloses the tailored blank obtained by butt-welding the welding scheduled portion of the steel sheet for butt welding.

Then, as the steel sheet for butt welding in which the intermetallic compound layer is allowed to remain by removing the aluminum coating layer, a tailored blank is manufactured by performing butt welding in a state in which the end surfaces of a region in which an intermetallic compound layer remains are butted together. In this case, the fatigue strength of the tailored blank is deteriorated.

In a case of the steel sheet for butt welding in which the intermetallic compound layer remains continuously from the region in which the aluminum coating layer is formed to the welded portion, a hard and brittle intermetallic compound layer remains between the weld metal portion and the region in which the aluminum coating layer is formed. In this case, there is an influence of the intermetallic compound layer remaining at the boundary (stress concentration portion) between the weld metal portion and a welded heat-affected zone. As a result, when a load is repeatedly applied to a hot stamped product using a tailored blank which is formed of the steel sheet for butt welding disclosed in Patent Document 1, the fatigue strength of the joint is deteriorated. Further, in the tailored blank, since aluminum eluted from the intermetallic compound layer is included in a portion in the vicinity of the end edge of the region in which the aluminum coating layer is formed in the weld metal portion, the weld metal portion in this portion is softened and the fatigue strength of the weld metal portion is deteriorated.

Accordingly, the steel sheet for butt welding from which only the aluminum coating layer of the welding scheduled portion is removed is not sufficiently applied to a site where fatigue characteristics are important.

In addition, in Patent Documents 2 to 5, as the steel sheet for butt welding from which the aluminum coating layer of the welding scheduled portion to be welded and the intermetallic compound layer are removed, a tailored blank obtained by butt-welding the welding scheduled portions of the steel sheet for butt welding is disclosed.

However, as the steel sheet for butt welding from which the intermetallic compound layer and the aluminum coating layer are removed, in the tailored blank obtained by performing butt welding in a state in which the end surfaces of the region in which both layers are removed are butted together, when coating is performed on a hot stamped product, the corrosion resistance of the weld metal portion after coating is deteriorated. In the welding scheduled portion, in a case where both the intermetallic compound layer and the aluminum coating layer are removed, there is no or a very little amount of aluminum mixed in the weld metal portion. Therefore, for example, in the steel sheets for butt welding disclosed in Patent Documents 2 to 5, scale (iron compound) is easily generated in the tailored blank. As a result, when a hot stamped product formed by hot press-forming the tailored blank is coated, the adhesion of a coating on the surface of the weld metal portion is deteriorated and thus the corrosion resistance of the weld metal portion after coating is deteriorated.

In contrast, the steel sheet for butt welding 100 of the present disclosure has the first exposed portion 22 in which the base steel sheet 12 is exposed since not only the aluminum coating layer 14 adjacent to the first coated portion 26 but also the intermetallic compound layer 16 is removed. Further, the steel sheet for butt welding 100 of the present disclosure has the second coated portion 24 in which the intermetallic compound layer 16 and the aluminum coating layer 14 are provided.

That is, the steel sheet for butt welding 100 of the present disclosure does not have a hard and brittle intermetallic compound layer 16 in the first exposed portion 22 in which the base steel sheet 12 is exposed. In addition, in the steel sheet for butt welding 100 of the present disclosure, the second coated portion 24 in which the intermetallic compound layer 16 and the aluminum coating layer 14 remain exists in the region including the end edge 100A of the steel sheet for butt welding 100.

Accordingly, in the tailored blank obtained by using the steel sheet for butt welding 100 of the present disclosure and butt-welding the end surfaces of the end portions having the first exposed portion 22 and the second coated portion 24 of the steel sheet for butt welding 100, at the boundary between the weld metal portion and the welded heat-affected zone, a hard and brittle intermetallic compound layer 16 is not provided. A portion in the vicinity of the end edge of the first coated portion 26 in the weld metal portion does not contain aluminum in the intermetallic compound layer 16 and the aluminum coating layer 14. In addition, the second coated portion 24 is included in the weld metal portion after butt welding (that is, an appropriate amount of aluminum of the second coated portion 24 is mixed into the weld metal portion).

For this reason, even in a case where this tailored blank is formed into a hot stamped product, it is considered that deterioration in the fatigue strength of the weld metal portion is suppressed. In addition, since the generation of scale is suppressed on the surface of the weld metal portion, chemical convertibility is improved and the adhesion of the coating is improved. Therefore, it is considered that even after coating the hot stamped product, the corrosion resistance of the weld metal portion after coating is excellent.

Further, the portion in the vicinity of the end edge 100B of the first coated portion 26 in the weld metal portion hardly contains aluminum of the intermetallic compound layer 16 and the aluminum coating layer 14. Accordingly, it is possible to suppress deterioration in the fatigue strength of the weld metal portion due to softening of the weld metal portion of this portion.

In addition, as a proportion of the width of the second coated portion 24 formed on the end portion scheduled to be welded, a percentage of (width of second coated portion 24/(width of second coated portion 24+width of first exposed portion 22)), which is a value for a total of the width of the second coated portion 24 and the width of the first exposed portion 22, may be provided in a range of 3% to 50%. When the proportion of the width of the second coated portion 24 is in this range, deterioration in fatigue strength is suppressed, and excellent corrosion resistance after coating can be effectively obtained. The lower limit of the proportion of the width of the second coated portion 24 is preferably 5%. On the other hand, the upper limit of the proportion of the width of the second coated portion 24 is preferably 40% and more preferably 30%.

The width of the second coated portion 24 is preferably smaller than the width of the first exposed portion 22. With this configuration, the second coated portion 24 remains in a range that is less than half of the distance between the end edge of the steel sheet for butt welding 100 and the first coated portion 26. Thus, when laser welding is performed on the steel sheet for butt welding 100, it is possible to stably prevent the first weld metal portion from coming into contact with the first coated portion 26. In addition, both fatigue strength and corrosion resistance after coating of the first weld metal portion can be increased. In actual machines, since the width of the first weld metal portion necessarily varies, this configuration is preferable.

The second coated portion 24 is preferably formed over the entire length of the steel sheet for butt welding 100. The second coated portion 24 is formed at least over the entire length in a range where welding is scheduled.

The first weld metal portion formed between the two steel sheets for butt welding 100 is preferably separated from the end edge 100B of the first coated portion 26. With this configuration, when a tailored blank is manufactured, it is possible to suppress deterioration in the fatigue strength of the first weld metal portion.

In the steel sheet for butt welding 100 of the present disclosure, the end portion of the welding scheduled portion has the first exposed portion 22 of the base steel sheet 12 and the second coated portion 24 formed in the region including the end edge 100A of the steel sheet for butt welding 100. The second coated portion 24 includes the following aspects as long as deterioration in the fatigue strength of the weld metal portion is suppressed and the corrosion resistance after coating can be maintained.

For example, when a coated steel sheet is punched to obtain a punched member, in the region including the end edge of the coated steel sheet in the end portion located around the coated steel sheet, sagging may occur due to cutting means such as a shear in some cases. For example, when the intermetallic compound layer and the aluminum coating layer are removed by cutting, grinding, and the like in the end portion of the coated steel sheet in the sagging coated steel sheet, the intermetallic compound layer and the aluminum plating layer may remain in the sagging portion. The portion in which the intermetallic compound layer and the aluminum coating layer remain becomes the second coated portion. At this time, the aluminum coating layer preferably includes in the second coated portion.

In addition, by forming the second coated portion or the like in the coated steel sheet, the steel sheet for butt welding is manufactured.

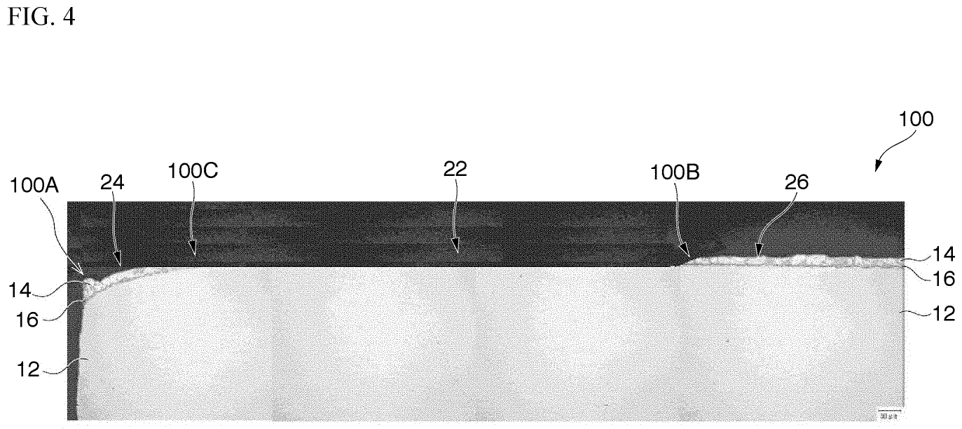

FIG. 4 is a cross-sectional image showing an example of the end portion having the first exposed portion 22 and the second coated portion 24 of the base steel sheet 12 in the steel sheet for butt welding 100 according to the present disclosure.

Referring to FIG. 4, sagging occurs in the region from the end edge 100A of the steel sheet for butt welding 100 to the end edge 100C of the boundary between the first exposed portion 22 and the second coated portion 24. In the sagging portion, the second coated portion 24 in which the aluminum coating layer 14 and the intermetallic compound layer 16 remain is formed on the base steel sheet 12. On the other hand, in the region from the end edge 100B of the first coated portion 26 to the end edge 100C at the boundary between the first exposed portion 22 and the second coated portion 24, the first exposed portion 22 in which the base steel sheet 12 is exposed is formed.

The aluminum contained in the second coated portion 24 is mixed in the weld metal portion in an appropriate amount so that the corrosion resistance after coating of the weld metal portion becomes excellent. For this reason, in the steel sheet for butt welding 100 of the present disclosure, in a case where sagging occurs, the aluminum coating layer 14 and the intermetallic compound layer 16 remaining in the sagging portion are not removed and used as the second coated portion. At this time, the aluminum coating layer 14 is preferably included in the second coated portion.

As an example of a preferable method of forming the first exposed portion 22 and the second coated portion 24 in at least a part of both surfaces of the end portion located around the coated steel sheet (steel sheet for butt welding), for example, the following method may be used.

In at least a part of the end portion located around the coated steel sheet, the intermetallic compound layers 16 and the aluminum coating layers 14 formed on both surfaces of the base steel sheet 12 are removed by cutting or grinding. Thus, this method may include a step of forming the first exposed portion 22 in which the base steel sheet 12 is exposed and the second coated portion 24 in which the intermetallic compound layer 16 and the aluminum coating layer 14 remain on at least one surface of the end portion located around the coated steel sheet on a side closer to the end edge of the coated steel sheet than to the first exposed portion 22 (referred to as formation method A).

For example, the formation method A is a method of forming the first exposed portion 22 and the second coated portion 24 in the end portion of the coated steel sheet as described above. First, as a steel sheet before a tailored blank is formed, a coated steel sheet cut into a desired size is prepared. Next, the aluminum coating layers 14 and the intermetallic compound layers 16 formed on both surfaces of the base steel sheet 12 are removed by cutting or grinding in at least a part of the both surfaces of the end portion of the cut coated steel sheet. At this time, the first exposed portion 22 in which the base steel sheet 12 is exposed is formed in the end portion of the coated steel sheet. At this time, further, the second coated portion 24 is formed along the end edge of the coated steel sheet on at least one surface of the end portion located around the coated steel sheet on the side closer to the end edge of the coated steel sheet than to the first exposed portion 22.

A removal method by cutting performed to form the first exposed portion 22 is not particularly limited. For example, cutting may be performed by machining such as a bite, an end mill, or a metal saw. Grinding may be performed by machining such as a grindstone, a grinder, or a sander. Further, by combining these methods, the intermetallic compound layer 16 and the aluminum coating layer 14 may be removed to form the first exposed portion 22.

Another method is a method of removing the intermetallic compound layer 16 and the aluminum coating layer 14 by laser processing such as laser gouging. Further, by combining these methods, the first exposed portion 22 may be formed by removing the intermetallic compound layer 16 and the aluminum coating layer 14.

In a case where the first exposed portion 22 is formed by laser processing such as laser gouging, when heat is applied, hydrogen may be mixed into the base steel sheet 12 in the portion in which the first exposed portion 22 is formed due to water vapor in the atmosphere. In addition, since the base steel sheet 12 in the portion in which the first exposed portion 22 is formed is rapidly cooled after laser processing, martensite is formed as the metallographic structure of the base steel sheet 12 in this portion. Thus, delayed fracture may occur at the end surface of the steel sheet for butt welding 100 before welding in some cases.

On the other hand, in a case where the first exposed portion 22 is formed by machining, in the base steel sheet 12 in the portion in which the first exposed portion 22 is formed, the temperature rise is suppressed and martensite is not formed. In addition, the formation of delayed fracture is suppressed since hydrogen does not enter. From this point, as a method of forming the first exposed portion 22, it is preferable to employ cutting by machining (cutting). Further, in a case where the first exposed portion 22 is formed by machining, there is no need to incorporate a light shielding measure against laser light when performing laser processing such as laser gouging, and thus this is advantageous in terms of cost or the like.

In a case where the first exposed portion 22 and the second coated portion 24 are formed by machining, for example, an end mill (a tip blade of an end mill, a side blade of an end mill), a metal saw, or the like may be used. Among the machining processes, the first exposed portion 22 and the second coated portion 24 are preferably formed by cutting with an end mill. That is, it is preferable to have a step of forming the first exposed portion 22 and the second coated portion 24 by cutting with an end mill. Cutting by an end mill is cutting by rotational movement. Therefore, in the first exposed portion 22 formed by the end mill, a cut mark having a fine uneven shape is generated on the cutting surface (the exposed surface of the base steel sheet 12 in the first exposed portion 22 and the cross section at the boundary between the first exposed portion 22 and the first coated portion).

As long as the first exposed portion 22 is formed on at least a part of both surfaces of the end portion located around the steel sheet for butt welding 100 (coated steel sheet), and the second coated portion 24 is formed on at least one surface of the end portion located around the steel sheet for butt welding 100, the order of forming the first exposed portion 22 and the second coated portion 24 in the end portion is not limited to the above formation method A.

As an example of another preferable method of forming the first exposed portion 22 on both surfaces of the end portion located around the coated steel sheet and the second coated portion 24 on at least one surface of the end portion located around the coated steel sheet, for example, the following method may be used.

The method may include a step of forming two first exposed portions 22 in which the base steel sheet 12 is exposed by removing the aluminum coating layers 14 and the intermetallic compound layers 16 formed on both surfaces of the base steel sheet 12 by cutting or grinding in regions of both surfaces of the coated steel sheet other than the end portion and forming second coated portions 24 in which the intermetallic compound layer 16 and the aluminum coating layer 14 remain on at least one surface of the coated steel sheet other than the end portion so as to be interposed between the two first exposed portions 22, and a step of forming the first exposed portion 22 in which the base steel sheet 12 is exposed on at least a part of both surfaces of the end portion of the coated steel sheet (steel sheet for butt welding) by cutting the coated steel sheet such that the second coated portion 24 has the region including the end edge of the coated steel sheet and forming the second coated portion 24 in which the intermetallic compound layer 16 and the aluminum coating layer 14 remain on at least one surface of the end portion of the coated steel sheet on the side closer to the end edge of the coated steel sheet than to the first exposed portion 22 (referred to as formation method B).

For example, the formation method B is specifically the following method. First, a coated steel sheet punched and cut into a desired size is prepared. Next, on the cut coated steel sheet, the first exposed portion 22 in which the base steel sheet 12 is exposed is formed by removing the aluminum coating layer 14 and the intermetallic compound layer 16 formed on the base steel sheet 12 by cutting or grinding. Two first exposed portions 22 are formed in regions excluding the first coated portion 26 so as to extend in one direction, for example. In the region interposed between the two first exposed portions 22, the second coated portion 24 in which the intermetallic compound layer 16 and the aluminum coating layer 14 remain is formed. Then, in the cut coated steel sheet, the second coated portion 24 interposed between the two first exposed portions 22 is cut so that the second coated portion 24 is formed along the end edge of the coated steel sheet. The steel sheet for butt welding obtained by cutting is a steel sheet before a tailored blank is formed.

In a case of the formation method B, the width of the second coated portion 24 (that is, the width of the second coated portion 24 before cutting) interposed between the two first exposed portion 22 may be 0.3 mm to 1.6 mm and is preferably 0.4 mm to 1.2 mm. In addition, as a position at which the second coated portion 24 is cut, the second coated portion may be cut at a position in the vicinity of the center line of the second coated portion 24 so as to have a desired width and may be cut at a position other than the center line. In addition, the first exposed portion 22 in which the base steel sheet 12 is exposed may be removed by cutting or grinding so as to have a desired width.

The width of the first exposed portion 22 of the base steel sheet 12 formed by the above formation method A may be 10% to 50% larger than half of the width of a melted region (weld metal portion) after butt welding of the steel sheet for butt welding 100.

The widths of the two first exposed portions 22 of the base steel sheet 12 before the second coated portion 24 formed by the above formation method B is cut may be respectively 10% to 50% larger than half of the width of a melted region (weld metal portion) after butt welding of the steel sheet for butt welding 100.

In addition, the width of the second coated portion 24 in the steel sheet for butt welding 100 before a tailored blank is formed is formed to have a width included in the melted region (weld metal portion) after butt welding of the steel sheet for butt welding 100.

Within these ranges, since an appropriate amount of aluminum is mixed into the weld metal portion after butt welding of the steel sheet for butt welding 100, excellent corrosion resistance after coating is obtained and deterioration in tensile strength is also suppressed. In addition, since there is no hard and brittle intermetallic compound layer 16 at the boundary between the weld metal portion and the welded heat-affected zone, deterioration in the fatigue strength of the steel sheet for butt welding after hot press forming is suppressed.

<Tailored Blank>

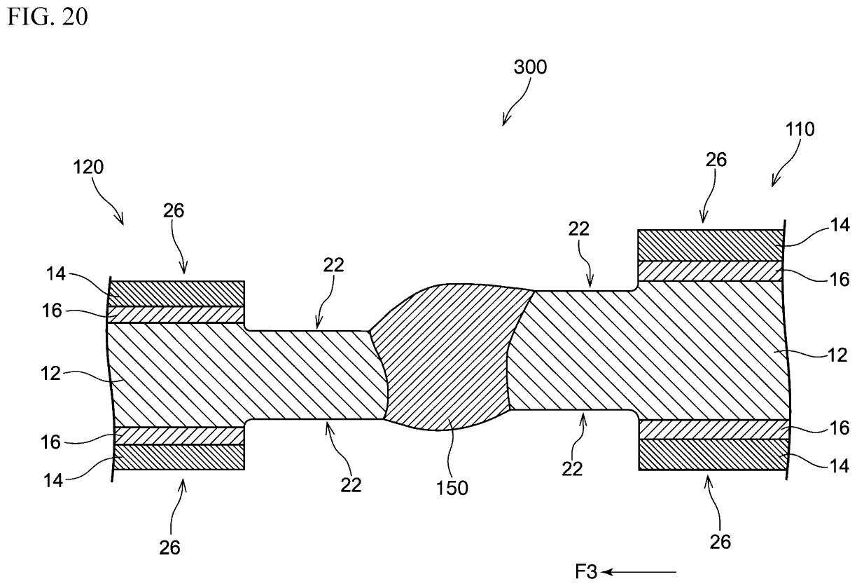

A tailored blank of the present disclosure includes a first weld metal portion and at least two steel sheet portions connected to each other through the first weld metal portion. Each of the at least two steel sheet portions represents a portion corresponding to the steel sheet as a result of butt-welding the steel sheets (steel sheets for butt welding) of the present disclosure. Specifically, each of the at least two steel sheet portions includes the first coated portion 26 in which the intermetallic compound layer 16 and the aluminum coating layer 14 are provided on the surface of the base steel sheet 12 in order from the base steel sheet 12, and the first exposed portion 22 in which the base steel sheet 12 is exposed. Here, in each steel sheet portion, a direction which is perpendicular to the thickness direction of each steel sheet portion and is directed from the first coated portion 26 to the first weld metal portion is set to a third direction (second direction) F3 (refer to FIG. 20). In the tailored blank of the present disclosure, in a third direction F3, the first coated portion 26, the first exposed portion 22, and the first weld metal portion are provided on both surfaces of the base steel sheet 12 such that the first coated portion 26, the first exposed portion 22, and the first weld metal portion are disposed in this order on the same surface.

Similarly, the other side of the steel sheet portion of the tailored blank, in the third direction F3, the first coated portion 26, the first exposed portion 22, and the first weld metal portion are preferably provided such that the first coated portion 26, the first exposed portion 22, and the first weld metal portion are disposed in this order on the same surface. Considering the fatigue strength properties, the tailored blank of the present disclosure preferably has the first exposed portion 22 and the first coated portion 26 on both surfaces or both surfaces with a first weld metal interposed therebetween. Such a configuration can be realized by forming the tailored blank by butt welding the end portions shown in any of FIGS. 1 to 4.

The tailored blank of the present disclosure may be formed by butt welding the end portions of two steel sheets for butt welding or may be formed by butt welding three or more end portions of steel sheets for butt welding. However, each of at least two steel sheets for butt welding includes the first coated portion 26 and the first exposed portion 22. Then, in each of at least two steel sheet portions, in the third direction, the first coated portion 26, the first exposed portion 22, and the first weld metal portion are provided on both surfaces of the base steel sheet 12 such that the first coated portion 26, the first exposed portion 22, and the first weld metal portion are disposed in this order on the same surface.

In addition, in the tailored blank of the present disclosure, welding may be performed in a state in which the end surfaces of two steel sheets for butt welding 100 are butted together or welding may be performed in a state in which the end surfaces of three steel sheets for butt welding 100.

For example, the tailored blank may be a welded member obtained by performing welding in a state in which the end surface of the end portion of the steel sheet for butt welding 100 of the present disclosure having the first exposed portion 22 and the second coated portion 24 present in the region including the end edge of the steel sheet for butt welding 100 on the side closer to the end edge of the steel sheet for butt welding 100 than to the first exposed portion 22, and the end surface of the end portion of the welding scheduled portion of another steel sheet are butted together. In addition, for example, the tailored blank may be obtained by performing welding in a state in which the end surfaces of the end portions having the first exposed portion 22 and the second coated portion 24 in the two steel sheets for butt welding 100 of the present disclosure are butted together or may be obtained by performing welding in a state in which the end surfaces of the end portions having the first exposed portion 22 and the second coated portion 24 in three steel sheets for butt welding 100 of the present disclosure are butted together.

Further, welding may be performed in a state in which the end surfaces of the end portions having the first exposed portion 22 and the second coated portion 24 in four or more steel sheets for butt welding 100 of the present disclosure.

Two or more steel sheets for butt welding 100 for obtaining a tailored blank may be used in combination according to the purpose. As two or more steel sheets for butt welding 100 for obtaining a tailored blank, for example, steel sheets of the same strength class may be used, or steel sheets of different strength classes may be used. In addition, as two or more steel sheets for butt welding 100, steel sheets for butt welding 100 having the same thickness may be used or steel sheets for butt welding 100 having different thicknesses may be used.

Further, in the two or more steel sheets for butt welding 100 for obtaining a tailored blank, the aspects of the second coated portion 24 existing in the region including the end edge of each of the steel sheets for butt welding 100 may be the same or the aspects of the second coated portion 24 may be different. For example, the following aspects may be combined.

For example, there are two kinds of aspects of the second coated portion 24: 1) an aspect in which the second coated portion is formed on both surfaces of the end portion of the steel sheet for butt welding 100; and 2) an aspect in which the second coated portion is formed on only one surface.

In addition, as the steel sheets for butt welding 100 having these aspects of the second coated portion 24, steel sheets for butt welding 100 in which the widths of the second coated portions 24 (the widths of the second coated portions 24 in the first direction F1; distances from the end edges of the steel sheets for butt welding) are the same may be used or steel sheets for butt welding 100 in which the widths of the second coated portions 24 are different may be used.

Further, as the two steel sheets for butt welding 100 for obtaining a tailored blank, for example, the steel sheet for butt welding 100 having the aspect of the second coated portion 24, and a steel sheet for butt welding not having a second coated portion 24 in a welding scheduled portion and having an end portion formed on only a first exposed portion 22 may be combined.

The welding method for performing butt welding is not particularly limited, and examples thereof include welding methods such as laser welding (laser beam welding), arc welding, electron beam welding, and mash seam welding. Examples of arc welding include plasma welding, TIG (Tungsten Inert Gas) welding, MIG (Metal Inert Gas) welding, MAG (Metal Active Gas) welding, etc., and suitable arc welding includes plasma welding. The welding conditions may be selected depending on the desired conditions such as the thickness of the steel sheet for butt welding 100 to be used.

In addition, if required, while a filler wire is being supplied, welding may be performed.

The tailored blank has at least two steel sheets for welding whose end portions are disposed to face each other, and a first weld metal portion. The at least two steel sheets for welding include at least one steel sheet for butt welding 100 of the present disclosure. The first weld metal portion (weld metal portion) is adjacent to the first exposed portions 22 in which the base steel sheets 12 of the end portions of the at least two steel sheets for welding are exposed.

For example, specifically, the first exposed portions 22 are provided in portions located around the weld metal portion on both surfaces of the at least two steel sheets for welding by the weld metal portion. The second coated portion 24 is included in the weld metal portion by butt welding.

In the tailored blank, as described above, in a state in which the end surfaces of the end portions having the first exposed portion 22 and the second coated portion 24 are butted together, welding is performed. Therefore, the amount of aluminum mixed from the intermetallic compound layer 16 and the aluminum coating layer 14 in the weld metal portion is mainly controlled by the amount of aluminum contained in the second coated portion 24 and becomes an appropriate amount. Therefore, corrosion resistance after coating is excellent. In addition, the first exposed portion 22 in which the intermetallic compound layer 16 does not exist is adjacent to the end portion of the weld metal portion, and thus deterioration in fatigue strength of the steel sheet for butt welding 100 after hot press forming is suppressed. In addition, deterioration in tensile strength is suppressed.

In the tailored blank, particularly, the concentration of aluminum (Al concentration) contained in the weld metal portion (first weld metal portion) which connects at least two steel sheet portions maybe 0.05% by mass to 1% by mass. Within this range, excellent corrosion resistance after coating is effectively obtained and fracture in the weld metal portion is suppressed. In addition, deterioration in fatigue strength is suppressed. From the point, the upper limit of the concentration of aluminum contained in the weld metal portion is preferably 1% by mass, more preferably 0.8% by mass, and still more preferably 0.4% by mass. The lower limit of the concentration of aluminum contained in the weld metal portion is preferably 0.08% by mass and more preferably 0.1% by mass.

The concentration of aluminum in the weld metal portion is an average concentration. The concentration of aluminum in the weld metal portion is measured as follows.

The steel sheet for butt welding is cut in a direction orthogonal to the laser weld line and embedded in a resin. The embedded steel sheet for butt welding is polished and mapping analysis is performed from the surface of the steel sheet for butt welding to the base steel sheet by an electron beam microanalyser (FE-EPMA) to measure the concentration of aluminum. The measurement conditions are an acceleration voltage of 15 kV, a beam diameter of about 100 nm, and an irradiation time of 1000 ms. The measurement pitch is a 5 μm pitch in a lattice shape. The measurement values of the concentration of aluminum of the weld metal portion are averaged to obtain the average value.

<Hot Stamped Product>

A hot stamped product of the present disclosure is formed by hot pressing the tailored blank of the present disclosure.

In the hot stamped product of the present disclosure, a first intermetallic compound portion, a third exposed portion, a second weld metal portion, a fourth exposed portion, and a second intermetallic compound portion are provided such that the first intermetallic compound portion, the third exposed portion, the second weld metal portion, the fourth exposed portion, and the second intermetallic compound portion are disposed in this order along the surface of the first base steel sheet and the surface of the second base steel sheet.

In the first intermetallic compound portion, a first intermetallic compound layer is provided on the surface of the first base steel sheet. In the third exposed portion, a first base steel sheet is exposed. In the second intermetallic compound portion, a second intermetallic compound layer is provided on the surface of the second base steel sheet. In the fourth exposed portion, a second base steel sheet is exposed.

The first base steel sheet and the second base steel sheet are steel sheets corresponding to the base steel sheet 12 in the tailored blank before hot press forming is performed. The first intermetallic compound layer and the second intermetallic compound portion are portion corresponding to the first coated portion 26 in the tailored blank before hot press forming is performed.

The concentration of aluminum contained in the second weld metal portion is preferably 0.05% by mass to 1% by mass.

The hot stamped product can be manufactured as follows.

First, a tailored blank is heated to a high temperature to soften the tailored blank. Then, the softened tailored blank is formed by hot press forming using a die, cooled and quenched to obtain a hot stamped product having a desired shape. The hot stamped product has a high tensile strength of, for example, about 1300 MPa or more by heating and quenching by cooling.

As a heating method at the time of hot press forming, it is possible to adopt a heating method by infrared heating, energization heating, induction heating or the like in addition to a normal electric furnace or radiant tube furnace.

In the hot stamped product, during heating of the tailored blank, the aluminum coating layer 14 of the tailored blank is changed to an intermetallic compound that protects the oxidation of the first base steel sheet and the second base steel sheet. For example, as an example, in a case where the aluminum coating layer 14 contains silicon (Si), when the aluminum coating layer 14 is heated, the Al phase is changed into an intermetallic compound, that is, an Al—Fe alloy phase or an Al—Fe—Si alloy phase due to mutual diffusion with Fe. The melting points of the Al—Fe alloy phase and the Al—Fe—Si alloy phase are high and are 1000° C. or higher. There are a plurality of kinds of Al—Fe phases and Al—Fe—Si phases, and when heated at a high temperature or for a long period of time, the Al phase is changed to an alloy phase having a higher Fe concentration. These intermetallic compounds prevent oxidation of the steel sheet for butt welding 100.

The maximum attainment temperature when hot press forming is performed is not particularly limited, and for example, the maximum attainment temperature is preferably 850° C. to 1000° C. In the hot press forming, since heating is performed in an austenite region, typically, a temperature of 900° C. to 950° C. is often adopted as the maximum attainment temperature.

In the hot press forming, the tailored blank heated to a high temperature is press-formed with a die cooled by water cooling or the like, and simultaneously quenched by cooling with the die. In addition, if required, water cooling may be performed by spraying water directly to the tailored blank from the gap of the die. Thus, a hot stamped product having a desired shape is obtained. The hot stamped product may be used a part as it is, or may be used after performing descaling treatment by shot blasting, brushing, laser cleaning, or the like on the welded portion, if required.

When the tailored blank is heated to a high temperature, the metallographic structure of the base steel sheet 12 is at least partially, preferably entirely, formed of an austenite single-phase structure. Thereafter, at the time of press forming with a die, the austenite is transformed into at least one of martensite or bainite by cooling under desired cooling conditions. Then, in the obtained hot stamped product, the metallographic structure of the base steel sheet 12 is a metallographic structure of martensite, bainite, martensite-bainite, ferrite-bainite, or ferrite-pearlite.

Here, an example of steps from the production of the steel sheet for butt welding 100 to the production of the hot stamped product is as follows.

First, an aluminum coating layer 14 is formed on both surfaces of a base steel sheet 12 to obtain a coated steel sheet. At this time, an intermetallic compound layer is formed between the base steel sheet 12 and the aluminum coating layer 14.

Next, the coated steel sheet coated with aluminum is wound in a coil shape on both surfaces of the base steel sheet 12. Next, the coated steel sheet wound in a coil shape is drawn out and punched to obtain a punched member.

Next, on at least a part of both surfaces of the end portion located around the coated steel sheet, the aluminum coating layer 14 and the intermetallic compound layer 16 are removed to form a first exposed portion 22 of the base steel sheet 12. At this time, on at least one surface of the end portion located around the coated steel sheet, a second coated portion 24 is formed in a region including the end edge of the coated steel sheet on a side closer to the end edge of the coated steel sheet than to the first exposed portion 22 to obtain a steel sheet for butt welding 100 of the present disclosure.

Here, the first exposed portion 22 and the second coated portion 24 formed in the end portion of the coated steel sheet may be formed in a state in which after the coated steel sheet is wound in a coil shape, the coated steel sheet wound in a coil shape is drawn out. In this case, after the first exposed portion 22 is formed, punching is performed so that the first exposed portion 22 and the second coated portion 24 are provided in the end portion of the coated steel sheet, and thus a punched member is obtained.

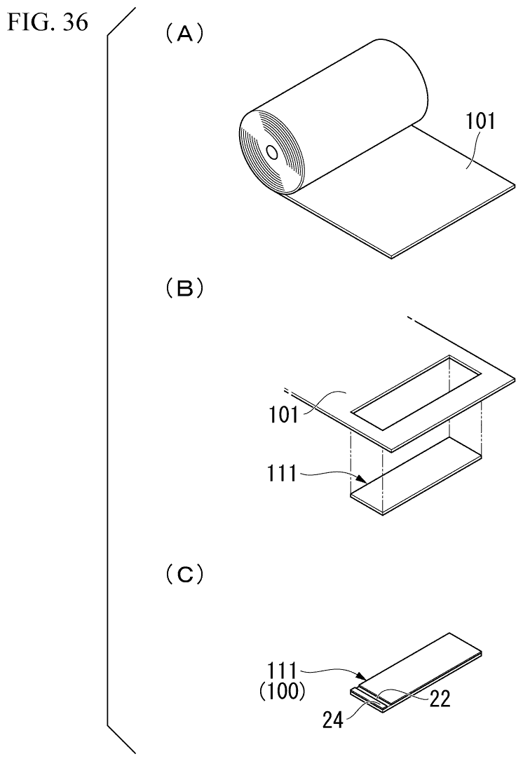

In addition, as shown in (A) of FIG. 36, a coated steel sheet 101 wound in a coil shape is drawn out, and as shown in (B) of FIG. 36, the drawn-out coated steel sheet 101 is punched to form a punched member 111. Then, as shown in (C) of FIG. 36, the first exposed portion 22 and the second coated portion 24 may be formed in the end portion of the formed punched member 111. Through the above steps, a steel sheet for butt welding 100 is manufactured.

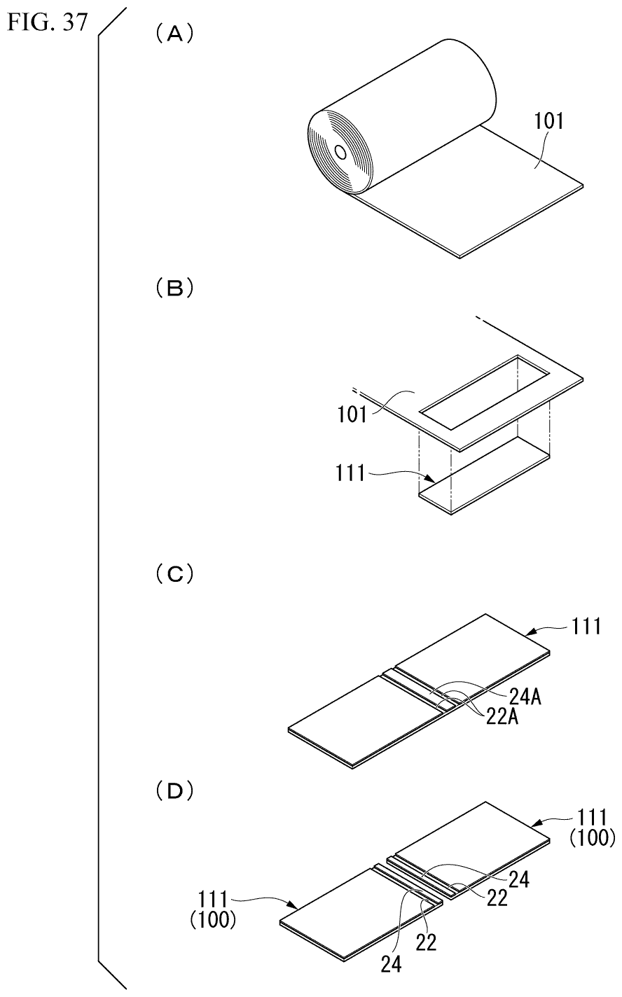

In addition, as shown in (A) of FIG. 37, the coated steel sheet 101 wound in a coil shape is drawn out, and as shown in (B) of FIG. 37, the drawn-out coated steel sheet 101 is punched to form a punched member 111. Thereafter, the first exposed portion 22 and the second coated portion 24 may be formed in the end portion of the punched member 111.

In this case, as shown in (C) of FIG. 37, in portions other than the end portion of the punched member 111, for example, two first exposed portion regions 22A and a second coated portion region 24A, which is interposed between the two first exposed portion regions 22A, may be formed so as to extend in one direction. Thereafter, the second coated portion region 24A of the punched member 111 may be cut, as shown in (D) of FIG. 37, in the end edge of each punched member 111, the first exposed portion 22 may be formed and the second coated portion 24 may be formed in a region including the end portion of the punched member 111 on the side closer to the end edge of the punched member 111 than to the first exposed portion 22. Through the above steps, two steel sheets for butt welding 100 are manufactured.

Next, in the end portion of the steel sheet for butt welding 100, at least one punched member in which the first exposed portion 22 and the second coated portion 24 are formed in the steel sheet for butt welding 100 of the present disclosure is prepared. For example, one punched member in which the first exposed portion 22 and the second coated portion 24 are formed may be prepared and two punched members may be prepared. In a case where one punched member in which the first exposed portion 22 and the second coated portion 24 are formed is prepared, another steel sheet for butt welding to be butt-welded may be a steel sheet for butt welding in which the second coated portion 24 is not formed and only the first exposed portion 22 is formed.

Next, in a state in which the end portions having the first exposed portion 22 and the second coated portion 24 formed in the punched member are butted together, the steel sheets for butt welding are butt-welded to obtain a tailored blank. For example, in a state in which the end portions having the first exposed portion 22 and the second coated portion 24 are butted together, the steel sheets for butt welding may be butt-welded, and in a state in which the end portion having the first exposed portion 22 and the second coated portion 24 and the end portion having only the first exposed portion 22 are butted together, the steel sheets for butt welding may be butt-welded.

Next, the tailored blank is heated in a heating furnace.

Next, using a pair of die including an upper die and a lower die, the heated tailored blank is pressed, formed, and quenched.

Then, the tailored blank is released from the die to obtain a hot stamped product having a desired shape.

For example, the hot stamped product is useful for application to various members of industrial machines in addition to various vehicle members such as a vehicle body.

<Steel Pipe>

A steel pipe of the present disclosure includes a third weld metal portion, and a third steel sheet for butt welding (third steel sheet) which is formed in an open tubular shape in which two end portions in a circumferential direction face each other, and in which the two end portions are connected to each other through the third weld metal portion. In the steel pipe of the present disclosure, each of the two end portions of the third steel sheet for butt welding includes a first coated portion 26, and a first exposed portion 22. In the first coated portion 26, an intermetallic compound layer 16 and an aluminum coating layer 14 are provided on both surfaces of a base steel sheet 12 in order from the base steel sheet 12 side. In the first exposed portion 22, the base steel sheet 12 is exposed.

In the steel pipe of the present disclosure, in the circumferential direction, the first coated portion 26, the first exposed portion 22, and the third weld metal portion are disposed in this order.

The steel pipe of the present disclosure is formed by welding the end portions of an open tube of the steel sheet for butt welding 100 of the present disclosure. However, when the open tube is welded, the entire second coated portion 24 of the steel sheet for butt welding 100 is incorporated in the third weld metal portion.

That is, the steel pipe is obtained by forming the steel sheet for butt welding 100 of the present disclosure into an open tube and performing welding in a state in which end portions having the first exposed portion 22 and the second coated portion 24 located on the side closer to the end edge of the steel sheet for butt welding 100 than to the first exposed portion 22 are butted together. That is, the steel pipe has at least one weld metal portion (that is, the third weld metal portion for welding both end portions of the open tube formed by the steel sheet for butt welding 100), and has the first exposed portions 22 in which the base steel sheet 12 is exposed on both surfaces of the tubular body of the steel sheet for butt welding 100 of the present disclosure adjacent to the weld metal portion.

The tailored blank and a hollow hot stamped product also have the structure in which the first exposed portion 22 in which the base steel sheet 12 is exposed is provided in a portion adjacent to the weld metal portion.

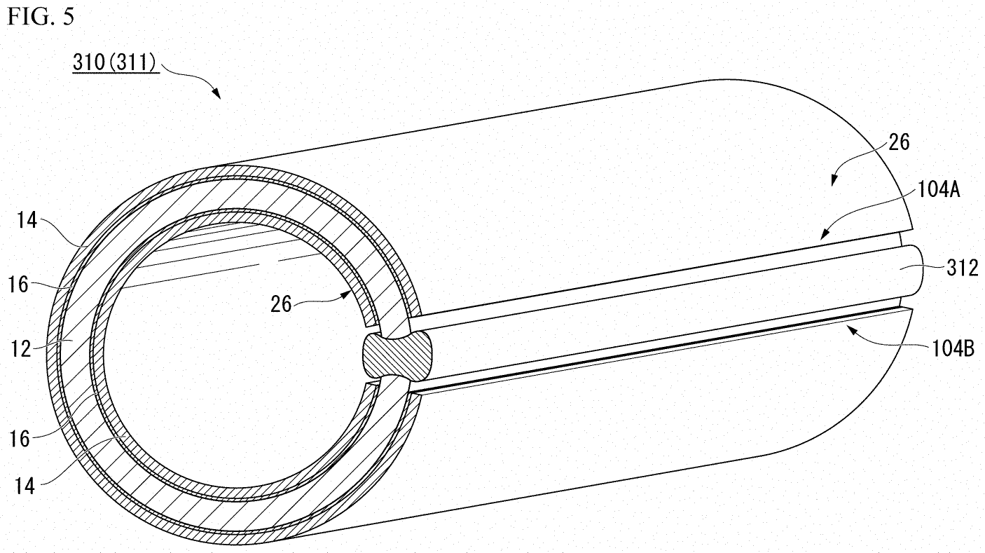

For example, a steel pipe 310 shown in FIG. 5 is manufactured as follows.

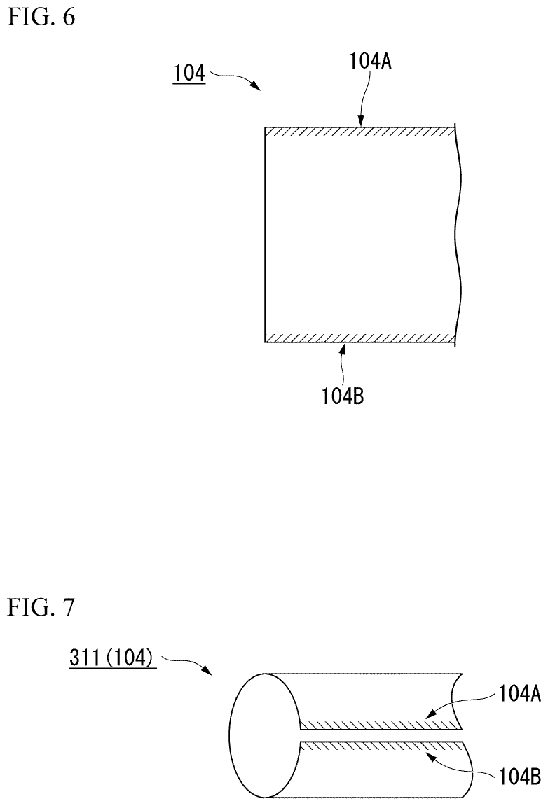

One steel sheet for butt welding 104 of the present disclosure shown in FIG. 6 is prepared. In the steel sheet for butt welding 104, a first exposed portion (not shown) and a second coated portion are provided in a first end portion (end portion) 104A. In the steel sheet for butt welding 104, a first exposed portion (not shown) and a second coated portion are provided in a second end portion (end portion) 104B opposite to the first end portion 104A. In FIG. 6, the first end portion 104A and the second end portion 104B are shown by hatching.

As shown in FIG. 7, this one steel sheet for butt welding 104 is formed into a tubular shape to form an open tube 311. Thereafter, the obtained open tube 311 is butt-welded in a state in which the end surface of the first end portion 104A and the end surface of the second end portion 104B are butt-welded, and this a steel pipe 310 shown in FIG. 5 is manufactured.

The concentration of aluminum contained in the third weld metal portion 312 formed between the end portions 104A and 104B of the open tube 311 is preferably 0.05% by mass to 1% by mass.

When the concentration of aluminum is within this range, excellent corrosion resistance after coating can be effectively obtained and fracture in the third weld metal portion 312 is suppressed.

In addition, deterioration in the fatigue strength of the third weld metal portion 312 is suppressed. At this point, the upper limit of the concentration of aluminum contained in the third weld metal portion 312 is preferably 1% by mass, more preferably 0.8% by mass, and still more preferably 0.4% by mass. The lower limit of the concentration of aluminum contained in the third weld metal portion 312 is preferably 0.08% by mass and more preferably 0.1% by mass.

The concentration of aluminum in the third weld metal portion 312 is an average concentration.

The steel pipe may be manufactured as follows.

Two steel sheets for butt welding in which a first exposed portion and a second coated portion are provided in a first end portion and a first exposed portion and a second coated portion are provided in a second end portion are prepared.

In a case of two steel sheets for butt welding, in a state in which the end surface of a first end portion of a first steel sheet for butt welding including a first exposed portion and a second coated portion, and the end surface of a second end portion of a second steel sheet for butt welding including a first exposed portion and a second coated portion are butted together, welding is performed to manufacture a new steel sheet for butt welding (tailored blank). Then, this new steel sheet for butt welding is formed into a tubular shape to form an open tube.

Then, in the obtained open tube, in a state in which the end surface of a second end portion of the first steel sheet for butt welding including the first exposed portion and the second coated portion, which is not welded, and the end surface of a first end portion of the second steel sheet for butt welding including the first exposed portion and the second coated portion, which is not welded, are butted together, welding is performed to manufacture a steel pipe.

In addition, a longer steel pipe may be manufactured by butt-welding the end portions of the steel pipe 310 in the longitudinal direction. In this case, the first exposed portion 22 and the second coated portion 24 described above may be formed in the end portions to be butt-welded in the steel pipe 310 when the steel pipe 310 is in the state of the steel sheet for butt welding, and when the steel pipe 310 is manufactured from the open tube, the first exposed portion 22 and the second coated portion 24 described above may be formed.

In a case where the steel pipe is formed of a tailored blank, two or more steel sheets for butt welding forming a tailored blank for forming the steel pipe are not limited to the above steel sheets and may be used in combination according to the purpose. Examples of the combination of two or more steel sheets for butt welding include the same as the combinations of the steel sheets for butt welding described in the steel sheet for butt welding for forming the tailored blank described above.

The method of forming the steel sheet for butt welding or tailored blank into a tubular shape is not particularly limited, and any method such as a UOE method or a bending roll method may be used.

In addition, the welding after being formed into a tubular shape is not particularly limited, but may be, for example, electric resistance welding in which welding is performed by laser welding, plasma welding, electric resistance welding, or high frequency induction heating welding.

<Hollow Hot Stamped Product>

A hollow hot stamped product of the present disclosure is manufactured by quenching the steel pipe (for example, steel pipe 310) of the present disclosure.

In the hollow hot stamped product of the present disclosure, a third intermetallic compound portion, a fifth exposed portion, a third weld metal portion, a sixth exposed portion, and a fourth intermetallic compound portion are provided along each of both surfaces of a third base steel sheet and each of both surfaces of a fourth base steel sheet such that the third intermetallic compound portion, the fifth exposed portion, the third weld metal portion, the sixth exposed portion, and the fourth intermetallic compound portion are disposed in this order.

In the third intermetallic compound portion, a third intermetallic compound layer is provided on the surface of the third base steel sheet. In the fifth exposed portion, the third base steel sheet is exposed. In the fourth intermetallic compound portion, a fourth intermetallic compound layer is provided on the surface of the fourth base steel sheet. In the sixth exposed portion, the fourth base steel sheet is exposed.

The third base steel sheet and the fourth base steel sheet are steel sheets corresponding to the base steel sheet 12 in the steel pipe before being quenched. The third intermetallic compound portion and the fourth intermetallic compound portion are portions corresponding to the first coated portion 26 in the steel pipe before being hot press-formed.

The concentration of aluminum contained in the third weld metal portion is preferably 0.05% by mass to 1% by mass.

The hollow quenching formed article may be a hollow formed article formed by quenching a steel pipe formed of the steel sheet for butt welding of the present disclosure or a tailored blank obtained by butt-welding the steel sheets for butt welding of the present disclosure.

That is, the hollow quenching formed article obtained by hot press-forming a steel pipe at least has the weld metal portion (that is, the weld metal portion obtained by welding the end portions of the steel sheet for butt welding) and the first exposed portion 22 in which the base steel sheet 12 is exposed on both surfaces of the hollow formed body by the steel sheet for butt welding of the present disclosure adjacent to the weld metal portion.

For example, the hollow quenching formed article is obtained as follows.

A steel pipe obtained using the steel sheet for butt welding 100 of the present disclosure is formed by a vendor. Next, the steel pipe is heated using a heating furnace, energization heating, or high frequency heating. Since the temperature of heating the steel pipe needs to be set to an austenite region, for example, the temperature may be set to 850° C. to 1100° C. and may be set to about 900° C. to 1000° C. Next, the heated steel pipe is cooled by water cooling or the like and quenched.

In addition, forming and quenching may be performed at the same time. This process is called 3-dimensional hot bending and direct quench (3DQ) and for example, the steel pipe is heated, deformed by applying a load, and then quenched by water cooling. Through these processes, a desired hollow hot stamped product is obtained. In addition, the hollow hot stamped product may be used as a part as it is. Further, the article may be used after the welded portion is descaled by shot blasting, brushing, laser cleaning, or the like, if necessary.

The use of the hollow hot stamped product of the present disclosure is not particularly limited and examples thereof include various members of industrial machines in addition to various vehicle members such as a vehicle body. Specific examples of the vehicle member include various pillars; reinforces such as stabilizers, door beams, roof rails, and bumpers; frames; and various parts such as arms.

Here, an example of a trial calculation the specifications of the steel sheet portion required to set the concentration of aluminum contained in the first weld metal portion (weld metal portion) of the tailored blank to 0.05% by mass to 1% by mass will be described.

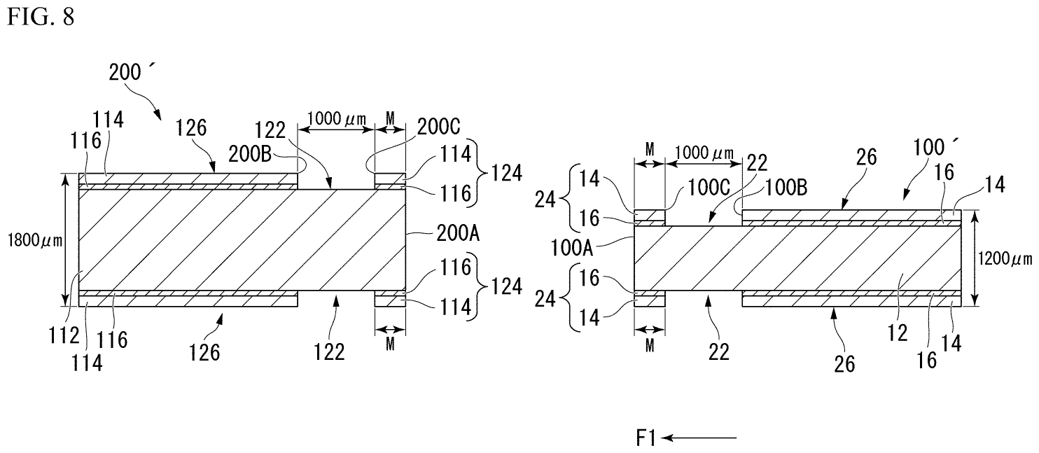

When a tailored blank is manufactured, a steel sheet portion 100′ and a steel sheet portion 200′ in an embodiment shown in FIG. 8 or a modification example of the steel sheet portions 100′ and 200′ shown in FIG. 8 is used.

The steel sheet portion 100′ includes the first coated portion 26 in which the intermetallic compound layer 16 and the aluminum coating layer 14 are provided on the surface of the base steel sheet 12 in order from the base steel sheet 12 side, the first exposed portion 22 in which the base steel sheet 12 is exposed, and the second coated portion 24 in which the intermetallic compound layer 16 and the aluminum coating layer 14 are provided on the surface of the base steel sheet 12 in order from the base steel sheet 12 side. In the first direction F1, the first coated portion 26, the first exposed portion 22, the second coated portion 24, and the end edge of the steel sheet portion 100′ are disposed on both surfaces of the base steel sheet 12.

The steel sheet portion 200′ has a base steel sheet 112, an aluminum coating layer 114, an intermetallic compound layer 116, a first exposed portion 122, a second coated portion 124, and a first coated portion 126 constituted in the same manner as the base steel sheet 12, the aluminum coating layer 14, the intermetallic compound layer 16, the first exposed portion 22, the second coated portion 24, and the first coated portion 26 of the steel sheet portion 100′.

Trial calculation of both of a case where in the steel sheet portions 100′ and 200′, the second coated portions 24 and 124 are formed on both surfaces of the steel sheet portions 100′ and 200′ respectively (the state shown in FIG. 8), and a case where the second coated portions 24 and 124 are formed on only one surface of the steel sheet portions 100′ and 200′ (a state in which the second coated portions 24 and 124 are eliminated from only one surface of the steel sheet portions 100′ and 200′ shown in FIG. 8) is performed.

In a case where the second coated portions 24 and 124 are formed on only one surface, the first exposed portions 22 and 122 are formed from the end edges of the first coated portions 26 and 126 to the end edges of the steel sheet portions 100′ and 200′ on the other surface (for example, the same embodiment as in FIG. 3).

The width of the first exposed portions 22 and 122 (in one example, the width of the first exposed portion 122 is the same as the width of the first exposed portion 22) is set to 1000 μm. In a case where the second coated portions 24 and 124 are formed on only one surface, the width of the first exposed portions 22 and 122 on the other surface is set to (1000+M)μm (M represents the width of the second coated portions 24 and 124).

The first exposed portions 22 and 122 are in contact with the end edges 100A and 200A of the steel sheet portions 100′ and 200′. The thickness of the steel sheet portion 100′ in the first coated portion 26 is set to 1200 μm. The thickness of the steel sheet portion 200′ in the first coated portion 126 is set to 1800 μm.

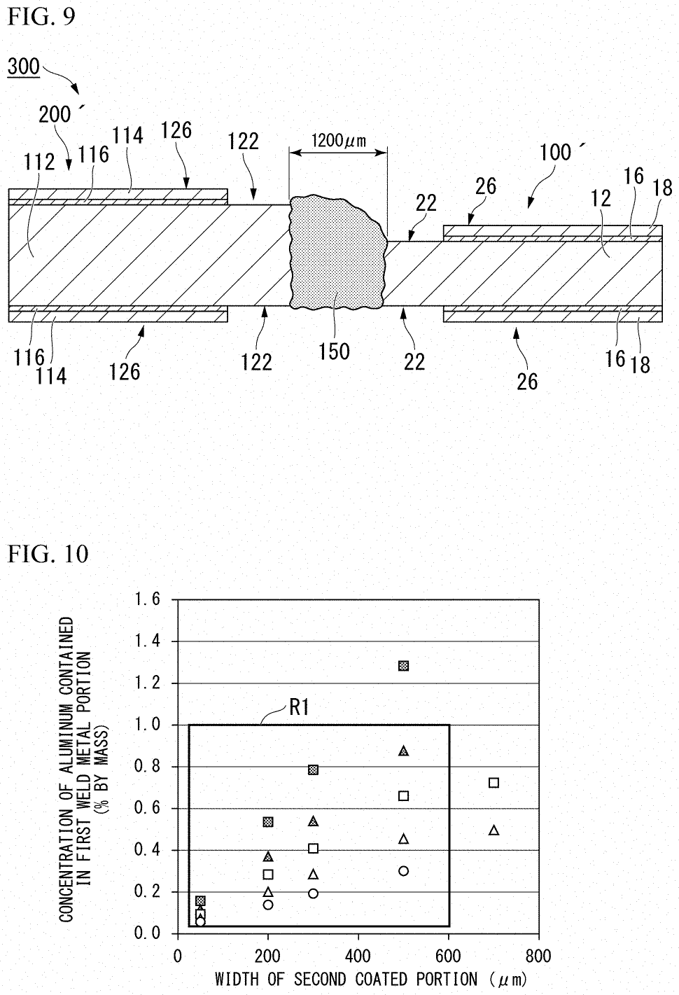

As shown in FIG. 9, butt welding is performed through the end portions having the first exposed portions 22 and 122 and the second coated portions 24 and 124 of the steel sheet portions 100′ and 200′ to manufacture a tailored blank 300. The width of the first weld metal portion 150 formed between the steel sheet portions 100′ and 200′ was set to 1200 μm. That is, 600 μm of each of the end portions of the steel sheet portions 100′ and 200′ is melted to form the first weld metal portion 150.

In Table 1, the calculation results of the concentration of aluminum contained in the first weld metal portion 150 according to the specifications of the steel sheet portions 100′ and 200′ are shown.

TABLE 1

| | Common to steel sheet | | | Concentration |
|---|---|---|---|---|
| | portions 100′ and 200′ | | | of aluminum |
| | Second coated | | Thickness of | contained |
| | portion | | aluminum | in first weld |
| | | Width | coating layer | metal portion |
| Case | Arrangement | μm | μm | % by mass |
| 1 | One surface | 50 | 22 | 0.07 |
| 2 | One surface | 200 | 22 | 0.20 |
| 3 | One surface | 100 | 22 | 0.29 |
| 4 | One surface | 500 | 22 | 0.45 |
| 5 | One surface | 50 | 13 | 0.06 |
| 6 | One surface | 200 | 13 | 0.14 |
| 7 | One surface | 300 | 13 | 0.19 |
| 8 | One surface | 500 | 13 | 0.30 |
| 9 | One surface | 50 | 34 | 0.09 |
| 10 | One surface | 200 | 34 | 0.28 |
| 11 | One surface | 300 | 34 | 0.41 |
| 12 | One surface | 500 | 34 | 0.66 |
| 13 | Both surfaces | 50 | 22 | 0.12 |
| 14 | Both surfaces | 200 | 22 | 0.37 |
| 15 | Both surfaces | 300 | 22 | 0.54 |
| 16 | Both surfaces | 500 | 22 | 0.88 |
| 17 | Both surfaces | 50 | 34 | 0.16 |
| 18 | Both surfaces | 200 | 34 | 0.53 |
| 19 | Both surfaces | 300 | 34 | 0.79 |
| 20 | Both surfaces | 500 | 34 | 1.28 |
| 21 | One surface | 700 | 34 | 0.79 |
| 22 | One surface | 700 | 22 | 0.54 |

The concentration of aluminum of the base steel sheets 12 and 112 is set to 0.03% by mass. The thickness of the intermetallic compound layers 16 and 116 is set to 3 μm. The aluminum contained in 600 μm of each of the end portions of the steel sheet portions 100′ and 200′ is contained in the first weld metal portion 150.

In Cases 1 to 12, in a case where the second coated portions 24 and 124 are formed on only one surface of the steel sheet portions 100′ and 200′, the width of the second coated portions 24 and 124 is changed to 50 μm, 200 μm, 30 μm, and 500 respectively, and the thickness of the aluminum coating layers 14 and 114 is changed to 13 μm, 22 μm, and 34 μm, respectively.

For example, in Case 1, the width of the second coated portions 24 and 124 is 50 μm and the thickness of the aluminum coating layers 14 and 114 is 22 μm. In Case 1, the concentration of aluminum contained in the first weld metal portion 150 is 0.07% by mass.

Cases 13 to 20 are cases where the second coated portions 24 and 124 are formed on both surfaces of the steel sheet portions 100′ and 200′, the width of the second coated portions 24 and 124 is changed to 50 μm, 200 μm, 30 μm, and 500 μm, and the thickness of the aluminum coating layers 14 and 114 is changed to 22 μm and 34 μm to perform trial calculation.

Cases 21 and 22 are cases where the second coated portions 24 and 124 are formed on only one surface of the steel sheet portions 100 and 200′ and the width of the second coated portions 24 and 124 is 700 μm. Also in these cases, the thickness of the aluminum coating layers 14 and 114 are is changed to 22 μm and 34 μm to perform trial calculation. However, since 600 μm of each of the end portions of the steel sheet portions 100′ and 200′ is melted to form the first weld metal portion 150, a part of the second coated portions 24 and 124 having a width of 700 μm is included in the first weld metal portion 150.

The results of the trial calculation are shown in FIG. 10. In FIG. 10, the horizontal axis represents the width of the second coated portions 24 and 124, and the vertical axis represents the concentration of aluminum contained in the first weld metal portion 150. In FIG. 10, the white circles represent the results in a case where the second coated portions 24 and 124 are formed only on one surface of the steel sheet portions 100′ and 200′ and the thickness of the aluminum coating layer 14 is 13 μm. (Cases 5 to 8). The white triangles represent the results in a case where the second coated portions 24 and 124 are formed only on one surface of the steel sheet portions 100′ and 200′, and the thickness of the aluminum coating layer 14 is 22 μm. (Case 1 to 4). The white square marks represent the results in a case where the second coated portions 24 and 124 are formed only on one surface of the steel sheet portions 100′ and 200′, and the thickness of the aluminum coating layer 14 is 34 μm. (Cases 9 to 12).

The black triangles represent the results in a case where the second coated portions 24 and 124 are formed on both surfaces of the steel sheet portions 100′ and 200′, respectively, and the thickness of the aluminum coating layer 14 is 22 μm. (Cases 13 to 16). The black squares represent the results in a case where the second coated portions 24 and 124 are formed on both surfaces of the steel sheet portions 100′ and 200′, respectively, and the thickness of the aluminum coating layer 14 is 34 μm. (Cases 17 to 20).

In this example, a case where the width of the second coated portions 24 and 124 and the concentration of aluminum contained in the first weld metal portion 150 included in a region R1 in which the concentration of aluminum contained in the first weld metal portion 150 is 0.05% by mass to 1% by mass and the width of the second coated portions 24 and 124 is more than 0 μm and less than 600 μm is preferable from the viewpoint of corrosion resistance after coating, and from the viewpoint that the entire second coated portions 24 and 124 are included in the first weld metal portion 150.

In the following, from the results of the trial calculation, the procedure for obtaining the specifications of the width of the second coated portions 24 and 124 and the thickness of the aluminum coating layers 14 and 114 in which the concentration of aluminum contained in the first weld metal portion 150 is 0.05% by mass to 1% by mass will be described.

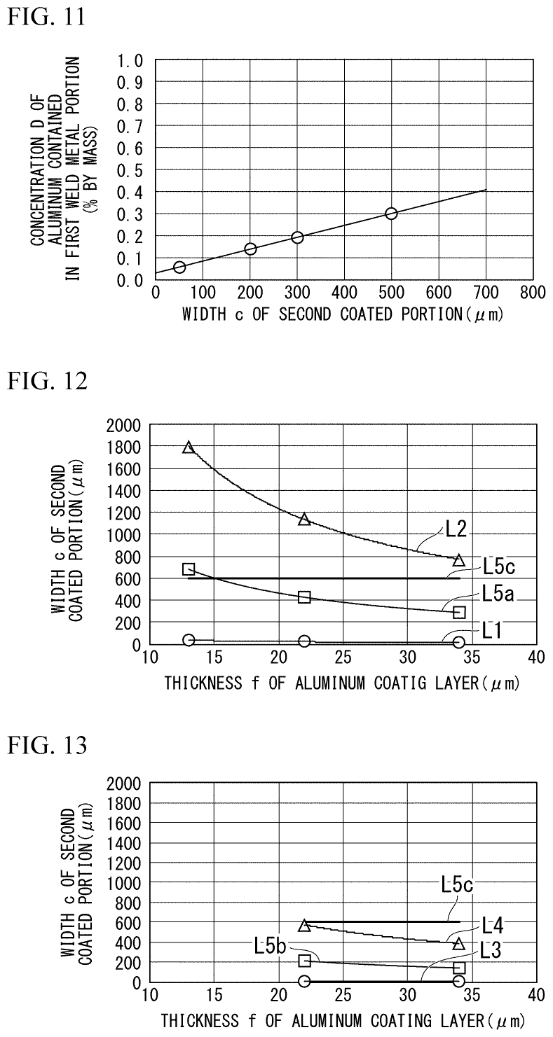

For example, in a case where the second coated portions 24 and 124 are formed on only one surface of the steel sheet portions 100′ and 200′ and the thickness of the aluminum coating layer 14 is 13 μm, a relationship between the width c μm of the second coated portions 24 and 124 and the concentration of aluminum d % by mass contained in the first weld metal portion 150 is approximated by an expression of a straight line. In FIG. 11, the relationship between the width of the second coated portions 24 and 124 and the concentration of aluminum contained in the first weld metal portion 150 is shown. In FIG. 11, the horizontal axis represents the width c of the second coated portions 24 and 124 and the vertical axis represents the concentration d of aluminum contained in the 1 weld metal portion 150. In this case, an expression of a straight line approximating the relationship between the width c of the second coated portions 24 and 124 and the concentration d of aluminum contained in the first weld metal portion 150 is Expression (13).

d=0.00054c+0.03014 (13)

Using the approximate Expression (13), the width of the second coated portions 24 and 124 in which the concentration d of aluminum contained in the first weld metal portion 150 is 0.05% by mass is calculated to be 36.7 μm from Expression (14).

(0.05−0.03014)/0.00054=36.7 (14)

Similarly, the width of the second coated portions 24 and 124 in which the concentration d of aluminum contained in the first weld metal portion 150 is 1% by mass is 1794.2 μm.

An expression of the approximate straight line in a case where the second coated portions 24 and 124 are formed on only one surface of the steel sheet portions 100′ and 200′ and the thickness of the aluminum coating layer 14 is 22 μm is Expression (15).

d=0.00085c+0.03036 (15)

An expression of the approximate straight line in a case where the second coated portions 24 and 124 are formed on only one surface of the steel sheet portions 100′ and 200′ and the thickness of the aluminum coating layer 14 is 34 μm is Expression (16).

d=0.00126c+0.03081 (16)

Note that the data for Cases 21 and 22 are not used in the calculation of Expressions (15) and (16).

An expression of the approximate straight line in a case where the second coated portions 24 and 124 are formed on both surfaces of the steel sheet portions 100′ and 200′ and the thickness of the aluminum coating layer 14 is 22 μm is Expression (17).

d=0.00169c+0.03146 (17)

An expression of the approximate straight line in a case where the second coated portions 24 and 124 are formed on both surfaces of the steel sheet portions 100′ and 200′ and the thickness of the aluminum coating layer 14 is 34 μm is Expression (18).

d=0.00250c+0.03322 (18)

In a case where the second coated portions 24 and 124 are formed on only one surface of the steel sheet portions 100′ and 200′, the results of trial calculation of the width of the second coated portions 24 and 124 with respect to the thickness of the aluminum coating layers 14 and 114 in which the concentration of aluminum contained in the first weld metal portion 150 is 0.05% by mass, 0.4% by mass, and 1% by mass are shown in Table 2.

In the actually manufactured tailored blank, a case where the concentration of aluminum contained the first weld metal portion 150 is 0.4% by mass is considered. Therefore, trial calculation of the case where the concentration of aluminum is 0.4% by mass is also performed.

TABLE 2

| | Width of second coated | Width of second coated | Width of second coated |
|---|---|---|---|
| Thickness of | portion in which | portion in which | portion in which |
| aluminum | concentration of aluminum | concentration of aluminum | concentration of aluminum |
| coating layer | is 0.05% by mass | is 0.4% by mass | is 1% by mass |
| μm | μm | μm | μm |
| 13 | 36.7 | 684.2 | 1794.2 |
| 22 | 23.1 | 435.1 | 1141.4 |
| 34 | 15.5 | 293.1 | 769.4 |

*The second coated portion is formd on only one surface.

In a case where the second coated portions 24 and 124 are formed on both surfaces of the steel sheet portions 100′ and 200′, the results of trial calculation of the width of the second coated portions 24 and 124 with respect to the thickness of the aluminum coating layers 14 and 114 in which the concentration of aluminum contained in the first weld metal portion 150 is 0.05% by mass, 0.4% by mass, and 1% by mass are shown in Table 3.

TABLE 3

| | Width of second coated | Width of second coated | Width of second coated |
|---|---|---|---|
| Thickness of | portion in which | portion in which | portion in which |
| aluminum | concentration of aluminum | concentration of aluminum | concentration of aluminum |
| coating layer | is 0.05% by mass | is 0.4% by mass | is 1% by mass |
| μm | μm | μm | μm |
| 22 | 11.0 | 218.0 | 572.8 |
| 34 | 6.7 | 146.6 | 386.4 |

In a case where the second coated portions 24 and 124 are formed on only one surface of the steel sheet portions 100′ and 200′, the relationship between the thickness of the aluminum coating layers 14 and 114 and the width of the second coated portions 24 and 124 in which the concentration of aluminum contained in the first weld metal portion 150 is 0.05% by mass and 1% by mass is shown in FIG. 12.

An expression approximating the relationship between the thickness f μm of the aluminum coating layer 14 and 114 and the width c of the second coated portions 24 and 124 to set the concentration of aluminum contained in the first weld metal portion 150 to 0.05% by mass is Expression (21) (a curve L1 in FIG. 12).

c=385.48f^{-0.914} (21)

On the other hand, an expression approximating the relationship between the thickness f of the aluminum coating layers 14 and 114 and the width c of the second coated portions 24 and 124 to set the concentration of aluminum contained in the first weld metal portion 150 to 1% by mass is Expression (22) (a curve L2 in FIG. 12).

c=17204f^{-0.88} (22)

An expression approximating the relationship between the thickness f of the aluminum coating layers 14 and 114 and the width c of the second coated portions 24 and 124 to set the concentration of aluminum contained in the first weld metal portion 150 to 0.4% by mass is Expression (22a) (a curve L5a in FIG. 12).

c=385.48f^{-0.914} (22a)

That is, in a case where the second coated portions 24 and 124 are formed on only one surface of the steel sheet portions 100′ and 200′, when the thickness f of the aluminum coating layers 14 and 114 and the width c of the second coated portions 24 and 124 satisfy the relationship of Expression (23), the concentration of aluminum contained in the first weld metal portion 150 is 0.05% by mass to 1% by mass.

385.48f^{-0.914}≤c≤17204f^{-0.88} (23)

However, in the trial calculation, only a portion having a width of less than 600 μm in the second coated portions 24 and 124 is incorporated into the first weld metal portion 150. Therefore, in FIG. 12, only a portion below a line L5c representing a state in which the width c of the second coated portions 24 and 124 is 600 μm is a range of the width c of the second coated portions 24 and 124. Further, in the first direction F1, the second coated portions 24 and 124 exist in a range of 0.5 mm (500 μm) from the end edge of the steel sheet portions 100′ and 200′, only a portion in which the width c of the second coated portions 24 and 124 is lower than 500 μm is a range of the width c of the second coated portions 24 and 124.

In FIG. 12, the thickness f of the aluminum coating layers 14 and 114 is in a range of 13 μm or more and 34 μm or less and the curve L2 is disposed above 500 μm. Therefore, Expression (23) is corrected to Expression (23a).

385.48f^{-0.914}≤c≤500 (23a)

Similarly, in a case where the second coated portions 24 and 124 are formed on both surfaces of the steel sheet portions 100′ and 200′, the relationship between the thickness of the aluminum coating layers 14 and 114 and the width of the second coated portions 24 and 124 in which the concentration of aluminum contained in the first weld metal portion 150 is 0.05% by mass and 1% by mass is shown in FIG. 13.

An expression approximating the relationship between the thickness f μm of the aluminum coating layers 14 and 114 and the width c of the second coated portions 24 and 124 to set the concentration of aluminum contained in the first weld metal portion 150 to 0.05% by mass is Expression (24) (a curve L3 in FIG. 13).

c=359.65f^{-1.129} (24)

On the other hand, an expression approximating the relationship between the thickness f of the aluminum coating layers 14 and 114 and the width c of the second coated portions 24 and 124 to set the concentration of aluminum contained in the first weld metal portion 150 to 1% by mass is Expression (25) (a curve L4 in FIG. 13).

c=9368f^{-0.904} (25)

An expression approximating the relationship between the thickness f of the aluminum coating layers 14 and 114 and the width c of the second coated portions 24 and 124 to set the concentration of aluminum contained in the first weld metal portion 150 to 0.4% by mass is Expression (25a) (a curve L5b in FIG. 13).

c=359.65f^{-1.129} (25a)

That is, in a case where the second coated portions 24 and 124 are formed on both surfaces of the steel sheet portions 100′ and 200′, when the relationship between the thickness f of the aluminum coating layers 14 and 114 and the width c of the second coated portions 24 and 124 satisfy Expression (26), the concentration of aluminum contained in the first weld metal portion 150 0.05% by mass to 1% by mass.

359.65f^{-1.129}≤c≤9368f^{-0.904} (26)

However, in the trial calculation, only a portion having a width of less than 600 μm in the second coated portions 24 and 124 is incorporated into the first weld metal portion 150. Therefore, in FIG. 13, only a portion below the line L5c representing a state in which the width c of the second coated portions 24 and 124 is 600 μm is a range of the width c of the second coated portions 24 and 124. Further, in the first direction F1, the second coated portions 24 and 124 exist in a range of 0.5 mm (500 μm) from the end edge of the steel sheet portions 100′ and 200′, only a portion in which the width c of the second coated portions 24 and 124 is lower than 500 μm is a range of the width c of the second coated portions 24 and 124.

In FIG. 13, the thickness f of the aluminum coating layers 14 and 114 is in a range of 22 μm or more and 34 μm or less and the curve L4 is disposed below the line L5c. Therefore, it is found that the width c of the second coated portions 24 and 124 satisfying Expression (26) can be obtained as a value less than 600 μm.

Table 4 shows the results of the trial calculation of the concentration of aluminum contained in the first weld metal portion 150 in a case where the specifications such as the thickness of the steel sheet portion 200′ are changed in the steel sheet portions 100′ and 200′.

TABLE 4

| | Steel sheet | | | | | | |
|---|---|---|---|---|---|---|---|
| | portion 200′ | Common to steel sheet portions 100′ and 200′ | | | | | Concentration of |
| | Thickness of | Concentration | | | Thickness of | Thickness of | aluminum contained |
| | steel sheet | of aluminum of | Second coated portion | | aluminum | intermetallic | in first weld |
| | portion | base steel sheet | | Width | coating layer | compound layer | metal portion |
| Case | μm | % by mass | Arrangement | μm | μm | μm | % by mass |
| 31 | 1800 | 0.03 | One surface | 30 | 22 | 3 | 0.06 |
| 32 | 1800 | 0.03 | One surface | 10 | 22 | 3 | 0.04 |
| 33 | 1800 | 0.03 | Both surfaces | 350 | 34 | 6 | 0.97 |
| 34 | 1800 | 0.03 | Both surfaces | 350 | 34 | 8 | 1.02 |
| 35 | 2300 | 0.03 | Both surfaces | 300 | 34 | 3 | 0.68 |
| 36 | 1400 | 0.03 | Both surfaces | 300 | 34 | 3 | 0.90 |
| 37 | 1000 | 0.03 | Both surfaces | 300 | 34 | 3 | 1.06 |
| 38 | 1800 | 0.05 | Both surfaces | 350 | 34 | 3 | 0.93 |
| 39 | 1800 | 0.12 | Both surfaces | 350 | 34 | 3 | 1.00 |

In Case 31, the second coated portions 24 and 124 are formed on only one surface of the steel sheet portions 100′ and 200′, the width c of the second coated portions 24 and 124 is 30 μm, and the thickness of the aluminum coating layers 14 and 114 is 22 μm. In this case, the concentration of aluminum contained in the first weld metal portion 150 is 0.06% by mass.

In Case 32, the width of the second coated portions 24 and 124 was 10 μm in comparison with Case 31. In this case, the concentration of aluminum contained in the first weld metal portion 150 is 0.04% by mass.

In Cases 33 to 39, the second coated portions 24 and 124 are formed on both surfaces of the steel sheets for butt welding 100 and 200, and the thickness of the aluminum coating layers 14 and 114 is 34 μm.

In Case 33, the width of the second coated portions 24 and 124 was 350 μm and the thickness of the intermetallic compound layers 16 and 116 is 6 μm. In this case, the concentration of aluminum contained in the first weld metal portion 150 is 0.97% by mass. In Case 34, the thickness of the intermetallic compound layers 16 and 116 is 8 μm m in comparison with Case 33. In this case, the concentration of aluminum contained in the first weld metal portion 150 is 1.02% by mass.

In Case 35, the thickness of the steel sheet for butt welding 200 is 2300 μm and the width of the second coated portions 24 and 124 is 300 μm. In this case, the concentration of aluminum contained in the first weld metal portion 150 is 0.68% by mass. In Case 36, the thickness of the steel sheet for butt welding 200 is 1400 μm in comparison with Case 35. In this case, the concentration of aluminum contained in the first weld metal portion 150 is 0.90% by mass. In Case 37, the thickness of the steel sheet for butt welding 200 is 1000 μm in comparison with Case 35. In this case, the concentration of aluminum contained in the first weld metal portion 150 is 1.06% by mass.

In Case 38, the concentration of aluminum in the base steel sheets 12 and 112 is 0.05% by mass, and the width of the second coated portions 24 and 124 is 350 μm. In this case, the concentration of aluminum in the first weld metal portion 150 is 0.93% by mass. In Case 39, the concentration of aluminum in the base steel sheets 12 and 112 is 0.12% by mass in comparison with Case 38. In this case, the concentration of aluminum contained in the first weld metal portion 150 is 1.00% by mass.

### EXAMPLES

Examples of the first embodiment of the present disclosure will be illustrated below, but the present disclosure is not limited to the following examples.

It is apparent to those skilled in the art that various modification examples or revised examples can be devised within the scope of technical ideas described in claims, and it is understood that these examples also fall into the technical scope of the present disclosure as a matter of course.

### Example 1

The chemical composition of a base steel sheet of a coated steel sheet (steel sheet for butt welding) used in the example is as shown in Table 5.

TABLE 5

| Tensile | | | | | | | | | | |
|---|---|---|---|---|---|---|---|---|---|---|
| strength | | | | | | | | | | |
| after hot | Chemical composition of base steel sheet | | | | | | | | | |
| press forming | (% by mass: remainder including Fe and impurities) | | | | | | | | | |
| (MPa) | C | Si | Mn | P | S | Cr | Ti | Al | N | B |
| 1800 | 0.30 | 0.20 | 1.70 | 0.009 | 0.002 | 0.23 | 0.02 | 0.03 | 0.003 | 0.0016 |
| 1500 | 0.22 | 0.22 | 1.25 | 0.010 | 0.003 | 0.20 | 0.02 | 0.03 | 0.003 | 0.0015 |
| 1300 | 0.12 | 0.03 | 2.01 | 0.012 | 0.004 | 0.23 | 0.02 | 0.02 | 0.004 | 0.0018 |

That is, the chemical composition of the base steel sheet was changed according to the tensile strength of the coated steel sheet after hot press forming (HS). For example, in a case where the tensile strength of the coated steel sheet is 1800 MPa, the amount of C is 0.30%, the amount of Si is 0.20%, the amount of Mn is 1.70%, the amount of P is 0.009%, the amount of S is 0.002%, the amount of Cr is 0.23%, the amount of Ti is 0.02%, the amount of Al is 0.03%, the amount of N is 0.003%, and the amount of B is 0.0016%. The remainder other than C and the like in the base steel sheet includes Fe and impurities.

In a case where the tensile strength of the coated steel sheet is 1500 MPa, the amount of Al is 0.03%, and in a case where the tensile strength of the coated steel sheet is 1300 MPa, the amount of Al is 0.02%.

A coated steel sheet coated with aluminum so as to have the thickness shown in Table 6 was prepared using the base steel sheet having the chemical composition shown in Table 5.

TABLE 6

| Tensile | | Thickness of | |
|---|---|---|---|
| strength | Thickness of | intermetallic | Thickness |
| after hot | aluminum | compound | of coated |
| press forming | coating layer | layer | steel sheet |
| (MPa) | (μm) | (μm) | (mm) |
| 1800 | 15 | 3 | 2.0, 1.8, 1.6, 1.3 |
| 1500 | 22 | 5 | 2.0, 1.8, 1.6, 1.2 |
| 1300 | 17 | 6 | 1.6, 1.3, 1.2 |

Then, this coated steel sheet was cut out to form a square coated steel sheet having one side of 10 cm. Next, a first exposed portion and a second coated portion were formed on at least a part of both surfaces of the end portion located around the prepared coated steel sheet to prepare a steel sheet for butt welding.

In a part of the coated steel sheet, an aluminum coating layer and an intermetallic compound layer were not removed. In addition, in a part of the coated steel sheet, only the aluminum coating layer was removed, and only the first exposed portion was formed while the second coated portion was not formed. Further, in a part of the coated steel sheet, the aluminum coating layer and the intermetallic compound layer were removed, and only the first exposed portion was formed while the second coated portion was not formed.

According to the exposed portion type shown in Table 7, in the first exposed portion, the aluminum coating layers formed on both surfaces, or the aluminum coating layer and the intermetallic compound layer were respectively removed to expose the base steel sheet.

TABLE 7

| | | | | | Before butt welding | | | | | |
|---|---|---|---|---|---|---|---|---|---|---|
| | Coated steel | | Coated steel | | | Coated steel sheet 1 | | | | |
| | sheet 1 | | sheet 2 | | | | | | | Width of second |
| | Tensile | | Tensile | | | | | | | coated portion/ |
| | strength | | strength | | | | | Width of | Width of | (width of second |
| | after hot | | after hot | | | Second | | second | first | coated portion + |
| | press | Thick- | press | Thick- | Exposed | coated | | coated | exposed | width of first |
| | forming | ness | forming | ness | portion | portion | | portion | portion | exposed portion) × |
| No. | (MPa) | (mm) | (MPa) | (mm) | type | type | | (mm) | (mm) | 100 (%) |
| 1 | 1500 | 1.8 | 1500 | 1.8 | A | — | | 0 | 1.30 | 0.00 |
| 2 | 1500 | 1.8 | 1500 | 1.2 | A | — | | 0 | 1.30 | 0.00 |
| 3 | 1500 | 1.8 | 1500 | 1.2 | B | — | | 0 | — | 0.00 |
| 4 | 1500 | 1.8 | 1500 | 1.2 | C | — | | 0 | — | 0.00 |
| 5 | 1800 | 1.8 | 1300 | 1.3 | A | One surface | E | 0.04 | 1.20 | 3.23 |
| 6 | 1500 | 1.6 | 1300 | 1.2 | A | One surface | E | 0.10 | 1.20 | 7.69 |
| 7 | 1800 | 1.6 | 1500 | 1.2 | A | Both surfaces | E | 0.05 | 1.30 | 3.70 |
| 8 | 1500 | 2.0 | 1300 | 1.6 | A | — | | 0 | 1.50 | 0.00 |
| 9 | 1500 | 1.8 | 1300 | 1.2 | A | One surface | E | 0.20 | 1.20 | 14.29 |
| 10 | 1800 | 1.8 | 1800 | 1.3 | A | One surface | E | 0.20 | 0.70 | 22.22 |
| 11 | 1800 | 1.8 | 1300 | 1.3 | A | One surface | E | 0.20 | 0.30 | 40.00 |
| 12 | 1500 | 2.0 | 1500 | 1.2 | A | One surface | E | 0.30 | 1.00 | 23.08 |
| 13 | 1800 | 2.0 | 1300 | 1.3 | A | One surface | D | 0.15 | 1.50 | 9.09 |
| 14 | 1800 | 2.0 | 1300 | 1.3 | A | One surface | D | 0.25 | 3.00 | 7.69 |

| | Before butt welding | | | | | |
|---|---|---|---|---|---|---|
| | Coated steel sheet 2 | | | | | |
| | | | | | Width of second | |
| | | | | | coated portion/ | |
| | | | Width of | Width of | (width of second | |
| | Second | | second | first | coated portion + | |
| | coated | | coated | exposed | width of first | |
| | portion | | portion | portion | exposed portion) × | |
| No. | type | | (mm) | (mm) | 100 (%) | Remark |
| 1 | — | | 0 | 1.30 | 0.00 | Comparative |
| 2 | — | | 0 | 1.30 | 0.00 | Example |
| 3 | — | | 0 | — | 0.00 | |
| 4 | — | | 0 | — | 0.00 | |
| 5 | — | | 0 | 1.20 | 0.00 | Invention |
| 6 | One surface | E | 0.20 | 1.80 | 10.00 | Example |
| 7 | Both surfaces | E | 0.05 | 1.60 | 3.03 | |
| 8 | One surface | E | 0.25 | 1.40 | 15.15 | |
| 9 | — | | 0 | 0.70 | 0.00 | |
| 10 | One surface | E | 0.15 | 1.20 | 11.11 | |
| 11 | One surface | E | 0.20 | 0.50 | 28.57 | |
| 12 | One surface | E | 0.40 | 1.00 | 28.57 | |
| 13 | One surface | D | 0.15 | 1.50 | 9.09 | |
| 14 | One surface | D | 0.25 | 3.00 | 7.69 | |

The first exposed portion was formed by cutting with an end mill such that the removal width to be the first exposed portion as average value obtained by measuring the width at five places was in a range of 0.3 mm to 3.0 mm. In addition, the first exposed portion was formed over a total length of 10 cm on both surfaces of the end portion of the coated steel sheet on only one side of the four sides of the coated steel sheet excluding the region including the edge of the coated steel sheet.

According to the second coated portion type shown in Table 7, while forming the first exposed portion, the second coated portion was formed in the region including the end edge of the coated steel sheet on a side closer to the end edge of the coated steel sheet than to the first exposed portion. The second coated portion was formed so as to have the width of the second coated portion shown in Table 7.

Next, as shown in Table 7, two coated steel sheets (two steel sheets for butt welding) were prepared (coated steel sheet 1 and coated steel sheet 2), the end surfaces of the end portion having the first exposed portion and the second coated portion were butted, and welding was performed by laser welding. Thus, a tailored blank was prepared. The welding was adjusted so as to perform through welding under the conditions of a laser output of 3.0 kW (kilowatt) to 5.0 kW and a welding rate of 4.0 m/min (meter per minute) to 7.0 m/min.

The prepared tailored blank was held in a furnace heated to 920° C. for 4 minutes. Then, the tailored blank was formed with a water-cooled die and quenched to manufacture a flat hot stamped product.

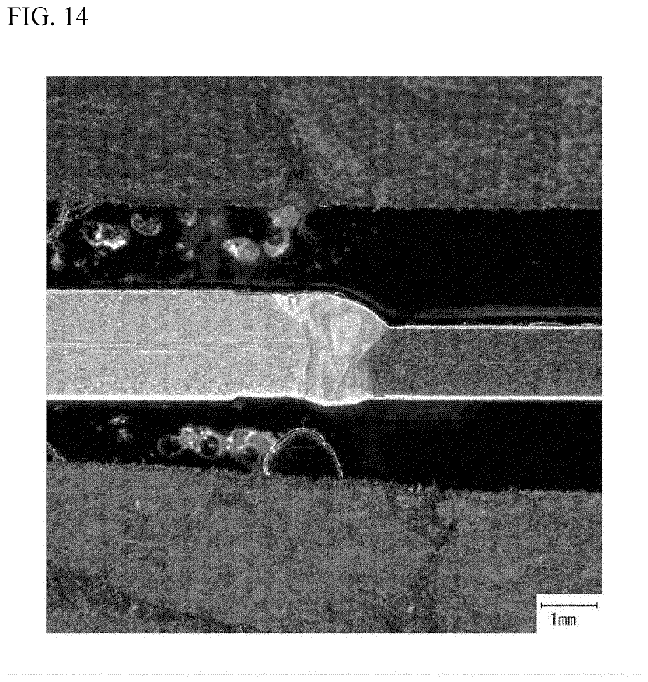

Here, the cross-sectional image of the tailored blank after hot press forming of Example No. 5 is shown in FIG. 14. A weld metal portion exists in the center portion of the tailored blank shown 14. The Vickers hardness of the weld metal portion was HV 420 or higher. In the cross-sectional image shown in FIG. 14, the white portion seen in the weld metal portion is not ferrite and this portion appears white due to light reflection.

<Evaluation>

(Fatigue Strength Test and Joint Static Strength)

From the obtained hot-stamping formed article, a dumbbell-shaped test piece having a welded portion was collected as a test piece for a tensile strength test and a test piece for a fatigue strength test.

The test piece was collected to have a parallel portion distance of 20 mm and a parallel portion width of 15 mm and to have a weld line in the center portion of the parallel portion over the entire length so as to be orthogonal to the longitudinal direction. Using this test piece, a fatigue strength test and a joint static strength were conducted.

The joint static strength (expressed as static strength) was calculated by dividing a load by the tensile strength x the cross section product on the side with the smaller sheet thickness.

The fatigue strength test (expressed as fatigue limit) was performed using an electromagnetic resonance type fatigue strength tester under the conditions of a load control axial force full pulsating tensile, a stress ratio of 0.1, a stress repetition number of 10⁷, and a repetition rate of about 80 Hz in a room temperature atmosphere. These results are shown in Table 8.

(Test for Corrosion Resistance after Coating)

After the obtained hot-stamping formed article was subjected to a chemical conversion treatment, electrodeposition coating was performed and a test for corrosion resistance after coating was performed. The chemical conversion treatment was performed with a chemical conversion treatment solution PB-SX35T manufactured by Nippon Parkerizing Co., Ltd. Thereafter, as an electrodeposition coating, a cationic electrodeposition coating POWERNICS 110 manufactured by Nippon Paint Co., Ltd. was used and the electrodeposition coating was applied to the hot-stamping formed article to have a target electrodeposition film thickness of about 15 μm. The hot-stamping formed article was washed with water and then baked by heating at 170° C. for 20 minutes to prepare a test sheet. The size of the test sheet was 65 mm long and 100 mm wide (there is a welded portion at the center portion of the width).

Using this test sheet, the corrosion resistance after coating was evaluated the corrosion state after the elapse of 360 cycles (120 days) using a vehicle component external appearance corrosion test JASO M610-92.

The evaluation of the corrosion resistance after coating was performed based on the maximum corrosion depth, and the weld metal portion was evaluated using a point micrometer according to the following determination criteria.

—Determination Criteria—

A: The maximum corrosion depth is less than 0.2 mm.

D: The maximum corrosion depth is 0.2 mm or more.

The tensile strength column of the coated steel sheet after hot press forming and the thickness column of the coated steel sheet in Tables 5 to 7 are expressed as the nominal tensile strength and the nominal sheet thickness. In addition, the coated steel sheet is a steel sheet obtained by applying aluminum coating to the base steel sheet.

Further, in Table 7, “A”, “B”, and “C” in the exposed portion type column are as follows. In A, the first exposed portion in which the base steel sheet is exposed is formed.

A: The aluminum coating layer and the intermetallic compound layer are removed.

B: The aluminum coating layer is removed.

C: The aluminum coating layer and the intermetallic compound layer remain (are not removed).

In Table 7, the notations “—”, “D”, and “E” in the second coated portion type column are as follows.

—: There is no second coated portion (only the first exposed portion was formed).

D: Only the intermetallic compound layer remains (only the aluminum coating layer of the second coated portion is removed).

E: The aluminum coating layer and the intermetallic compound layer remain.

In Table 7, the width of the second coated portion is a value obtained by measuring a distance from the end edge of the coated steel sheet (steel sheet for butt welding) to the boundary between the second coated portion and the first exposed portion by the method described above.

In Table 8, the numerical value in the sheet thickness ratio column is a value obtained by calculating the sheet thickness ratio of the base steel sheet according to Expression (11) above at the position corresponding to the first exposed portion of the coated steel sheet and the position of the first coated portion.

TABLE 8

| | After butt welding and hot press forming | | | | | |
|---|---|---|---|---|---|---|
| | Al | | | | | |
| | concentration | | | | Corrosion | |
| | of first weld | Sheet | Static | Fatigue | resistance | |
| | metal portion | thickness | strength | strength | after | |
| No. | (% by mass) | ratio | (MPa) | (MPa) | coating | Remark |
| 1 | 0.03 | 0.97 | 1530 | 470 | D | Comparative |
| 2 | 0.03 | 0.95 | 1542 | 430 | D | Example |
| 3 | 0.21 | 1.00 | 1530 | 345 | A | |
| 4 | 1.10 | 1.00 | 1280 | 340 | A | |
| 5 | 0.08 | 0.98 | 1320 | 420 | A | Invention |
| 6 | 0.17 | 0.92 | 1315 | 410 | A | Example |
| 7 | 0.12 | 1.00 | 1500 | 420 | A | |
| 8 | 0 11 | 0.95 | 1330 | 410 | A | |
| 9 | 0.12 | 0.95 | 1330 | 425 | A | |
| 10 | 0.14 | 0.96 | 1815 | 435 | A | |
| 11 | 0.17 | 0.97 | 1310 | 425 | A | |
| 12 | 0.39 | 0.98 | 1515 | 415 | A | |
| 13 | 0.14 | 0.98 | 1320 | 425 | A | |
| 14 | 0.20 | 0.97 | 1340 | 415 | A | |

In Table 8, the Al concentration of the first weld metal portion is a value measured according to the method described above.

As shown in Table 8, in Nos. 1 and 2 in which both the aluminum coating layer and the intermetallic compound layer are removed and the second coated portion is provided, the fatigue strength is excellent. However, since the concentration of aluminum in the first weld metal portion is low, the corrosion resistance after coating is inferior.

In No. 3 in which the aluminum coating layer is removed, the intermetallic compound layer remains, and the first exposed portion of the base steel sheet is not provided, although the corrosion resistance after coating is excellent, the fatigue strength is inferior.

In No. 4 in which neither the aluminum coating layer nor the intermetallic compound layer was removed, the corrosion resistance after coating is excellent. However, the fatigue strength is inferior and further, the static strength is inferior.

On the other hand, as shown in Table 8, in Nos. 5 to 14 using a coated steel sheet having an end portion in which both the aluminum coating layer and the intermetallic compound layer are removed to form an exposed portion and further, the second coated portion is formed at the end edge of the coated steel sheet, the fatigue strength and the corrosion resistance after coating are excellent.

### Second Embodiment

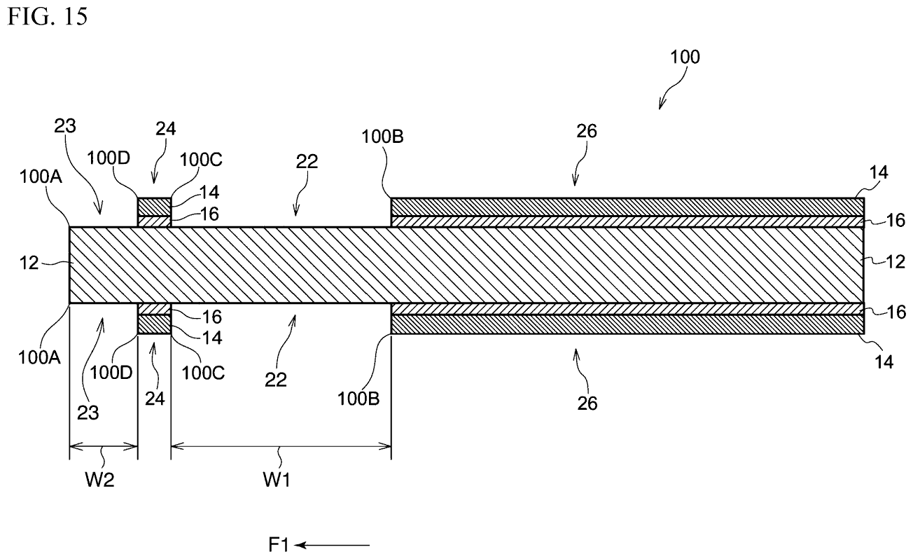

Next, a second embodiment of the present disclosure will be described with reference to FIGS. 15 to 20, 38, and 39. However, the same portions as those in the above embodiment are denoted by the same reference numerals, description thereof is omitted, and only different points will be described.

In the following description, in a case where there is no distinction between the first exposed portion and the second exposed portion, these portions are simply referred to as an exposed portion.

In the steel sheet for butt welding according to the first embodiment, the second coated portion is provided in the region including the end edge, but there is no limitation thereto. As long as the second coated portion is provided on the end edge side and is in a position incorporated in the weld metal portion during butt welding, the second coated portion and the end edge may be separated from each other. Hereinafter, the second embodiment in which the second exposed portion is provided between the second coated portion and the end edge of the steel sheet for butt welding will be described.

<Steel Sheet for Butt Welding>

The steel sheet for butt welding of the present disclosure includes, in addition to each configuration of the steel sheet for butt welding 100 of the first embodiment, a second exposed portion in which the base steel sheet 12 is exposed is provided between the end edge 100A of the steel sheet for butt welding and a second coated portion 24 in the first direction.

The distance from the end edge of the steel sheet for butt welding to the second coated portion 24 (the width of the second exposed portion) is preferably smaller than the distance from the end edge of the first coated portion 26 to the second coated portion 24 (the width of the first exposed portion).

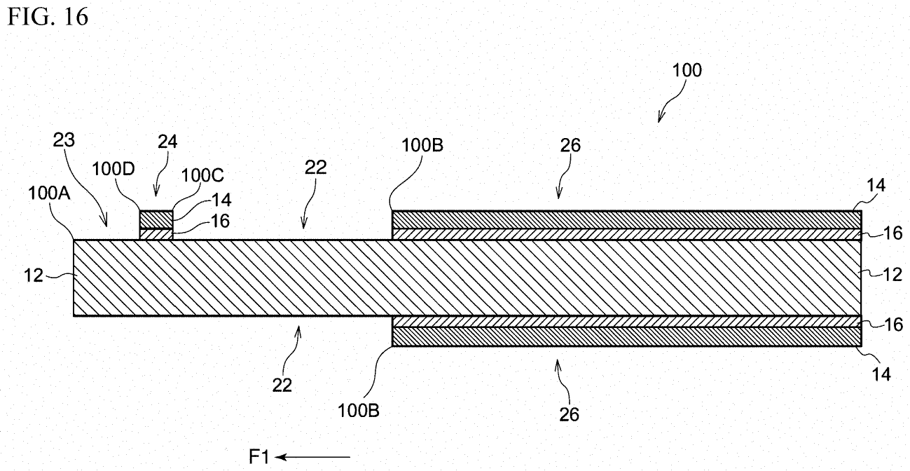

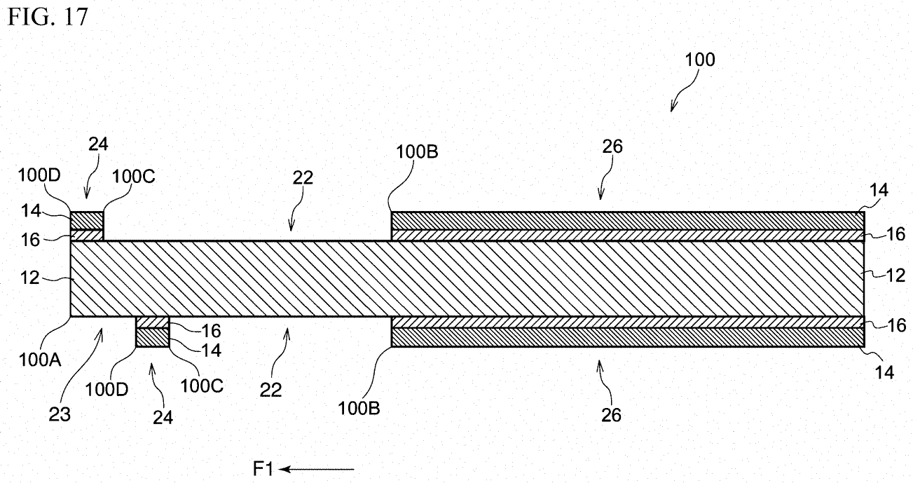

FIG. 15 is a schematic cross-sectional view showing an example of the end portion having the exposed portion of the base steel sheet, and the second coated portion in which the intermetallic compound layer and the aluminum coating layer remain in the steel sheet for butt welding of the present disclosure. FIG. 16 is a schematic cross-sectional view showing another example of the end portion having the exposed portion of the base steel sheet, and the second coated portion in which the intermetallic compound layer and the aluminum coating layer remain in the steel sheet for butt welding of the present disclosure. FIG. 17 is a schematic cross-sectional view showing still another example of the end portion having the exposed portion of the base steel sheet, and the second coated portion in which the intermetallic compound layer and the aluminum coating layer remain in the steel sheet for butt welding of the present disclosure.

In FIGS. 15 to 17, 100C and 100D represent end edges in the second coated portion 24, respectively. 100D represents the end edge of the second coated portion 24 at the boundary with a second exposed portion 23 in the vicinity of the end edge 100A of the steel sheet for butt welding 100. 100C represents the end edge of the second coated portion 24 at the boundary with the first exposed portion 22 located in the vicinity of the center portion (first coated portion 26) of the steel sheet for butt welding 100.

As shown in FIGS. 15 to 17, the steel sheet for butt welding 100 of the present disclosure includes, in addition to each configuration of the steel sheet for butt welding 100 of the first embodiment, a second exposed portion 23 in which the base steel sheet 12 is exposed between the end edge 100A of the steel sheet for butt welding 100 and the second coated portion 24 in the first direction F1. In the first direction F1, the end edge 100A of the steel sheet for butt welding 100 and the second exposed portion 23 are adjacent to each other.

The second coated portion 24 is provided so as to be interposed between the first exposed portion 22 and the second exposed portion 23. The distance from the end edge 100A of the steel sheet for butt welding 100 to the end edge 100D of the second coated portion 24 (W2 shown in FIG. 15; the width of the second exposed portion 23 in the first direction F1; hereinafter, also simply referred to as the width of the second exposed portion 23) is preferably smaller than the distance from the end edge 100B of the first coated portion 26 to the end edge 100C of the second coated portion 24 (W1 shown in HG 15; the width of the first exposed portion 22). That is, the second coated portion 24 is preferably provided such that the relationship between the width of the first exposed portion 22 and the width of the second exposed portion 23 satisfies the relationship between W2<W1 (the width W2 of the second exposed portion 23 smaller than the width W1 of the first exposed portion 22).

As long as the second exposed portion 23 in which the base steel sheet 12 is exposed is provided between the end edge 100A of the steel sheet for butt welding 100 and the second coated portion 24 in the first direction F1 in the steel sheet for butt welding 100 of the present disclosure, the embodiment of the end portion is not particularly limited. In the steel sheet for butt welding 100 shown in FIG. 15, although the embodiment in which the second coated portion 24 is provided at substantially the same position on both surfaces of the end portion, (that is, the distance between W1s on both surfaces and the distance between W2s on both surfaces are the same) is shown, the second coated portion 24 may be provided at different positions. In the steel sheet for butt welding 100 shown in FIG. 15, the second coated portion 24 provided on one surface may be provided closer to the end edge 100A of the steel sheet for butt welding 100 than the second coated portion 24 provided on the other surface.

Further, the second coated portion 24 may be provided as shown in FIG. 16 or FIG. 17. In the steel sheet for butt welding 100 shown in FIG. 16, the second coated portion 24 and the first exposed portion 22 are provided on one surface of the end portion. On the other hand, only the first exposed portion 22 is formed on the other surface of the end portion. That is, in the steel sheet for butt welding 100 shown in FIG. 16, as in the steel sheet for butt welding 100 shown in FIG. 15, the second coated portion 24 is formed to be interposed between the first exposed portion 22 and the second exposed portion 23 on one surface of the end portion. In addition, the first exposed portion 22 is formed over the region from the end edge 100A of the steel sheet for butt welding 100 to the end edge 100B of the first coated portion 26 on the other surface of the end portion.

In the steel sheet for butt welding 100 shown in FIG. 17, as in the steel sheet for butt welding 100 shown in FIG. 15, the second coated portion 24 and the first exposed portion 22 are provided on one surface of the end portion. The second coated portion 24 is provided in the region including the end edge 100A of the steel sheet for butt welding 100 on the other surface of the end portion, and the end edge 100D of the second coated portion 24 is located at the end edge 100A of the steel sheet for butt welding 100. That is, the first exposed portion 22 provided on the other surface of the end portion is provided between the end edge 100B in the first coated portion 26 to the end edge 100C of the second coated portion 24.

The steel sheet for butt welding 100 of the present disclosure has been described above with reference to FIGS. 15 to 17, but the steel sheet for butt welding of the present disclosure is not limited to these.

In addition, in the steel sheet for butt welding 100 of the present disclosure, the thickness of the base steel sheet 12 in the exposed portion provided in the end portion of the steel sheet for butt welding 100 may be the same as the thickness of the base steel sheet 12 at the first coated portion 26. Further, in the steel sheet for butt welding 100 of the present disclosure, the thickness of the base steel sheet 12 in the exposed portion provided in the end portion of the steel sheet for butt welding 100 may be smaller than the thickness of the base steel sheet 12 in the first coated portion 26.

Further, at the boundary between the first coated portion 26 and the first exposed portion 22, when the steel sheet for butt welding 100 is viewed from the cross section, the end surface of the first coated portion 26 may be inclined to the outside in the thickness direction.

<Exposed Portion>

The exposed portion is formed in the end portion of the welding scheduled portion of the steel sheet for butt welding 100. Then, as shown in FIG. 38, in the end portion in which the exposed portions 22 and 23 are formed, which is a welding scheduled portion, the exposed portions 22 and 23 in which the base steel sheet 12 is exposed are provided on at least a part of both surfaces. The exposed portions 22 and 23 have the first exposed portions 22 provided in contact with the end edge of the steel sheet for butt welding 100 and along the end edge of the steel sheet for butt welding 100 on at least one surface of the steel sheet for butt welding 100. In addition, the exposed portions have the second exposed portions 23 provided in contact with the end edge of the first coated portion 26 and along the end edge of the first coated portion 26. The width W2 of the second exposed portion 23 is shorter than the width W1 of the first exposed portion 22.

In addition, in a case where the surface provided with only the exposed portion is provided in the end portion in which the exposed portion is formed, the exposed portion (first exposed portion 22) is provided over the entire width from the end edge of the end portion of the steel sheet for butt welding 100 to the end edge 100B of the first coated portion 26 (refer to FIG. 16).

The first exposed portion 22 to be formed on both surfaces of the end portion of the steel sheet for butt welding 100 may be formed as follows. That is, in the embodiment in which when the end portions of the steel sheet for butt welding 100 are butt-welded, the first exposed portion 22 in which the base steel sheet 12 is exposed is formed between the weld metal portion and the first coated portion 26, the first exposed portion 22 is formed in the steel sheet for butt welding 100. The second coated portion 24 is provided in the vicinity of the end edge of the steel sheet for butt welding 100 by forming the second exposed portion 23 between the second coated portion and the end edge 100A of the steel sheet for butt welding 100.

The width of the range in which the exposed portion is formed may be 0.1 mm or more and 5.0 mm or less. In the present disclosure, the width of the range in which the exposed portion is formed is a distance from the end edge 100A of the end portion of the steel sheet for butt welding 100 to the end edge 100B of the first coated portion 26 (in a case of FIG. 15, which represents a total of W1 and the width W2 of the second coated portion 24).

In a case where the butt welding is laser welding, the width of the range in which the exposed portion is formed is preferably 0.5 mm or more and the width of the range in which the exposed portion is formed is preferably 1.5 mm or less. In a case where the butt welding is plasma welding, the width of the range in which the exposed portion is formed is preferably 1.0 mm or more and the width of the range in which the exposed portion is formed is preferably 4.0 mm or less. By setting the width of the range in which the exposed portion is formed to 0.2 mm to 4.6 mm (on average), when formed into a hot stamped product, deterioration in joint fatigue strength is easily controlled.

The thickness of the base steel sheet 12 in the exposed portion in the end portion of the steel sheet for butt welding 100 is an average value of measurement values in the first exposed portion 22. The thickness of the base steel sheet 12 in the first coated portion 26 is an average thickness in this region. In addition, the sheet thickness ratio is an average value.

The thickness of the base steel sheet 12 in the first exposed portion 22 in the end portion of the steel sheet for butt welding 100 and the thickness of the base steel sheet 12 in the center portion of the steel sheet for butt welding 100 can be obtained by cutting the steel sheet for butt welding 100 in the thickness direction and observing the cut cross section with an optical microscope. In the cut cross section, the thickness of the base steel sheet 12 in the first exposed portion 22 and the thickness of the base steel sheet 12 in the center portion of the steel sheet for butt welding 100 may be measured.

In the end portion of the steel sheet for butt welding 100 to be applied as a blank material, in a case where a region in which the second coated portion 24 is provided to face the exposed portion exists on the surface opposite to the surface in which the second exposed portion is provided, the thickness of the base steel sheet 12 in the exposed portion is measured in a part excluding this region. That is, the thickness of the base steel sheet 12 in the exposed portion is an average value obtained by measuring the thicknesses in the part in which the base steel sheet 12 is exposed on both surfaces.

Specifically, the thickness of the base steel sheet 12 in the exposed portion is an average value obtained as follows. The thickness of the base steel sheet 12 at the exposed portion is measured from the cross section of the steel sheet for butt welding 100 at a position where the width of the first exposed portion 22 in the first direction F1 is divided into two equal parts. At this time, the exposed portion is divided into five parts the longitudinal direction in plan view, and five places are measured to obtain the average value.

Regarding the thickness of the second coated portion 24, as in the first embodiment, in the longitudinal direction of the first exposed portion 22, at the positions of five places obtained by dividing the entire length of the second coated portion 24 into five equal parts, the thickness of the second coated portion 24 is obtained at the positions where the width of the second coated portion 24 is divided into two equal parts in the first direction F1, and the average value of the obtained values is used as the thickness of the second coated portion 24.

The same applies to the thickness of the intermetallic compound layer 16 or the like.

<Second Coated Portion>

The second coated portion 24 is provided on at least one surface of the steel sheet for butt welding 100 so as to be interposed between the first exposed portion 22 and the second exposed portion 23 in the first direction F1. The second coated portion 24 is provided in a range in which the width W2 of the second exposed portion 23 is smaller than the width W1 of the first exposed portion 22. For example, the ratio of W2/W1 is preferably 0.01 to less than 1.

The second coated portion 24 to be formed on at least one surface of the end portion of the steel sheet for butt welding 100 may be formed such that after welding is performed in a state in which the end surfaces of the steel sheet for butt welding 100 having the exposed portion and the second coated portion 24 are butted together, the second coated portion 24 does not exist at the boundary between a weld metal to be formed in the tailored blank and the steel sheet for butt welding 100 (the exposed portion of the base steel sheet 12). That is, after butt welding, the second coated portion 24 is provided between the second exposed portion 23 provided on at least one surface of the end portion of the steel sheet for butt welding 100 and the first exposed portion 22 provided along the end edge of the first coated portion 26 in the vicinity of the end edge of the steel sheet for butt welding 100 so that the second coated portion is included in the weld metal.

The second coated portion 24 is preferably provided in a range in which a distance from the end edge 100A of the end portion of the steel sheet for butt welding 100 to the second coated portion 24 (the width of the second exposed portion 23) is 0.01 mm or more and a distance from the end edge of the first coated portion 26 to the second coated portion 24 (the width of the first exposed portion 22) is 0.05 mm or more.

The method of measuring these distances is the same as the method of measuring the width of the exposed portion described later.

Here, with reference to FIG. 15, the width W2 of the second exposed portion 23 is preferably 0.01 mm or more. The width W1 of the first exposed portion 22 is preferably 0.1 mm or more.

In a case where the second exposed portion is provided, the second coated portion 24 is preferably provided in a range of 0.55 mm from the end edge 100A of the steel sheet for butt welding 100. When the second coated portion 24 is provided in this range, the second coated portion 24 is easily included in the weld metal after butt welding. The second coated portion 24 is preferably provided in a range of 0.4 mm from the end edge 100A of the steel sheet for butt welding 100 and more preferably provided in a range of 0.3 mm from the end edge 100A of the steel sheet for butt welding 100.

In addition, the width of the second coated portion 24 provided in the end portion of the steel sheet for butt welding 100 is preferably as follows. In a case where butt welding is laser welding, the width of the second coated portion 24 is preferably 0.05 mm or more and the width of the second coated portion 24 is preferably 0.30 mm or less. In a case of using plasma welding, the width of the second coated portion 24 is preferably 0.10 mm or more and the width of the second coated portion 24 is preferably 0.60 mm or less.

In a case where the width of the second coated portion 24 changes at each position in the direction in which the second coated portion 24 extends, the width of the second coated portion 24 may be defined as the absolute maximum value of the width of the second coated portion 24 at each position in the direction in which the second coated portion 24 extends.

Here, the width of the first exposed portion 22 is an average value obtained by measuring the width of the first exposed portion 22 at five places obtained by dividing the entire length into five equal parts in the direction in which the first exposed portion 22 extends. Similarly, the width of the second exposed portion 23 is an average value obtained by measuring the width of the second exposed portion 23 at five places obtained by dividing the entire length into five equal parts in the direction in which the first exposed portion 22 extends, and the width of the second coated portion 24 is an average value obtained by measuring the width of the second coated portion 24 at five places obtained by dividing the entire length into five equal parts in the direction in which the first exposed portion 22 extends.

The width of the first exposed portion 22, the width of the second exposed portion 23, and the width of the second coated portion 24 are measured as follows.

Measurement samples including cross sections in which the entire widths of the exposed portions 22 and 23 and the second coated portion 24 formed in the end portion of the steel sheet for butt welding 100 can be observed (for example, the cross section of the steel sheet for butt welding 100 in the first direction F1 in plan view) are collected from five places. The measurement samples are collected from five places obtained by dividing the length of the exposed portion 22 and 23 formed in a direction along the end edge 100A of the steel sheet for butt welding 100 into five equal parts. Next, cutting is performed so that the cross section of the steel sheet for butt welding 100 is exposed. Thereafter, the cut measurement samples are embedded in a resin, polishing is performed, and the cross section is magnified with a microscope. Then, for each sample, the width of the second exposed portion 23 which is a distance from the end edge 100A of the steel sheet for butt welding 100 to the second coated portion 24, and the width of the first exposed portion 22 which is a distance from the second coated portion 24 to the first coated portion 26 are measured. In addition, for each sample, a distance between both end edges in the second coated portion 24 is measured.

In addition, as the proportion of the width of the second coated portion 24 formed in the end portion in which welding is scheduled, a percentage of (width of second coated portion 24/(width of second coated portion 24+width of exposed portion), which is a value for a total of the width of the second coated portion 24 and the width of the exposed portion (the width of the first exposed portion 22 and the second exposed portion 23), may be in a range of 3% to 50%. When the width of the second coated portion 24 is in this range, deterioration in fatigue strength is suppressed and excellent corrosion resistance after coating is effectively obtained. A preferable lower limit of the proportion of the width of the second coated portion 24 is 5%. On the other hand, a preferable upper limit of the proportion of the width of the second coated portion 24 is 40% and a more preferable upper limit is 30%.

In the steel sheet for butt welding 100 of the present disclosure, not only the aluminum coating layer 14 but also the intermetallic compound layer 16 are removed on at least a part of both surfaces of the end portion of the steel sheet for butt welding 100 and the exposed portion 22 and 23 in which the base steel sheet 12 is exposed are provided. Further, in the end portion in which the exposed portions 22 and 23 are provided, the second coated portion 24 is provided while being interposed between the two exposed portion 22 and 23. Then, the second coated portion 24 is provided such that the width of the second exposed portion 23 is smaller than the width of the first exposed portion 22. That is, the steel sheet for butt welding 100 of the present disclosure does not have a hard and brittle intermetallic compound layer 16 in the exposed portions 22 and 23 in which the base steel sheet 12 is exposed. In addition, in the steel sheet for butt welding 100 of the present disclosure, the second coated portion 24 in which the intermetallic compound layer 16 and the aluminum coating layer 14 remain exists in the vicinity of the end edge of the steel sheet for butt welding 100 through the second exposed portion 23 between the second coated portion and the end edge 100A of the steel sheet for butt welding 100.

Accordingly, a tailored blank obtained by using the steel sheets for butt welding 100 of the present disclosure as blank materials and performing welding while butting the end surfaces of the end portions having the exposed portion and the second coated portion 24 in the steel sheets for butt welding 100 of the present disclosure does not have a hard and brittle intermetallic compound layer 16 at the boundary between the weld metal and the steel sheet for butt welding 100. A portion in the vicinity of the end edge 100B of the first coated portion 26 in the weld metal portion does not contain the aluminum of the intermetallic compound layer 16 and the aluminum coating layer 14. In addition, the second coated portion 24 is incorporated in the weld metal portion after butt welding after butt welding (that is, an appropriate amount of aluminum of the second coated portion 24 is mixed into the weld metal portion).

For this reason, even in a case where this tailored blank is formed into a hot stamped product, it is considered that deterioration in the fatigue strength of the joint is suppressed. In addition, since the generation of scale is suppressed on the surface of the weld metal portion, chemical convertibility is improved and the adhesion of the coating is improved. Therefore, it is considered that even after coating the hot stamped product, the corrosion resistance of the weld metal portion after coating is excellent.

Further, the portion in the vicinity of the end edge 100B of the first coated portion 26 in the weld metal portion hardly contains aluminum of the intermetallic compound layer 16 and the aluminum coating layer 14. Thus, it is possible to suppress deterioration in the fatigue strength of the weld metal portion due to softening of the weld metal portion of this portion.

Further, in the steel sheet for butt welding 100 of the present disclosure, the second coated portion 24 exists in the vicinity of the end edge 100A of the steel sheet for butt welding 100 such that the second coated portion is separated from the end edge 100A of the steel sheet for butt welding 100 and is interposed between the two exposed portions 22 and 23. Therefore, in handling such as conveyance before the steel sheets for butt welding 100 are joined, the second coated portion 24 is hardly peeled off. As a result, there is an advantage that an appropriate amount of aluminum can be easily mixed in the weld metal portion.

In the steel sheet for butt welding 100 of the present disclosure, in the end portion of the welding scheduled portion, the second coated portion 24 is formed to be interposed between the first exposed portion 22 and the second exposed portion 23 of the base steel sheet 12 described above. The following embodiment is also included in the second coated portion 24 as long as deterioration in the fatigue strength of the weld metal portion can be suppressed and the corrosion resistance after coating can be maintained.

For example, when the coated steel sheet is punched to obtain a punched member that becomes a blank material, cutting means such as a shear may be employed. When cutting is performed with a shear, in a region including the end edge of the coated steel sheet, sagging may occur on one surface, and burring may occur on the other surface.

The intermetallic compound layer and the aluminum coating layer are removed from the end portion of the coated steel sheet on which sagging and burring occur by cutting, for example. At this time, by grinding the surface where the burring occurs, the second exposed portion 23 can be provided in the region in contact with the end edge of the coated steel sheet. In addition, the second coated portion 24 can be provided so that the intermetallic compound layer 16 and the aluminum coating layer 14 remain closer to the center portion of the coated steel sheet than to the region in which burring occurs. Further, the first exposed portion 22 can be provided closer to the center portion than to the region which becomes the second coated portion 24. On the other hand, in the portion in which sagging occurs, the second coated portion 24 can be provided so that the intermetallic compound layer 16 and the aluminum coating layer 14 remain in the region including the end edge of the coated steel sheet. In the portion in which sagging occurs, the second coated portion 24 may be provided, but the intermetallic compound layer 16 and the aluminum coating layer 14 may be removed so that the base steel sheet 12 is exposed.

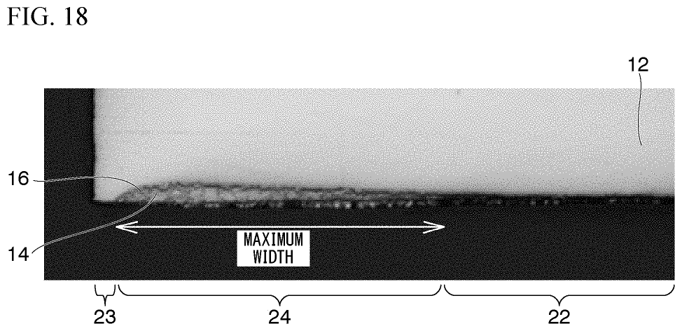

FIG. 18 is a cross-sectional image showing an example of the end portion having the exposed portions 22 and 23 and the second coated portion 24 f the base steel sheet 12 in the steel sheet for butt welding 100 according to the second embodiment of the present disclosure. The end portion of the steel sheet for butt welding 100 shown in FIG. 18 is shown as an enlarged image when the exposed portions 22 and 23 and the second coated portion are formed by removing the surface in which burring occurs by cutting in the end portion of the steel sheet for butt welding 100.

The second exposed portion 23 is provided by cutting the surface in which burring occurs so that the base steel sheet 12 is exposed. In addition, the first exposed portion 22 is provided by cutting so that the base steel sheet 12 is exposed. The second coated portion 24 is provided by cutting so that the first exposed portion 22 in which the intermetallic compound layer 16 and the aluminum coating layer 14 remain is formed. The second coated portion 24 shown in FIG. 18 has the intermetallic compound layer 16 and the aluminum coating layer 14.

The aluminum contained in the second coated portion 24 is mixed with the weld metal in an appropriate amount, and thus the corrosion resistance after coating of the weld metal portion becomes excellent. Therefore, in the steel sheet for butt welding 100 of the present disclosure, when cutting the surface where burring occurs, the aluminum coating layer 14 and the intermetallic compound layer 16 remaining closer to the center of the steel sheet for butt welding 100 than to the portion where the burring occurs may be used as the second coated portion 24. The second coated portion 24 may be cut to a degree that the intermetallic compound layer 16 and the aluminum coating layer 14 remain.

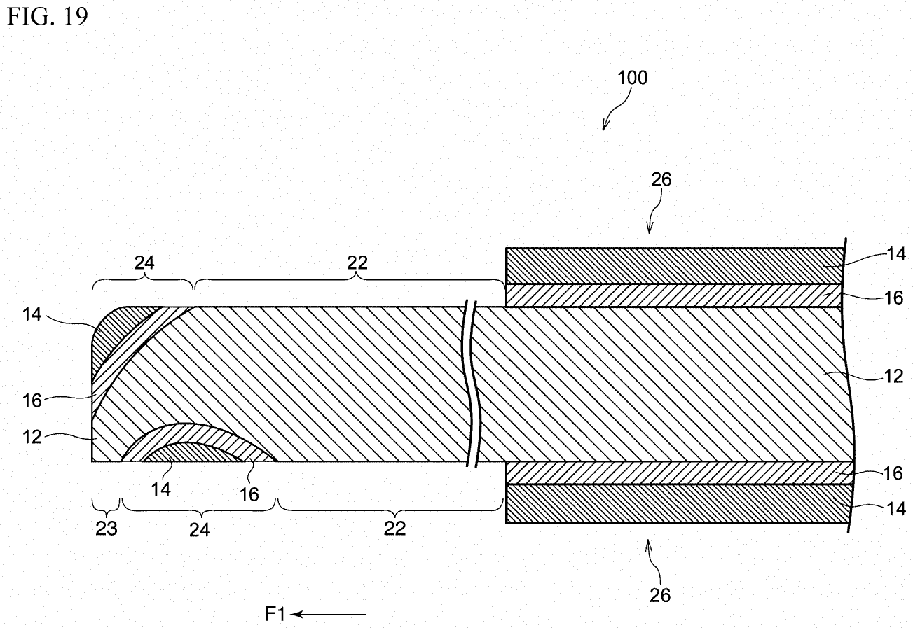

FIG. 19 is a schematic enlarged cross-sectional view showing another example of the end portion having the exposed portion and the second coated portion of the base steel sheet 12 in the steel sheet for butt welding 100 according to the second embodiment of the present disclosure. FIG. 19 schematically shows a state the end portion of the steel sheet for butt welding 100 in which sagging occurs on one surface of the end portion and burring occurs on the other surface is cut. By allowing the intermetallic compound layer 16 and the aluminum coating layer 14 to remain in the portion in which sagging occurs on the surface in which sagging occurs, the second coated portion 24 is provided along the end edge of the steel sheet for butt welding 100. On the surface in which burring occurs, the first exposed portion 22 and the second coated portion 24 are provided by cutting. By cutting the surface in which burring occurs, the second exposed portion 23 is formed. In addition, the second coated portion 24 is formed closer to the center portion of the steel sheet for butt welding 100 than to the second exposed portion 23 so that the intermetallic compound layer 16 and the aluminum coating layer 14 remain. Further, the first exposed portion 22 is formed closer to the center portion of the steel sheet than to the second coated portion 24.

Although the second coated portion 24 is provided in the portion in which sagging occurs in the end portion of the steel sheet for butt welding 100 shown in FIG. 19, the base steel sheet 12 may be exposed by cutting the second coated portion 24 in the portion in which sagging occurs. In addition, in the second coated portions 24 provided on both surfaces shown in FIG. 19, both the intermetallic compound layer 16 and the aluminum coating layer 14 remain.

As an example of a preferable method of forming the exposed portion and the second coated portion 24 on at least a part of both surfaces in the end portion of the coated steel sheet (steel sheet for butt welding), for example, the following method may be mentioned.

This method is a method of performing a step of removing the intermetallic compound layer 16 and the aluminum coating layer 14 formed on the base steel sheet 12 are removed by cutting on at least a part of both surfaces of the end portion of the coated steel sheet to provide the exposed portion in which the base steel sheet 12 is exposed to provide and the second coated portion 24 in which the intermetallic compound layer 16 and the aluminum coating layer 14 remain (referred to as formation method C).

In the step, in the end portion in which the exposed portion is provided, on both surfaces of the coated steel sheet, as exposed portions, the second exposed portion 23 which is in contact with the end edge of the coated steel sheet and formed along the end edge of the coated steel sheet, and the first exposed portion 22 which is in contact with the end edge of the first coated portion 26 and formed along the end edge of the first coated portion 26 are formed. When the step is performed, a distance from the end edge of the coated steel sheet to the second coated portion 24 is preferably shorter than a distance from the end edge of the first coated portion 26 to the second coated portion 24.

The formation method C is, for example, a method of forming the exposed portion and the second coated portion 24 in the end portion of the coated steel sheet as follows. First, as a coated steel sheet (blank material) before the steel sheet for butt welding is formed, a coated steel sheet cut into a desired size is prepared. Next, the aluminum coating layers 14 and the intermetallic compound layers 16 formed on both surfaces of the base steel sheet 12 are removed by cutting in at least a part of the both surfaces of the end portion of the cut coated steel sheet. Then, in the end portion of the coated steel sheet, the second exposed portion 23 in which the base steel sheet 12 is exposed is formed along the end edge of the coated steel sheet. At this time, the second coated portion 24 is formed adjacent to the second exposed portion 23 provided along the end edge in the end portion of the coated steel sheet. Further, the first exposed portion 22 is formed along the end edge in the first coated portion 26 to be adjacent to the second coated portion 24. The second coated portion 24 is formed such that the width of the second exposed portion 23 is smaller than the width of the first exposed portion 22.

When the exposed portions 22 and 23 and the second coated portion 24 described above are formed on at least a part of both surfaces of the end portion of the steel sheet for butt welding 100, the order of forming the exposed portions 22 and 23 and the second coated portion 24 in the end portion is not limited to the above formation method C.

As an example of another preferable method of forming the exposed portions 22 and 23 and the second coated portion 24 described above on at least a part of both surfaces of the end portion of the coated steel sheet, for example, the following method may be used.

This method is a method of performing a step of removing the aluminum coating layer 14 and the intermetallic compound layer 16 formed on the base steel sheet 12 by cutting on at least a part of both surfaces of the coated steel sheet to provide the exposed portion in which the base steel sheet 12 is exposed, the second coated portion 24 in which the intermetallic compound layer 16 and the aluminum coating layer 14 remain, and the first coated portion 26 (referred to as formation method D).

In the step, a first process and a second process are performed.

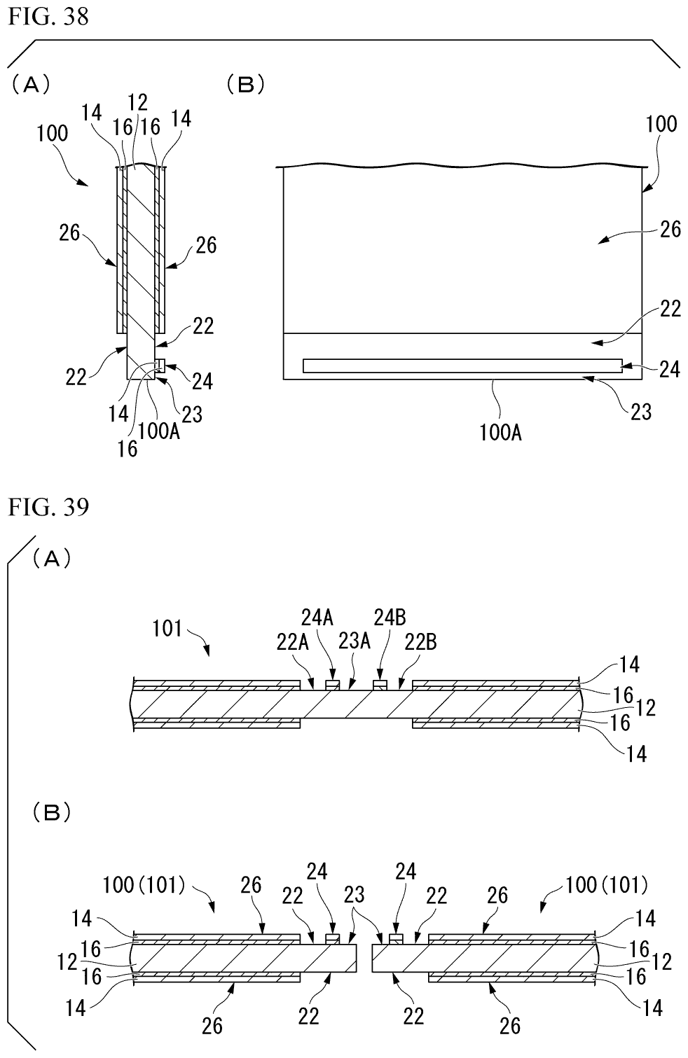

As shown in (A) of FIG. 39, in the first process, in a portion which becomes the end portion in which the first coated portion 26 and the exposed portions 22 and 23 are provided, on at least one surface of the coated steel sheet 101, a first exposed portion region 22A which becomes the first exposed portion 22, a second coated portion region 24A which is adjacent to the first exposed portion region 22A and becomes the second coated portion 24, a second exposed portion region 23A which is adjacent to the second coated portion region 24A and becomes the second exposed portion 23, a second coated portion region 24B which is adjacent to the second exposed portion region 23A and becomes the second coated portion 24, and a first exposed portion region 22B which is adjacent to the second coated portion region 24B and becomes the first exposed portion 22 are formed in this order.

In the second process, as shown in (B) of FIG. 39, by cutting the coated steel sheet 100 at the second exposed portion region 23A, the first exposed portion 22 is formed along the end edge of the first coated portion 26, the second exposed portion 23 is formed along the end edge of the coated steel sheet 101, and the second coated portion 24 is formed to be interposed between the exposed portions 22 and 23. Through the above steps, two steel sheets for butt welding 100 are manufactured.

In the second process, a distance from the end edge of the coated steel sheet 101 to the second coated portion 24 is preferably smaller than a distance from the end edge of the first coated portion 26 to the second coated portion 24.

For example, the formation method D is specifically the following method. First, a coated steel sheet 101 which is punched and cut into a desired size (blank material) is prepared. Next, on the cut coated steel sheet 101, an exposed portion region in which the base steel sheet 12 is exposed is formed by removing the aluminum coating layer 14 and the intermetallic compound layer 16 formed on the base steel sheet 12 by cutting. Three exposed portion regions are formed through the second coated portion 24 in regions excluding the first coated portion 26 so as to extend in one direction, for example. The three exposed portion regions include exposed portion regions which become the first exposed portions 22, and an exposed portion region which becomes the second exposed portion 23. In regions interposed between these three exposed regions, two second coated portion regions in which the intermetallic compound layer 16 and the aluminum coating layer 14 remain are formed to be adjacent to the exposed portion region which becomes the first exposed portions 22 and the exposed portion region which becomes the first exposed portion 22 to each other. Then, the steel sheet is cut at the exposed portion region which becomes the second exposed portion 23 (that is, the exposed portion region located in the center of the three exposed portion regions) to obtain two coated steel sheets (blank materials). The exposed portion region which becomes the second exposed portion 23 is cut so that the second exposed portion 23 is disposed along the end edge of the coated steel sheet in the cut coated steel sheet. Then, the obtained coated steel sheets are steel sheets for butt welding before forming a tailored blank.

In a case of the formation method D, the width of the exposed portion region which becomes the second exposed portion 23 may be 0.05 mm to 12 mm and is preferably 0.2 mm to 10 mm. In addition, the position where the exposed portion region which becomes the second exposed portion 23 is cut may be at a position in the vicinity of the center line of the exposed portion region or may be cut at a position other than the vicinity of the center line so as to have a desired width. In addition, the width of the exposed portion region in which the base steel sheet is exposed may be removed by cutting so as to have a desired width.

The total width of the first exposed portion 22, the second exposed portion 23, and the second coated portion 24 formed in the formation method C and D described above may be 10% to 50% larger than half of the width of the a melted region (weld metal portion). Thus, it is possible to prevent the melted region from coming into contact with the first coated portion 26.

In addition, the width of the second coated portion 24 in the steel sheet for butt welding 100 before a tailored blank is formed is formed to have a width included in the melted region after the steel sheets for butt welding 100 are butt-welded.

Within these ranges, since an appropriate amount of aluminum is mixed into the weld metal portion after the steel sheets for butt welding 100 are butt-welded, excellent corrosion resistance after coating is obtained and deterioration in tensile strength is also suppressed. In addition, since a hard and brittle intermetallic compound layer 16 is not provided at the boundary between the weld metal portion and the steel sheet for butt welding 100, deterioration in the fatigue strength of the steel sheet for butt welding 100 after hot press forming is suppressed.

<Tailored Blank>

FIG. 20 is a schematic cross-sectional view showing an example of the tailored blank of the present disclosure.

A tailored blank 300 of the present disclosure includes a first weld metal portion, and at least two steel sheet portions connected to each other through the first weld metal portion. Each of the at least two steel sheet portions represents a portion corresponding to the steel sheet as a result of butt-welding the steel sheets (steel sheets for butt welding) of the present disclosure. Specifically, each of the at least two steel sheet portions includes a first coated portion 26 in which an intermetallic compound layer 16 and an aluminum coating layer 14 are provided on the surface of a base steel sheet 12 in this order from the base steel sheet 12 side, and a first exposed portion 22 in which the base steel sheet 12 is exposed. In the tailored blank of the present disclosure, in a third direction F3, the first coated portion 26, the first exposed portion 22, and the first weld metal portion are provided such that the first coated portion 26, the first exposed portion 22, and the first weld metal portion are disposed in this order on the same surface.

The tailored blank 300 shown in FIG. 20 is formed by butt-welding end portions of welding scheduled portions of a steel sheet for butt welding 110 of the present disclosure and a steel sheet for butt welding 120 of the present disclosure. In the tailored blank 300, the steel sheet for butt welding 110 and the steel sheet for butt welding 120 whose sheet thickness is smaller than the sheet thickness of the steel sheet for butt welding 110 are joined by a first weld metal portion 150. In addition, the tailored blank 300 has the first exposed portion 22 adjacent to the first weld metal portion 150 and has the first coated portions 26 of the steel sheets for butt welding 110 and 120 adjacent to a side of the first exposed portion 22 apart from the first weld metal portion 150. The second coated portion 24 provided in the end portion of the welding scheduled portion of each of the steel sheet for butt welding 110 and the steel sheet for butt welding 120 is incorporated in the first weld metal portion 150 by butt welding, and disappears from the end portion of each of the steel sheets for butt welding 110 and 120.

It is preferred that the entire second coated portion in the butted end portions of the steel sheets for butt welding 110 and 120 is incorporated (included) in the first weld metal portion 150.

<Hot Stamped Product>

In the second embodiment, when a hot stamped product is manufactured, the differences from the first embodiment are as follows.

After a punched member is obtained by punching the coated steel sheet in which both surfaces of the base steel sheet 12 are coated with aluminum, the following steps are performed.

The aluminum coating layer 14 and the intermetallic compound layer 16 are removed on at least a part of both surfaces of the end portion of the coated steel sheet to form an exposed portion of the base steel sheet 12. At this time, on at least one surface of the end portion of the coated steel sheet, a second exposed portion 23 provided along the end edge of the end portion of the coated steel sheet, a first exposed portion 22 provided along the end edge of the first coated portion 26, and a second coated portion 24 provided adjacent to the end edge of the coated steel sheet to be interposed between the two exposed portions 22 and 23 are formed to obtained the steel sheet for butt welding 100 of the present disclosure.

Here, the exposed portions 22 and 23 and the second coated portion 24 formed on the end portion of the coated steel sheet may be formed in a state in which after the coated steel sheet is wound in a coil shape, the coated steel sheet wound in a coil shape is drawn out. In this case, after the exposed portion is formed, punching is performed so that the exposed portion and the second coated portion 24 are provided in the end portion of the coated steel sheet to obtain a punched member.

In addition, the exposed portion and the second coated portion 24 formed in the end portion of the coated steel sheet may be formed after a punched member is formed by drawing out the coated steel sheet wound in a coil shape and punching the drawn-out coated steel sheet. In this case, the exposed portion and the second coated portion 24 may be formed in the end portion of the punched member. In addition, in portions other than the end portion of the punched member, for example, an exposed region A, a first remaining region, an exposed region B which becomes the second exposed portion 23, a second remaining region, and an exposed region C which becomes the first exposed portion 22 are formed in this order in the width direction of the coated steel sheet so as to extend in one direction. Then, the steel sheet may be cut at the exposed region B which becomes the second exposed portion 23 to obtain the steel sheets for butt welding 100 of the present disclosure.

The concept of the specifications of the steel sheet for butt welding required to make the concentration of aluminum contained in the first weld metal portion of the tailored blank described in the first embodiment 0.05% by mass to 1% by mass can be applied to the steel sheet for butt welding 100 of the second embodiment.

### EXAMPLES

Examples of the second embodiment of the present disclosure will be illustrated below, but the present disclosure is not limited to the following examples.

### Example 2

First, a coated steel sheet coated with aluminum so as to have the thickness shown in Table 9 was prepared using a base steel sheet having the chemical composition shown in Table 5 above.

TABLE 9

| Tensile | | Thickness of | |
|---|---|---|---|
| strength | Thickness of | intermetallic | Thickness |
| after hot | aluminum | compound | of coated |
| press forming | coating layer | layer | steel sheet |
| (MPa) | (μm) | (μm) | (mm) |
| 1800 | 15 | 3 | 1.8, 1.6, 1.3 |
| 1500 | 22 | 5 | 2.0, 1.8, 1.6, 1.2 |
| 1300 | 17 | 6 | 1.6, 1.3, 1.2 |

Then, the coated steel sheet was cut out to form a square coated steel sheet (blank material) having a side of 10 cm. Next, the exposed portion and the second coated portion were formed on at least a part of both surfaces in the end portion of the welding scheduled portion of the prepared coated steel sheet.

In a part of the coated steel sheet, only the exposed portion was formed by removing the aluminum coating layer and the intermetallic compound layer and the second coated portion was not formed.

According to the exposed portion type shown in Table 10, the aluminum coating layer and the intermetallic compound layer formed on both surfaces were respectively removed in the exposed portion to expose the base steel sheet.

TABLE 10

| | | | | | Before butt welding | | | | | | |
|---|---|---|---|---|---|---|---|---|---|---|---|
| | Coated steel | | Coated steel | | | Coated steel sheet 1 | | | | | |
| | sheet 1 | | sheet 2 | | | | | Distance from | | Distance from | Width of second |
| | Tensile | | Tensile | | | | | end edge of | | end edge of | coated portion/ |
| | strength | | strength | | | | | coated steel | Width of | first coated | width of second |
| | after hot | | after hot | | | | Second | sheet to | second | portion to | coated portion + |
| | press | Thick- | press | Thick- | | Exposed | coated | second coated | coated | second coated | width of exposed |
| | forming | ness | forming | ness | End | portion | portion | portion | portion | portion | portion) × |
| No. | (MPa) | (mm) | (MPa) | (mm) | portion | type | type | (mm) | (mm) | (mm) | 100 (%) |
| 1 | 1500 | 1.8 | 1500 | 1.2 | First surface | A | — | — | 0 | 1.50 | 0 |
| | | | | | Second surface | | — | — | 0 | 1.50 | 0 |
| 2 | 1800 | 1.8 | 1300 | 1.3 | First surface | A | E | 0.05 | 0.15 | 1.30 | 10.00 |
| | | | | | Second surface | | — | — | — | 1.30 | 0 |
| 3 | 1500 | 1.6 | 1300 | 1.2 | First surface | A | E | 0.05 | 0.30 | 1.05 | 21.43 |
| | | | | | Second surface | | — | — | — | 1.05 | 0 |
| 4 | 1800 | 1.8 | 1800 | 1.3 | First surface | A | E | 0.05 | 0.10 | 1.05 | 8.33 |
| | | | | | Second surface | | — | — | — | 1.05 | 0 |
| 5 | 1800 | 1.6 | 1300 | 1.6 | First surface | A | D | 0.05 | 0.50 | 0.75 | 38.46 |
| | | | | | Second surface | | — | — | — | 1.30 | 0 |
| 6 | 1500 | 1.8 | 1800 | 1.8 | First surface | A | E | 0.03 | 0.30 | 0.87 | 25.00 |
| | | | | | Second surface | | — | — | — | 1.20 | 0 |
| 7 | 1500 | 2.0 | 1500 | 1.2 | First surface | A | E | 0.25 | 0.30 | 0.65 | 25.00 |
| | | | | | Second surface | | — | — | — | 1.20 | 0 |
| 8 | 1800 | 1.8 | 1300 | 1.3 | First surface | A | E | 0.05 | 0.30 | 0.85 | 25.00 |
| | | | | | Second surface | | — | — | — | 1.20 | 0 |
| 9 | 1800 | 1.8 | 1800 | 1.3 | First surface | A | E | 0.05 | 0.30 | 0.85 | 25.00 |
| | | | | | Second surface | | E | 0.05 | 0.30 | 0.85 | 25.00 |
| 10 | 1800 | 1.8 | 1300 | 1.3 | First surface | A | E | 0.05 | 0.30 | 0.85 | 25.00 |
| | | | | | Second surface | | E | 0 | 0.05 | 1.00 | 4.76 |

| | Before butt welding | | | | | | |
|---|---|---|---|---|---|---|---|
| | Coated steel sheet 2 | | | | | | |
| | | | Distance from | | Distance from | Width of second | |
| | | | end edge of | | end edge of | coated portion/ | |
| | | | coated steel | Width of | first coated | width of second | |
| | | Second | sheet to | second | portion to | coated portion + | |
| | Exposed | coated | second coated | coated | second coated | width of exposed | |
| | portion | portion | portion | portion | portion | portion) × | |
| No. | type | type | (mm) | (mm) | (mm) | 100 (%) | Remark |
| 1 | A | — | — | 0 | 1.50 | 0 | Comparative |
| | | — | — | 0 | 1.50 | 0 | Example |
| 2 | A | — | — | 0 | 1.20 | 0.00 | Invention |
| | | — | — | 0 | 1.20 | 0 | Example |
| 3 | A | E | 0.05 | 0.20 | 1.30 | 12.90 | |
| | | — | — | 0 | 1.55 | 0 | |
| 4 | A | E | 0.05 | 0.10 | 1.20 | 7.41 | |
| | | — | — | 0 | 1.35 | 0 | |
| 5 | A | D | 0.05 | 0.50 | 0.65 | 41.67 | |
| | | — | — | 0 | 1.20 | 0 | |
| 6 | A | E | 0.05 | 0.30 | 0.85 | 25.00 | |
| | | | | | 1.20 | 0 | |
| 7 | A | E | 0.05 | 0.30 | 0.85 | 25.00 | |
| | | — | — | 0 | 1.20 | 0 | |
| 8 | A | E | 0.2 | 0.30 | 1.10 | 18.75 | |
| | | — | — | 0 | 1.20 | 0 | |
| 9 | A | E | 0.05 | 0.30 | 0.85 | 25.00 | |
| | | — | — | 0 | 1.20 | 0 | |
| 10 | A | E | 0.05 | 0.30 | 0.85 | 25.00 | |
| | | E | 0 | 0.30 | 0.90 | 25.00 | |

The exposed portion was formed by cutting with an end mill. In addition, the exposed portion was formed over a total length of 10 cm on only one side of the four sides of the coated steel sheet on both surfaces of the end portion of the coated steel sheet excluding the region including the end edge of the coated steel sheet. The width of the exposed portion is a total of a distance from the end edge of the coated steel sheet to the second coated portion and a distance from the end edge of the first coated portion to the second coated portion. In No. 1 shown in Table 10, the second coated portion does not exist. That is, the numerical value of the column “Distance from first coated portion end edge to second coated portion (mm)” represents a distance from the end edge to the end edge of the end portion of the coated steel sheet in the region excluding the first coated portion.

At the same time as formation of the exposed portions, the second coated portion was formed in a region interposed between the two exposed portions while being separated from the end edge of the coated steel sheet according to the second coated portion type shown in Table 10. The second coated portion was formed to have the width of the second coated portion shown in Table 10.

Next, as shown in Table 10, two coated steel sheets (steel sheets for butt welding) (the coated steel sheet 1 and the coated steel sheet 2) were prepared, the end surfaces of the end portions of the welding scheduled portions were butted, and butt welding is performed by laser welding to prepare a tailored blank. The welding was adjusted so as to perform through welding under the conditions of a laser output of 3.0 kW to 5.0 kW and a welding rate of 4.0 m/min to 7.0 m/min.

The prepared tailored blank was held in a furnace heated to 920° C. for 4 minutes. Then, the tailored blank was formed with a water-cooled die and quenched to manufacture a flat hot stamping-formed article.

Here, the Vickers hardness of the weld metal of the coated steel sheet 1 and the coated steel sheet 2 was HV 450 or higher.

<Evaluation>

(Fatigue Strength Test and Joint Static Strength)

The test was performed in the same manner as in Example 1 in the first embodiment. The test results are shown in Table 11.

TABLE 11

| | After butt welding and hot press forming | | | | | |
|---|---|---|---|---|---|---|
| | | | | | Corrosion | |
| | Al concentration of | Sheet | Static | Fatigue | resistance | |
| | first weld metal portion | thickness | strength | strength | after | |
| No. | (% by mass) | ratio | (MPa) | (MPa) | coating | Remark |
| 1 | 0.03 | 0.97 | 1541 | 420 | D | Comparative |
| | | | | | | Example |
| 2 | 0.12 | 0.97 | 1330 | 415 | A | Invention |
| 3 | 0.26 | 0.94 | 1318 | 415 | A | Example |
| 4 | 0.12 | 0.95 | 1841 | 420 | A | |
| 5 | 0.42 | 0 97 | 1325 | 435 | A | |
| 6 | 0.23 | 0.98 | 1538 | 452 | A | |
| 7 | 0.20 | 0.97 | 1521 | 425 | A | |
| 8 | 0.25 | 0.93 | 1320 | 435 | A | |
| 9 | 0.43 | 0.97 | 1852 | 440 | A | |
| 10 | 0.39 | 0.91 | 1365 | 425 | A | |

(Test of Corrosion Resistance after Coating)

The test was performed in the same manner as in Example 1 in the first embodiment. The determination criterion are the same as those in Example 1.

The coated steel sheets in Tables 9 and 10 are steel sheets obtained by coating the base steel sheet with aluminum.

In Table 10, the notations of “A”, “B”, and “C” in the removed portion type column and the notations of “-”, “D”, and “E” in the second coated portion type column are the same as in Example 1.

In Table 10, “Distance from coated steel sheet end edge to second coated portion”, “Width of second coated portion”, and “Distance from first coated portion end edge to second coated portion” were measured by the methods described above. The numerical value in “Distance from first coated portion end edge to second coated portion” on the surface on which the second coated portion is not formed represents a distance from the first coated portion end edge to the coated steel sheet end edge.

In Table 11, the numerical value in the sheet thickness ratio column is a value obtained by calculating the sheet thickness ratio of the base steel sheet from Expression (29) at the position corresponding to the first exposed portion of the coated steel sheet and the position corresponding to the first coated portion. Each thickness is measured by the method described above.

Sheet thickness ratio=(thickness of base steel sheet in first exposed portion)/(thickness of base steel sheet in portions other than end portion of coated steel sheet) (29)

In Table 11, the Al concentration of the first weld metal portion is a value measured according to the method described above.

As shown in Table 11, No. 1 in which both the aluminum coating layer and the intermetallic compound layer are removed and the second coated portion is not provided has a low aluminum concentration in the first weld metal portion, and thus the corrosion resistance after coating is inferior.

On the other hand, as shown in Table 11, in Nos. 2 to 10 using steel sheets in which both the aluminum coating layer and the intermetallic compound layer are removed to form exposed portions and further, the second coated portion is formed to be interposed between two exposed portions in the vicinity of the end edge of the coated steel sheet, both fatigue strength and corrosion resistance after coating are excellent.

### Third Embodiment

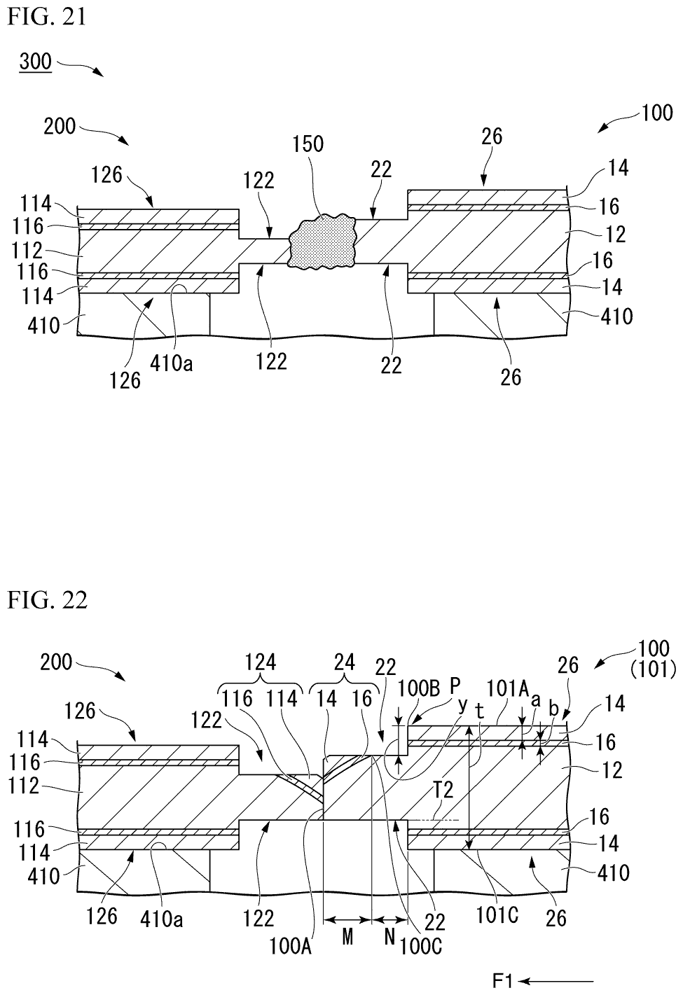

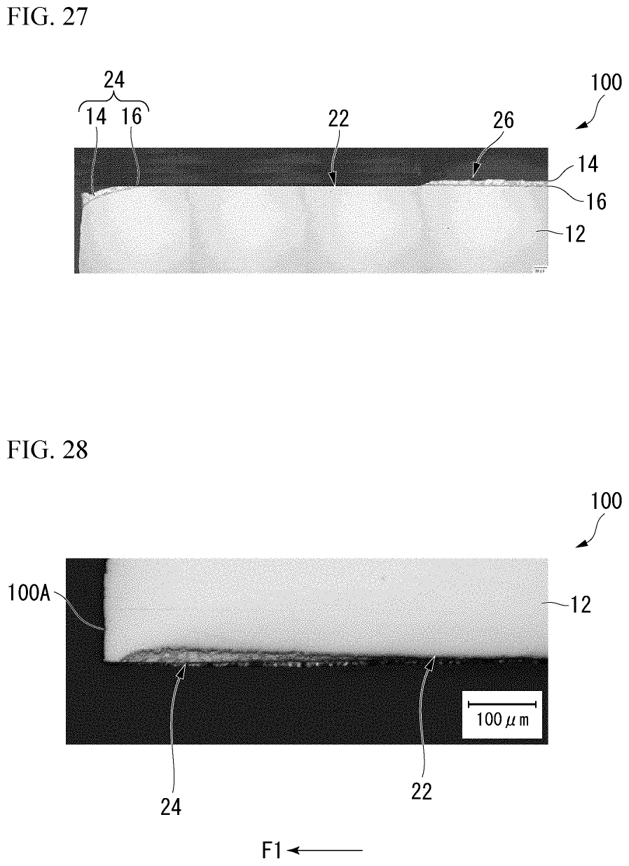

Next, a third embodiment of the present disclosure will be described with reference to FIGS. 21 to 33. However, the same portions as those in the above embodiment will be denoted by the same reference numerals, and description thereof will be omitted. Only different points will be described.

<Tailored Blank>

As shown in FIG. 21, a tailored blank 300 manufactured by the method of manufacturing a tailored blank according to the present disclosure is configured by butt-welding two steel sheets for butt welding 100 and 200 with a first weld metal portion 150 interposed between the steel sheets for butt welding 100 and 200.

Hereinafter, first, the structure of the steel sheet for butt welding 100 before being butt-welded shown in FIG. 22 will be described.

<Steel Sheet for Butt Welding>

The embodiment of the steel sheet for butt welding 100 of the present disclosure is the same as the embodiment of the steel sheet for butt welding 100 in the first embodiment.

An aluminum coating layer 14 is provided on a first surface of a base steel sheet 12 and a second surface opposite to the first surface, respectively. An intermetallic compound layer 16 is formed between the first surface of the base steel sheet 12 and the aluminum coating layer 14 provided on the first surface. Further, the intermetallic compound layer 16 is formed between the second surface opposite to the first surface of the base steel sheet 12 and the aluminum coating layer 14 provided on the second surface.

The thickness per one side (one layer) of the base steel sheet 12 in the aluminum coating layer 14 is a μm (micrometer). The thickness per one side (one layer) of the base steel sheet 12 in the intermetallic compound layer 16 is b μm.

In the steel sheet for butt welding 100 configured as described above, with reference to FIG. 22, a first exposed portion 22 in which the base steel sheet 12 is exposed on both surfaces of the end portion located around the steel sheet for butt welding 100. A first coated portion 26 in which the intermetallic compound layer 16 and the aluminum coating layer 14 are provided on the base steel sheet 12 is provided on a side closer to the center portion of the steel sheet for butt welding 100 than to the first exposed portion 22. On at least one surface of the end portion located around the steel sheet for butt welding 100, a second coated portion 24 in which the intermetallic compound layer 16 and the aluminum coating layer 14 remain is provided on a side closer to the end edge 100A of the steel sheet for butt welding 100 than to the first exposed portion 22.

In this example, the aluminum coating layer 14 and the intermetallic compound layer 16 remain in the second coated portion 24. In this example, although the second coated portion 24 is formed on one surface of the end portion of the steel sheet for butt welding 100, the second coated portion 24 may be formed on each of both surfaces of the end portions of the steel sheet for butt welding 100.

Referring to FIG. 22, the steel sheet for butt welding 200 has a base steel sheet 112, an aluminum coating layer 114, and an intermetallic compound layer 116 similarly configured as the base steel sheet 12, the aluminum coating layer 14, and the intermetallic compound layer 16 of the steel sheet for butt welding 100.

In this example, the thickness of the base steel sheet 112 is different from the thickness of the base steel sheet 12. The base steel sheet 112 and the base steel sheet 12 may have the same thickness.

A first exposed portion 122 in which the base steel sheet 112 is exposed is formed on both surfaces of the end portion located around the steel sheet for butt welding 200. On one surface of the end portion located around the steel sheet for butt welding 200, a second coated portion 124 in which the aluminum coating layer 114 and the intermetallic compound layer 116 remain is formed on the side closer to the end edge of the steel sheet for butt welding 200 than to the first exposed portion 122. A first coated portion 126 in which the intermetallic compound layer 116 and the aluminum coating layer 114 are provided on the base steel sheet 112 is provided on the side closer to the center portion of the steel sheet for butt welding 200 than to the first exposed portion 122.

<First Weld Metal Portion>

The first weld metal portion is formed by melting and solidifying the end portions of the two steel sheets for butt welding when the two steel sheets for butt welding are butt-welded. The concentration of aluminum contained in the first weld metal portion is preferably 0.05% by mass to 1% by mass.

<Method of Manufacturing Tailored Blank>

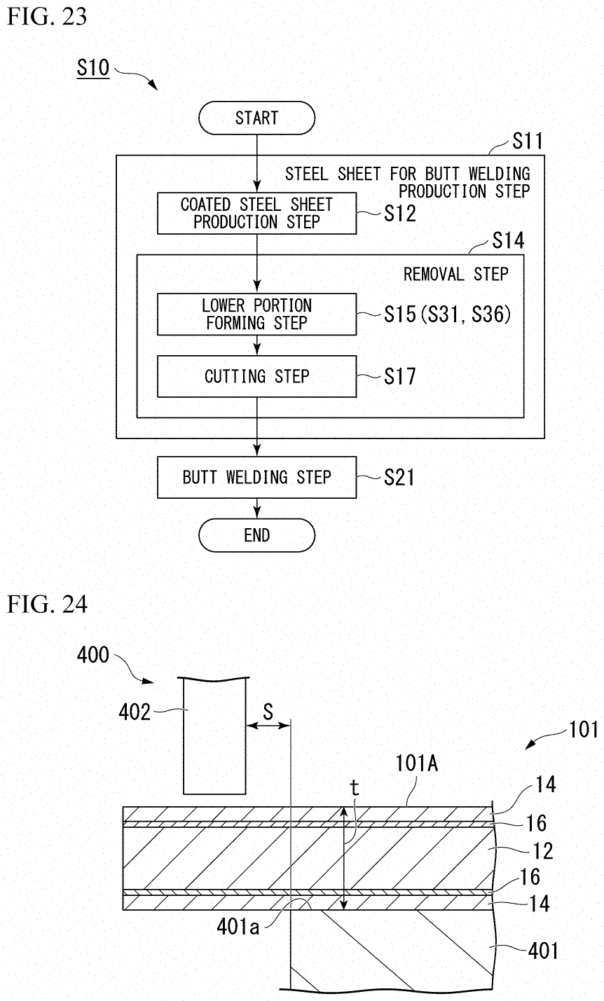

Next, a method of manufacturing a tailored blank of the present disclosure including forming the first exposed portions 22 and 122 and the second coated portions 24 and 124 on the coated steel sheet to manufacture steel sheets for butt welding 100 and 200, and further butt-welding the steel sheets for butt welding 100 and 200 together to manufacture the tailored blank 300 will be described. FIG. 23 is a flow chart showing a method of manufacturing a tailored blank S10 according to the present disclosure.

In the present disclosure, the method of manufacturing a tailored blank S10 using two steel sheets for butt welding of the present disclosure will be described. However, the number of steel sheets for welding used in the method of manufacturing a tailored blank may be 3 or more. Then, of the two or more welding steel sheets, at least one steel sheet for butt welding manufactured by the method of manufacturing a steel sheet for butt welding according to the present disclosure may be used.

First, in the method of manufacturing a steel sheet for butt welding (the method of manufacturing a steel sheet for butt welding) (Step S11 in FIG. 23), a coated steel sheet production step S12 is performed. In the coated steel sheet production step S12, a coated steel sheet 101 shown in FIG. 24 is manufactured. In the coated steel sheet production step S12, by a known method, the coated steel sheet 101 in which an intermetallic compound layer 16 and an aluminum coating layer 14 are provided in order from a base steel sheet 12 side is manufactured on each surface of the base steel sheet 12. In the coated steel sheet 101, a first exposed portion 22 and the second coated portion 24 may be formed on the above-described steel sheet for butt welding 100.

Here, the thickness of the coated steel sheet 101 is set to t μm. The thickness of the coated steel sheet 101 is equal to the thickness in the first coated portion 26 of the steel sheet for butt welding 100 shown in FIG. 22.

When the coated steel sheet production step S12 is completed, the process proceeds to a removal step S14. The removal step S14 is a step of mechanically removing the aluminum coating layer 14 and the intermetallic compound layer 16.

Next, in the removal step S14, a lower portion forming step S15 is performed.

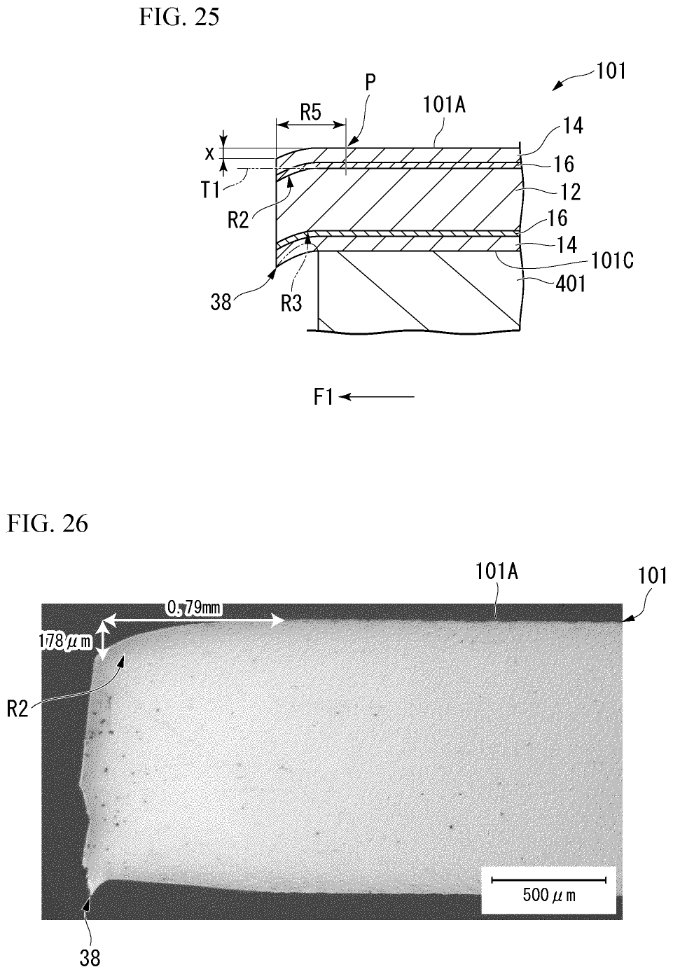

In the lower portion forming step S15, as shown in FIG. 25, a lower region R2 is formed on the surface of the base steel sheet 12 of the coated steel sheet 101 by cutting the coated steel sheet 101 and deforming a part of the coated steel sheet 101. The lower region R2 is formed on the end edge of the base steel sheet 12.

Here, the first direction F1 is defined. The first direction F1 is a direction which is perpendicular to the thickness direction of the coated steel sheet 101 and is a direction from the center portion of the coated steel sheet 101 to one end edge of the coated steel sheet 101 in plan view. This first direction F1 corresponds to the first direction F1 of the steel sheet for butt welding 100 when the coated steel sheet 101 is processed into the steel sheet for butt welding 100. The lower region R2 referred to here is a region of the aluminum coating layer 14 and the intermetallic compound layer 16 located on the inner side of the base steel sheet 12 from a virtual plane T1 in which the surface of a portion of the base steel sheet 12, which is not deformed at the time of cutting, (for example, the first exposed portion) in the first direction F1 extends in the thickness direction.

In this example, in the lower portion forming step S15, the coated steel sheet 101 is cut by shearing which is a mechanical method, and the lower region R2 is formed in the coated steel sheet 101. The lower region may be formed on the coated steel sheet 101 using blanking (punching) instead of shearing. The mechanical method mentioned here means a method in which a tool is directly brought into contact with the coated steel sheet 101 and the coated steel sheet 101 is processed with the contacted tool.

In the lower portion forming step S15, specifically, as shown in FIG. 24, the coated steel sheet 101 is placed on an upper surface 401 a of a support table 401 of a shearing device 400. The upper surface 401a is flat and is disposed along a horizontal plane. At this time, the end portion of the coated steel sheet 101 is disposed so as to protrude from the support table 401.

A blade portion 402 of the shearing device 400 is disposed above the upper surface 401a of the support table 401 with a certain spacing S from the support table 401 along the upper surface 401a.

When the blade portion 402 is moved downward and the coated steel sheet 101 is cut in the thickness direction of the coated steel sheet 101 as shown in FIG. 25, the end portion of the coated steel sheet 101 is cut. At this time, a sagging lower region R2 is formed on a first surface 101A of the coated steel sheet 101. A protrusion portion 38 with burring is formed on a lower surface of the coated steel sheet 101.

Here, the deepest lower portion depth of the lower region R2 is x μm. The lower portion depth x represents a distance (the absolute maximum value) from the virtual plane T1 to the surface of the base steel sheet 12 in the lower region R2. The lower portion depth x can be measured with a known laser profile meter or the like.

A cross-sectional image showing an example of a state in which the lower region R2 is formed on the coated steel sheet 101 of the present disclosure is shown in FIG. 26.

The lower region R2 is formed in a range of 0.79 mm from the end edge of the coated steel sheet 101 along the first surface 101A. The lower portion depth x is 178 μm.

By adjusting the material of the coated steel sheet 101, the spacing S, and the like, while forming the protrusion portion 38, a lower region R3 is formed by deforming the lower surface of the coated steel sheet 101 as shown by the two-dot chain line in FIG. 25. The two-dot chain line represents the shape of the lower surface of the coated steel sheet 101.

In this case, in the lower portion forming step S15, the lower region R2 is formed on the upper surface of the coated steel sheet 101, and a lower region R3 is formed on the lower surface, respectively. For example, it is considered that the lower region R3 is formed by drawing the material forming the coated steel sheet 101 toward the protrusion portion 38 due to the rigidity of the coated steel sheet 101 when the protrusion portion 38 is formed.

When the lower portion forming step S15 is completed, the process proceeds to Step S17.

Next, in the cutting step (elimination step) S17, the coated steel sheet 101 is cut using a mechanical cutting method to form the first exposed portion 22 and the second coated portion 24, and thus the steel sheet for butt welding 100 is manufactured. In the present disclosure, an end mill is used for cutting, and at least the aluminum coating layer 14 and the intermetallic compound layer 16 existing on the outer side of the coated steel sheet 101 in the thickness direction from the virtual plane T1 is removed by cutting with the end mill. The coated steel sheet 101 is cut by bringing the end mill blade rotating around the axis line into direct contact with the coated steel sheet 101.

In the cutting S17, in addition to the end mill, for example, a bite, a metal saw, or the like is used. In the elimination step, the aluminum coating layer 14 and the intermetallic compound layer 16 may be removed by grinding. A grinding stone, a grinder, and the like are used for grinding.

In the cutting step S17, a region R5 from the end edge of the coated steel sheet 101 to the transcendent position P larger than the lower region R2 is cut in the direction opposite to the first direction F1. The transcendent position P is a position that becomes the end edge 100B of the first coated portion 26 in the subsequent step, and a range between the lower region R2 and the transcendent position P becomes the first exposed portion 22. At this time, the depth of cutting the region R5 of the coated steel sheet 101 is constant. Thus, the production cost required for cutting can be suppressed. The aluminum coating layer 14 and the intermetallic compound layer 16 on the lower region R2 in the region R5 may not be cut.

The depth at which the coated steel sheet 101 is cut less than the total value of the thickness a of the aluminum coating layer 14, the thickness b of the intermetallic compound layer 16, and the lower portion depth x. That is, cutting is performed so that at least a part of the intermetallic compound layer 16 and the aluminum coating layer 14 located in the lower region R2 remains.

As shown in FIG. 22, in the cutting step S14, the depth (length) of the coated steel sheet 101 in the thickness direction for cutting the aluminum coating layer 14 and the intermetallic compound layer 16 per one surface of the coated steel sheet 101 is y μm.

By the above cutting, as shown in FIG. 22, the base steel sheet 12 is exposed to the outside and a first exposed portion 22 is formed between the lower region R2 and the transcendent position P in the first direction F1. A second coated portion 24 in which the intermetallic compound layer 16 and the aluminum coating layer 14 remain is formed on the lower region R2 on the side closer to the end edge of the coated steel sheet 101 than to the first exposed portion 22. In the first direction H, on at least one surface of the base steel sheet 12, the first coated portion 26, the first exposed portion 22, the second coated portion 24, and the end edge of the coated steel sheet 101 are provided such that the first coated portion 26, the first exposed portion 22, the second coated portion 24, and the end edge of the coated steel sheet 101 are disposed this order. In the first direction F1, on the other surface of the base steel sheet 12, at least the first coated portion 26, the first exposed portion 22, and the end edge of the coated steel sheet 101 are provided such that the first coated portion 26, the first exposed portion 22, and the end edge of the coated steel sheet 101 are disposed this order.

The steel sheet for butt welding 100 is manufactured by forming the first exposed portion 22 and the second coated portion 24 on the coated steel sheet 101 by the above cutting.

In the first direction, the first coated portion 26, the first exposed portion 22, the second coated portion 24, and the end edge of the coated steel sheet may be disposed in this order on the other surface of the base steel sheet 12.

In the steel sheet for butt welding 100, the thickness of the base steel sheet 12 corresponding to the portion in which the first exposed portion 22 and the second coated portion 24 are formed may be thinner than the thickness of the base steel sheet 12 corresponding to a portion in which the first exposed portion 22 and the second coated portion 24 are not formed.

A cross-sectional image showing an example of a state in which the first exposed portion 22 and the second coated portion 24 are formed on the steel sheet for butt welding 100 of the present disclosure is shown in HG 27.

In this example, as shown in FIG. 22, the first exposed portion 22 is also formed on a second surface 101C opposite to the first surface 101A of the steel sheet for butt welding 100.

Here, a distance from the end edge 100A of the steel sheet for butt welding 100 to the end edge 100C (the width of the second coated portion 24) is M μm. A distance between the first coated portion 26 and the second coated portion 24 (the width of the first exposed portion 22) is N μm.

For example, when the lower portion depth x is larger than the thickness a of the aluminum coating layer 14, the aluminum coating layer 14 remains in the second coated portion 24.

That is, in a case where the aluminum coating layer 14 in the region in which the lower region R2 is not formed is tried to be removed, the first surface 101A of the coated steel sheet 101 is removed by a mechanical method in a planar manner by the thickness of the aluminum coating layer 14. In a case where the cutting depth y is larger than the thickness a of the aluminum coating layer 14, the aluminum coating layer 14 can be removed in the region in which the lower region R2 is not formed by the mechanical method. However, in the region in which the lower region R2 is formed, as compared with the region in which the lower region R2 is not formed, as a result, the position of the aluminum coating layer 14 escapes in the thickness direction by the depth of the lower region R2. Therefore, the aluminum coating layer 14 remains on the lower region R2 as described above.

At this time, it is preferable to satisfy Expressions (31) to (36).

10≤a+b<50 (31)

2%≤(x/t)≤15% (32)

a+b<y (33)

(y/t)<7% (34)

N>200 (35)

M≤1300 (36)

Regarding Expression (31), when a value of (a+b) is 10 or more, the surface of the base steel sheet 12 is sufficiently coated and thus the corrosion resistance after coating of the base steel sheet 12 can be secured. In addition, when the value of (a+b) is less than 50, the aluminum coating layer 14 and the intermetallic compound layer 16 can be prevented from becoming too thick.

By satisfying Expression (32), the amount of aluminum contained in the second coated portion 24 can be adjusted to an appropriate range. When the value of (x/t) is 2% or more, the depth x of the lower portion depth x is increased and thus the second coated portion 24 can be prevented from being disposed in the vicinity of the end edge 100B of the first coated portion 26.

By satisfying Expression (33), cutting is performed with a length y in the thickness direction larger than the total of the thickness a of the aluminum coating layer 14 and the thickness b of the intermetallic compound layer 16, and thus the first exposed portion 22 can be more reliably formed by the steel sheet 100.

By satisfying Expression (34), when the aluminum coating layer 14 or the like is cut, it is possible to prevent the strength of the steel sheet for butt welding 100 from being deteriorated since the steel sheet for butt welding 100 becomes too thin.

Regarding Expressions (35) and (36), a butt welding step S21 described later will be described.

In the cutting step S17, from the second surface 101C side of the coated steel sheet 101, cutting is performed while moving along a virtual plane T2 shown in FIG. 22 without changing the position of the cutting reaching point in the thickness direction on the virtual plane T2. Thus, the intermetallic compound layer 16 and the aluminum coating layer 14 formed in the lower region R3 located on the inner side in the thickness direction from the virtual plane T2 remain as the second coated portion 24. At this time, a portion of the protrusion portion 38 with burring is cut to become the second exposed portion 23.

When the cutting step S17 is performed, the steel sheet for butt welding 100 in which the first exposed portion 22 and the second coated portion 24 are formed is manufactured.

That is, in the coated steel sheet 101, by removing a part of the aluminum coating layer 14 and the intermetallic compound layer 16, the first exposed portion 22 in which the base steel sheet 12 is exposed, the first coated portion 26 in which the intermetallic compound layer 16 and the aluminum coating layer 14 remain on the surface of the base steel sheet 12 in order from the base steel sheet 12 side, and the second coated portion 24 in which the intermetallic compound layer 16 and the aluminum coating layer 14 remain on the surface of the base steel sheet 12 are formed. In this example, the second coated portion 24 is formed on the surface of the base steel sheet 12 such that the intermetallic compound layer 16 and the aluminum coating layer 14 remain in order from the base steel sheet 12 side.

Thus, the steel sheet for butt welding 100 is manufactured.

In the steel sheet for butt welding 100, in the first direction F1, the first coated portion 26, the first exposed portion 22, the second coated portion 24, and the end edge 100A of the steel sheet for butt welding 100 are disposed on the same surface in this order.

A cross-sectional image showing an example of a state in which the second coated portion 24 is formed in the steel sheet for butt welding 100 of the present disclosure by burring is shown in FIG. 28. The first exposed portion 22 is formed on the second coated portion 24 in a direction opposite to the first direction F1.

When the cutting step S17 is completed, the removal step S14 is completed and further, a steel sheet for butt welding production step S11 is completed and the process proceeds to Step S21. In this manner, in the steel sheet for butt welding production step S11, the first exposed portion 22 and the second coated portion 24 are formed using at least a mechanical method such as shearing and cutting.

In addition, similarly, the first exposed portion 22, the second coated portion 24, and the second exposed portion 23 may be formed on both surfaces of the end portion of the coated steel sheet 101.

Next, in the butt welding step S21, a steel sheet for butt welding 200 is manufactured in the same step as the steel sheet for butt welding production step S11.

As shown in FIG. 22, the end portions of the steel sheets for butt welding 100 and 200 are disposed on an upper surface 410a of a welding table 410 in a state in which the end portions are butted together. At this time, the steel sheets for butt welding 100 and 200 are disposed in a state in which the steel sheets are butted together through the end edge 100A of the steel sheet for butt welding 100 having the first exposed portion 22 and the second coated portion 24 of the steel sheet for butt welding 100 and the end edge of the steel sheet for butt welding 200 having the first exposed portion 122 and the second coated portion 124 of the steel sheet for butt welding 200. Since the upper surface 410a of the welding table 410 is flat, the steel sheets for butt welding 100 and 200 are disposed so that the lower surfaces of the welding table 410 are flush with each other.

For example, the end portions of the steel sheets for butt welding 100 and 200 is butt-welded using a known laser welding device (not shown). Thus, as shown in FIG. 21, the first weld metal portion 150 is formed between the steel sheets for butt welding 100 and 200 to manufacture a tailored blank 300.

At this time, the welding conditions are determined such that the second coated portions 24 and 124 are melted and included in the first weld metal portion 150 during welding, and the first weld metal portion 150 does not reach the first coated portion 26 beyond the first exposed portions 22 and 122.

By satisfying above Expression (35), it is possible to prevent aluminum from being included in the portion between the first weld metal portion 150 and the first coated portion 26 by contact of the first weld metal portion 150 with the aluminum coating layers 14 and 114, and the like.

By satisfying Expression (36), the amount of aluminum contained in the portion between the first weld metal portion 150 and the first coated portion 26 is suppressed and thus the fatigue strength of a portion of the first weld metal portion 150 in the vicinity of the end edge 100B of the first coated portion 26 can be more reliably maintained.

When the second coated portion 24 is formed only in the lower region R2 formed by sagging, during laser welding of the steel sheets for butt welding 100 and 200, the aluminum coating layer 14 is easily melted and agitated, and an aluminum concentrated portion is hardly formed in the first weld metal portion 150. Accordingly, both the fatigue strength and the corrosion resistance after coating of the first weld metal portion 150 can be enhanced.

When the butt welding step S21 is completed, all steps of the method of manufacturing a tailored blank S10 is completed and thus a tailored blank 300 is manufactured.

The distance M in FIG. 22 is more preferably equal to or less than half of the distance between the end edge 100A of the steel sheet for butt welding 100 and the first coated portion 26. That is, it is more preferable that the second coated portion 24 is disposed only on a side closer to the end edge 100A than to a middle position between the end edge 100A of the steel sheet for butt welding 100 and the end edge 100B of the first coated portion 26, and the first exposed portion 22 is formed on sides closer to the first coated portion 26 than to the middle position to expose the base steel sheet 12.

With such a configuration, it is possible to more reliably prevent aluminum from being mixed in the portion between the first weld metal portion 150 and the first coated portion 26 by contact of the first weld metal portion 150 with the aluminum coating layers 14 and 114 and the like.

As described above, according to the method of manufacturing a steel sheet for butt welding S11 in the present disclosure, in the steel sheet for butt welding 100, the first exposed portion 22 is formed in the end portion and the second coated portion 24 is formed on the side closer to the end edge 100A of the steel sheet for butt welding 100 than to the first exposed portion 22 using at least a mechanical method. Therefore, for the same reason as the steel sheet 100 of the first embodiment, it is possible to suppress deterioration in fatigue strength while maintaining the corrosion resistance after coating of the first weld metal portion 150.

Further, by forming the first exposed portion 22 and the second coated portion 24 using at least a mechanical method in the mechanical removal step, it is possible to effectively cut the aluminum coating layer 14 and the intermetallic compound layer 16 at a time.

In the method of manufacturing a steel sheet for butt welding S11 of the present disclosure, a mechanical method may not be used.

The mechanical method used in steel sheet production step S11 includes cutting. Therefore, the step of forming the lower region R2 on the steel sheet for butt welding 101 or cutting the coated steel sheet 101 can be efficiently performed.

In the mechanical removal step, the cutting step S17 is performed. In the cutting step S17, the first exposed portion 22 and the second coated portion 24 can be easily formed by removing the aluminum coating layer 14 and the intermetallic compound layer 16 by cutting.

In the lower portion forming step S15, by forming the lower region R2 and the lower region R3 at the same time, a plurality of the lower regions R2 and R3 can be effectively formed.

In addition, according to the method of manufacturing a tailored blank S10 in the present disclosure, the method of manufacturing a tailored blank S10 can be performed using the method of manufacturing a steel sheet S11 capable of maintaining fatigue strength while maintaining the corrosion resistance after coating of the first weld metal portion 150.

The concentration of aluminum contained in the first weld metal portion 150 is 0.05% by mass to 1% by mass. When the concentration of aluminum is in this range, excellent corrosion resistance after coating can be effectively obtained and fracture in the first weld metal portion 150 is suppressed.

In addition, deterioration in the fatigue strength of the first weld metal portion 150 is suppressed. From this point, the upper limit of the concentration of aluminum contained in the first weld metal portion 150 is preferably 1% by mass, more preferably 0.8% by mass, and still more preferably 0.4% by mass. The lower limit of the concentration of aluminum contained in the first weld metal portion 150 is preferably 0.08% by mass and more preferably 0.1% by mass.

In the method of manufacturing a steel sheet for butt welding of the present disclosure, the first exposed portion and the second coated portion may be formed as follows.

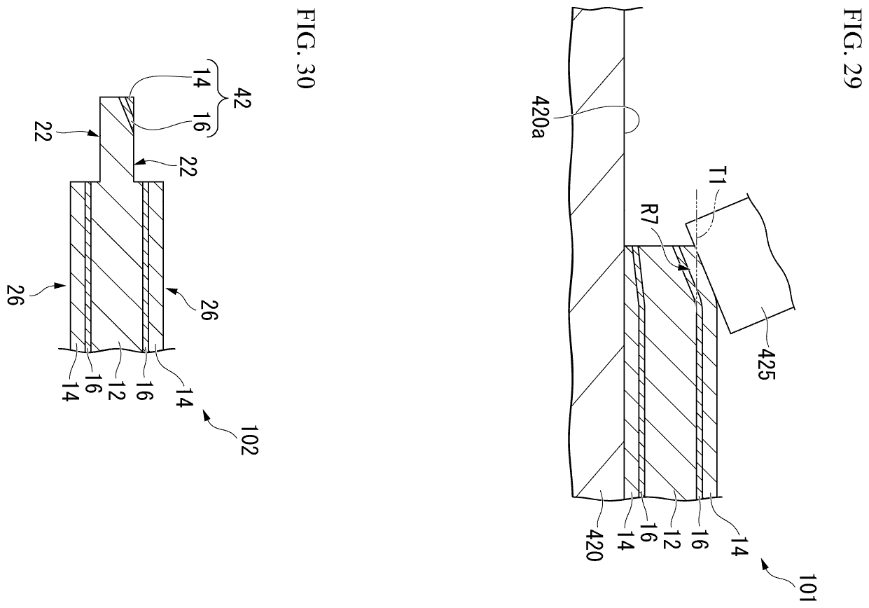

In the lower portion forming step S31 shown in FIG. 23, as shown in FIG. 29, the coated steel sheet 101 is placed on an upper surface 420a of a support table 420. Using a mechanical method of compressing the end portion of the coated steel sheet 101 in the thickness direction of the coated steel sheet 101 with a pressing member 425 such as a pressure roll, a lower region R7 is formed on the upper surface of the coated steel sheet 101. The lower region R7 is formed at the end edge of the coated steel sheet 101. The direction of compressing the steel sheet by the pressing member 425 may be inclined with respect to the thickness direction.

In the lower region R7, the deepest recessed portion is located at the end edge of the coated steel sheet 101.

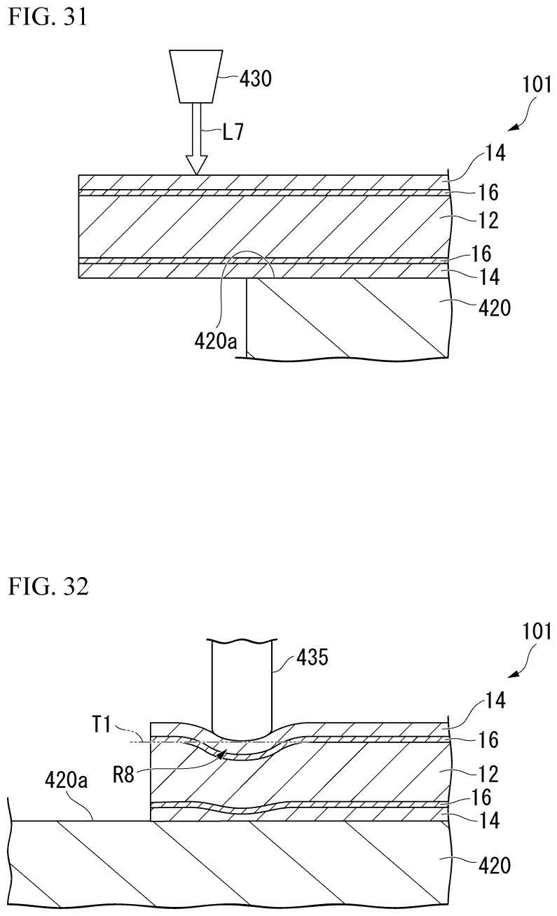

In a lower portion forming step S36 shown in FIG. 23, as shown in FIG. 31, the coated steel sheet 101 is placed on the upper surface 420a of the support table 420. At this time, the end portion of the coated steel sheet 101 is disposed so as to protrude from the support table 420.

In this example, a laser processing method that is not a mechanical method is used. A laser beam L7 is emitted to the from end portion of the coated steel sheet 101 from a laser processing apparatus 430 in the thickness direction of the coated steel sheet 101. Thus, the end portion of the coated steel sheet 101 is cut, but at this point, a lower region is not yet formed in the coated steel sheet 101.

Further, as shown in FIG. 32, using a mechanical method of compressing the end portion of the coated steel sheet 101 in the thickness direction of the coated steel sheet 101 with a pressing member 435 such as a pressure roll, a lower region R8 is formed on the upper surface of the coated steel sheet 101 including the end edge. In the lower region R8, the deepest recessed portion is separated from the end edge of the coated steel sheet 101. Hereinafter, such a method of forming the lower region is referred to as a partial indentation method.

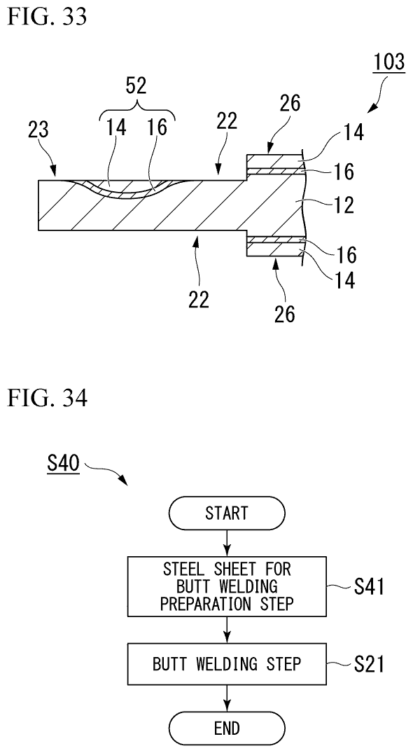

Next, when the cutting step S17 is performed, as shown in FIG. 33, a steel sheet for butt welding 103 in which a first exposed portion 22, a second exposed portion 23, and a second coated portion 52 are formed is manufactured.

As shown in FIG. 34, in a method of manufacturing a tailored blank S40 of the present disclosure, a sheet for butt welding preparation step S41 of obtaining a steel sheet for butt welding 100 by purchasing the steel sheet for butt welding 100 without manufacturing the steel sheet for butt welding 100 may be performed. In this case, the butt welding step S21 is performed using the steel sheet for butt welding 100 obtained in the steel sheet for butt welding preparation step S41.

In this case, in the method of manufacturing a tailored blank, at least two steel sheets for butt welding of the present disclosure are butt-welded. Then, at least two steel sheet portions are connected to each other through a first weld metal portion to manufacture a tailored blank.

At this time, it is preferable that the end edges having the second coated portion 24 of the steel sheets for butt welding which are the steel sheets for butt welding 100 are butt-welded and the entire second coated portion 24 melted during the butt welding is incorporated in the first weld metal portion.

<Method of Manufacturing Hot Stamped Product>

In a method of manufacturing a hot stamped product of the present disclosure, the tailored blank 300 manufactured by the method of manufacturing a tailored blank S10 is hot press-formed to manufacture a hot stamped product (hot-stamping formed article).

<Method of Manufacturing Steel Pipe>

In a method of manufacturing a steel pipe of the present disclosure, the end portions of an open tube formed using the steel sheet for butt welding 100 manufactured by the method of manufacturing a steel sheet for butt welding S11 are welded to manufacture a steel pipe.

In the method of manufacturing a steel pipe of the present disclosure, a method of manufacturing a steel pipe may be performed using a steel sheet for butt welding 100 obtained by purchasing the steel sheet for butt welding 100 without manufacturing the steel sheet for butt welding 100.

In this case, in the method of manufacturing a steel pipe, the steel sheet for butt welding 100 is formed into an open tubular shape such that two end portions in the circumferential direction face to each other, and the second coated portion 24 is disposed in at least one of the two end portions. Then, the two end portions of the steel sheet for butt welding 100 are butt-welded and the two end portions are connected to each other through the third weld metal portion.

At this time, it is preferable that the entire second coated portion 24 melted during the butt welding is incorporated in the third weld metal portion.

<Method of Manufacturing Hollow Hot Stamped Product>

In a method of manufacturing a hollow hot stamped product of the present disclosure, a steel pipe manufactured by the method of manufacturing a steel pipe for butt welding is quenched to manufacture a hollow hot stamped product (hollow hot-stamping formed article).

### EXAMPLES

Examples of the third embodiment of the present disclosure will be illustrated below, but the present disclosure is not limited to the following examples.

### Example 3

First, the coated steel sheet was cut using the base steel sheet having the chemical composition shown in Table 5 under the conditions shown in steel sheets 1 to 7 shown in Table 12.

TABLE 12

| | | | Total | | | | | Distance between | | |
|---|---|---|---|---|---|---|---|---|---|---|
| | Tensile | Thickness | thickness | | Lower | | | deepest part of | | |
| | strength | of coated | of both | Specific | portion | | Width | lower region and | | |
| | after hot | steel sheet | layers | content of | depth | | of lower | end edge of | Distance | |
| Steel | press forming | t | a + b | cutting coated | x | (x/t) | region | coated steel sheet | N | |
| sheet | MPa | μm | μm | steel sheet | μm | % | μm | μm | μm | Remark |
| 1 | 1300 | 1200 | 30 | Coated steel sheet | 0 | 0.0 | 0 | — | — | Comparative |
| | | | | was cut by | | | | | | Example |
| | | | | laser processing. | | | | | | |
| 2 | 1300 | 1200 | 30 | Coated steal sheet | 30 | 2.5 | 300 | 0 | 1200 | Invention |
| | | | | was cut by shearing. | | | | | | Example |
| 3 | 1300 | 1200 | 30 | Coated steel sheet | 60 | 5.0 | 500 | 0 | 1000 | Invention |
| | | | | was cut by shearing. | | | | | | Example |
| 4 | 1300 | 1200 | 30 | Coated steel sheet | 150 | 12.5 | 700 | 0 | 800 | Invention |
| | | | | was cut by shearing. | | | | | | Example |
| 5 | 1500 | 1600 | 30 | Coated steal sheet | 80 | 5.0 | 500 | 0 | 1000 | Invention |
| | | | | was cut by shearing. | | | | | | Example |
| 6 | 1800 | 1800 | 30 | Coated steel sheet | 90 | 5.0 | 500 | 0 | 1000 | Invention |
| | | | | was cut by shearing. | | | | | | Example |
| 7 | 1300 | 1200 | 30 | Coated steel sheet | 60 | 5.0 | 1000 | 500 | 500 | Invention |
| | | | | was cut by laser | | | | | | Example |
| | | | | processing and then | | | | | | |
| | | | | partial indentation | | | | | | |
| | | | | method was performed. | | | | | | |

In Table 12, for steel sheets 1 to 7, the tensile strength after hot press forming (MPa), the coated steel sheet thickness t (μm), the total thickness of both layers (a+b) (μm), the specific content of cut coated steel sheet, the lower portion depth X (μm), value of (x/t) according to Expression (32), the width of lower region (μm), the distance between the deepest part of the lower region and the end edge of the coated steel sheet (μm), and the distance N (μm) are respectively shown.

In each of the steel sheets 1 to 7, the length of the aluminum coating layer and intermetallic compound layer cut from the end edge of the coated steel sheet (the value of (M+N) in FIG. 22) is 1500 μm.

The tensile strength after hot press forming of the steel sheets 1 to 4 and 7 is 1300 MPa. For example, the amount of Al of the steel sheets 1 to 4 and 7 is 0.02% in Table 5. The tensile strength of the steel sheet 5 is 1500 MPa and the tensile strength of the steel sheet 6 is 1800 MPa.

The steel sheets 1 to 4 and 7 each have a thickness t of 1200 μm. The thickness t of the steel sheet 5 is 1600 μm and the thickness t of the steel sheet 6 is 1800 μm.

The total thickness of both layers means a total of the thickness of the aluminum coating layer and the thickness of the intermetallic compound layer. The total thickness of both layers in each of the steel sheets 1 to 7 is 30 μm.

The specific content of cutting the coated steel sheet represents the specific content of processing the steel sheets 1 to 7.

In the steel sheet 1, the coated steel sheet is cut by laser processing, but a lower region is not formed by a partial indentation method or the like. In the steel sheets 1 to 6, the coated steel sheet was cut by shearing. In the steel sheet 7, the coated steel sheet was cut by laser processing and then a lower region was formed by a partial indentation method.

In the steel sheet 1, since the lower region is not formed, the lower portion depth x is 0 μm.

The lower portion depths x of the steel sheets 2 to 7 are respectively 30 μm, 60 μm, 150 μm, 80 μm, 90 μm, and 60 μm.

Thus, the values of (x/t) of the steel sheets 2 to 7 by Expression (32) are respectively 0.0%, 2.5%, 5.0%, 12.5%, 5.0%, 5.0%, and 5.0%.

In the steel sheet 1, since the lower region is not formed, the width of the lower region is 0 μm.

The widths of the lower regions in the steel sheets 2 to 7 are respectively 300 μm, 500 μm, 700 μm, 500 μm, 500 μm, and 1000 μm.

In the steel sheet 1, since the lower region is not formed, there is no value for the distance between the deepest part of the lower region and the end edge of the coated steel sheet.

In the steel sheets 2 to 6, since the lower region is formed by shearing, the deepest part of the lower region is located at the end edge of the coated steel sheet. Therefore, each distance between the deepest part of the lower region and the end edge of the coated steel sheet is 0 μm.

In the steel sheet 7, the distance is 500 μm.

The distance N when the aluminum coating layer and the intermetallic compound layer are cut as described above means the distance between the end edge 100B of the first coated portion 26 and the second coated portion 24. At this point, since both layers were not yet cut, the distance N when the both layers were cut by 1500 μm as scheduled was obtained.

In the steel sheet 1, since the lower region is not formed, there is no value for the distance N.

In the steel sheets 2 to 6, since the lower region is formed by shearing, the width of the lower region is the value of the distance M. Therefore, the distance N is a value obtained by subtracting the distance M from 1500 μm. Accordingly, the distances N from the steel sheets 2 to 6 are respectively 1200 μm, 1000 μm, 800 μm, 1000 μm, and 1000 μm.

In the steel sheet 7, since the lower region is formed by a partial indentation method, 500 μm, which is a value by subtracting the distance between the deepest part of the lower region and the end edge of the coated steel sheet and further a half value of the width of the lower region from 1500 is the distance N.

The steel sheet 1 in which the lower region is not formed is Comparative Example, and the steel sheets 2 to 7 in which the lower region is formed are Invention Examples (Examples).

Next, under the conditions shown in Nos. 1 to 10 shown in Table 13, the aluminum coating layers and the intermetallic compound layers of the coated steel sheets were cut. The coated steel sheets were butt-welded to manufacture a tailored blank. Then, the (static) tensile strength of the tailored blank, and the corrosion resistance after coating of the first weld metal portion of the hot stamped product were determined.

TABLE 13

| | | | | | Concentration | Corrosion | | | |
|---|---|---|---|---|---|---|---|---|---|
| | | | | | of aluminum | resistance | | | |
| | | Cutting | | | contained in | after | | | |
| | | depth | | Distance | first weld | coating of | | | |
| | Set of | y | (y/t) | M | metal portion | first weld | Tensile | Overall | |
| No. | steel sheets | μm | % | μm | % by mass | metal portion | strength | determination | Remark |
| 1 | Steel sheets 1 | 0 | 0.0 | 1500 | 1.52 | A | D | D | Comparative |
| | | | | | | | | | Example |
| 2 | Steel sheets 1 | 10 | 0.8 | 1500 | 1.01 | A | D | D | Comparative |
| | | | | | | | | | Example |
| 3 | Steel sheets 1 | 50 | 4.2 | 0 | 0.02 | D | A | D | Comparative |
| | | | | | | | | | Example |
| 4 | Steel sheets 2 | 30 | 2.5 | 270 | 0.43 | A | A | A | Invention |
| | | | | | | | | | Example |
| 5 | Steel sheets 2 | 100 | 8.3 | 0 | 0.02 | D | A | D | Comparative |
| | | | | | | | | | Example |
| 6 | Steel sheets 3 | 50 | 4.2 | 240 | 0.39 | A | A | A | Invention |
| | | | | | | | | | Example |
| 7 | Steel sheets 4 | 50 | 4.2 | 470 | 0.74 | A | A | A | Invention |
| | | | | | | | | | Example |
| 8 | Steel sheets 5 | 50 | 3.1 | 270 | 0.34 | A | A | A | Invention |
| | | | | | | | | | Example |
| 9 | Steel sheets 6 | 50 | 2.8 | 290 | 0.33 | A | A | A | Invention |
| | | | | | | | | | Example |
| 10 | Steel sheets 7 | 50 | 4.2 | 470 | 0.74 | A | A | A | Invention |
| | | | | | | | | | Example |

The aluminum coating layer and the intermetallic compound layer were cut with an end mill. As the end mill, a tool bottom blade having a diameter φ of 6 mm and a tip end radius of 0.5 mm was used. The rotational rate of the end mill was set to 40000 rpm and the feed rate was set to 6 in/min so as to obtain 1.5 mm flat cutting.

In Table 13, for Nos. 1 to 10, the sets of steel sheets, the cutting depth y (μm), the value of (y/t) according to Expression (34), the distance M, the concentration of aluminum contained in the first weld metal portion, the corrosion resistance after coating of the first weld metal portion, the tensile strength, and the overall determination are respectively shown.

The fact that the set of steel sheets for No. 1 are the steel sheets 1 means that a pair of steel sheets 1 in Table 12 are used.

The sets of steel sheets for Nos. 2 and 3 are the steel sheets 1. The sets of steel sheets for Nos. 4 and 5 are the steel sheets 2. The sets of steel sheets 7 for Nos. 6 to 10 are the steel sheets 3, respectively.

The fact that the cutting depth y for No. 1 is 0 μm means that in each steel sheet 1, without cutting the aluminum coating layer and the intermetallic compound layer, in a range of 1500 μm in which the aluminum coating layer and the intermetallic compound layer are scheduled to be cut, the aluminum coating layer and the intermetallic compound layer remain as it is.

The cutting depths y of Nos. 2 to 10 are 10 μm, 50 μm, 30 μm, 100 μm, 50 μm, 50 μm, 50 μm, 50 μm, and 50 μm, respectively. The first surface and the second surface of each coated steel sheet were respectively cut at the cutting depth y. However, since the lower region is not formed on the second surface of the coated steel sheet, the second surface of the coated steel sheet is cut and then the second coated portion is not formed on the second surface of the coated steel sheet.

Since the total thicknesses of both layers of each of the steel sheets 1 to 7 is 30 μm, when the cutting depth y is 30 μm, the base steel sheet is not cut and both the aluminum coating layer and the intermetallic compound layer are cut.

Thus, the value of (y/t) obtained by Expression (34) for Nos. 1 to 10 are respectively 0.0%, 0.8%, 4.2%, 2.5%, 8.3%, 4.2%, 4.2%, 3.1%, 2.8%, and 4.2%.

The distance M means the distance from the end edge of the steel sheet for butt welding to the end edge opposite to the end edge of the steel sheet for butt welding in the second coated portion as described above.

In No. 1, in a range of 1500 μm in which the aluminum coating layer and the intermetallic compound layer are scheduled to be cut, the aluminum coating layer and the intermetallic compound layer remain as it is. Thus, the distance M is 1500 μm.

In No. 2, since a part of both layers having a thickness of 30 μm before cutting remains, the distance M is 1500 μm.

In No. 3, since the lower region is not formed in the steel sheet 1 and both the aluminum coating layer and the intermetallic compound layer are cut, the distance M is 1500 μm.

In Nos. 4 to 10, the distances M are respectively 270 μm, 0 μm, 240 μm, 470 μm, 270 μm, 290 μm, and 470 μm.

The concentration of aluminum contained in the first weld metal portion in Nos. 1 to 10 was measured using, for example, the above-mentioned electron beam microanalyser. The concentrations of aluminum of Nos. 1 to 10 are respectively 1.52% (mass), 1.01%, 0.02%, 0.43%, 0.02%, 0.39%, 0.74%, 0.34%, 0.33%, and 0.74%.

<Evaluation>

(Test for Corrosion Resistance after Coating)

The first weld metal portion was tested in the same manner as in Example 1 of the first embodiment. The determination criterion are the same as in Example 1.

In Nos. 3 to 5, it was found that the evaluation of the corrosion resistance after coating of the first weld metal portion was “D” (inferior).

In Nos. 1, 2, 4, and 6 to 10, it was found that the evaluation of the corrosion resistance after coating of the first weld metal portion was “A” (excellent).

(Tensile Strength)

From the hot stamped product obtained above, a dumbbell-shaped test piece having a welded portion was collected as a test piece for a tensile strength test.

The test piece was collected to have a parallel portion distance of 20 mm and a parallel portion width of 15 mm and to have a weld line in the center portion of the parallel portion over the entire length so as to be orthogonal to the longitudinal direction. Using this test piece, a tensile strength test was conducted.

—Determination Criterion—

A: Cutting was performed in the steel sheet for butt welding (base steel sheet).

D: Cutting was performed in the weld metal portion or the like other than the steel sheet for butt welding (base steel sheet).

In Nos. 1 and 2, it was found that the evaluation of the tensile strength was “D” (inferior).

In Nos. 3 to 10, it was found that the evaluation of the tensile strength was “A” (excellent).

When the evaluation of the corrosion resistance after coating of the first weld metal portion is “A” and the evaluation of the tensile strength is “A”, the overall determination evaluation is “A” (excellent). When at least one of the evaluation of the corrosion resistance after coating of the first weld metal portion or the evaluation of the tensile strength is “D”, the overall determination evaluation is “D” (inferior).

In Nos. 1 and 3 to 5, it was found that the overall determination evaluation was “D” and in Nos. 4, and 6 to 10, the overall determination evaluation was “A”.

In the first weld metal portion formed when a tailored blank is manufactured by butt-welding two steel sheets for butt welding having the same thickness, and the third weld metal portion formed when a steel pipe is manufactured by welding the end portions of an open tube formed using the steel sheet for butt welding, the relationships between the specifications of the end portion of the steel sheet for butt welding and the concentrations of aluminum contained in the first and third weld metal portions are equal to each other. Therefore, examples in which the thicknesses of the coated steel sheet 1 and the coated steel sheet 2 in the first and second embodiments are the same are examples relating to the concentration of aluminum contained in the third weld metal portion when a steel sheet for butt welding and a steel pipe are manufactured using the coated steel sheet. The same applies to examples of Nos. 1 to 10 in the third embodiment.

Conventionally, in a case where an aluminum coated steel sheet is butt-welded, an intermetallic compound is formed due to an increase in the content of aluminum in the weld metal. Here, in a case where mechanical stress is applied, cracks initiate and the strength of the tailored blank is deteriorated. Alternatively, in a heating step before hot stamping, the aluminum solid-soluted in the weld metal is inhibits austenite transformation in the region and thus deteriorates the strength of the hot stamp forming body. In the steel sheet according to the present disclosure, in the steel sheet end portion region, an exposed layer excluding the intermetallic compound layer is provided. After the steel sheets are butt-welded, in this exposed portion, the intermetallic compound in the welded portion of the tailored blank is eliminated and the above-mentioned strength deterioration is prevented.

Also, according to the steel sheet according to the present disclosure, during butt welding, all Al contained in the second coated portion (aluminum coating layer) provided on the end edge side is introduced into the weld metal portion. That is, the Al concentration of the weld metal portion of the tailored blank is adjusted by the amount of Al of the second coated portion. Thus, the corrosion resistance of the weld metal is improved. In other words, by adjusting the size of the second coated portion, the Al concentration in the weld metal portion of the tailored blank can be adjusted, and the corrosion resistance can be easily controlled. Further, the second coated portion of the present disclosure includes an aluminum coating layer and does not require a large dimension. For example, even when the width of the second coated portion is equal to or less than half of the width of the weld metal portion to be formed in the tailored blank (for example, 500 μm), the amount of Al sufficient to improve the corrosion resistance of the weld metal portion can be introduced into the weld metal portion.

According to the present disclosure, the entire second coated portion is incorporated in the weld metal portion and the first exposed portion adjacent to the second coated portion becomes an exposed portion between the weld metal portion and the first coated portion in the tailored blank. That is, by providing the first exposed portion at the position adjacent to the second coated portion including the aluminum coating layer, it is possible to form the first exposed portion between the weld metal portion and the first coated portion while adding a desired amount of Al to the weld metal portion simply by performing butt welding. That is, by butt-welding the steel sheet of the present disclosure, it is possible to form a tailored blank having excellent corrosion resistance and strength.

### INDUSTRIAL APPLICABILITY

The steel sheet, the tailored blank, the hot stamped product, the steel pipe, the hollow hot stamped product, the method of manufacturing a steel sheet, the method of manufacturing a tailored blank, the method of manufacturing a hot stamped product, the method of manufacturing a steel pipe, and the method of manufacturing a hollow hot stamped product of the present disclosure can be suitably used for maintaining the corrosion resistance after coating and fatigue strength of the weld metal portion.

### BRIEF DESCRIPTION OF THE REFERENCE SYMBOLS

12, 112: base steel sheet
14, 114: aluminum coating layer
16, 16: intermetallic compound layer
22, 122: first exposed portion
23: second exposed portion
24, 124: second coated portion
26, 126: first coated portion
100, 102, 103, 104, 110, 120, 200: steel sheet for butt welding
100A: end edge
150: first weld metal portion
300: tailored blank
312: third weld metal portion
F1: first direction
F3: third direction (second direction)
T1: virtual plane
R2, R3, R7, R8: lower region
S11: steel sheet for butt welding production step (method of manufacturing steel sheet)
S12: coated steel sheet production step
S14: removal step
S15: lower portion forming step
S17: cutting step (elimination step)

1. A steel sheet comprising:
a first coated portion in which an intermetallic compound layer and an aluminum coating layer are provided on a surface of a base steel sheet in order from the base steel sheet;
a first exposed portion in which the base steel sheet is exposed; and
a second coated portion in which the intermetallic compound layer and the aluminum coating layer are provided on a surface of the base steel sheet in order from the base steel sheet,
wherein in a first direction which is perpendicular to a thickness direction of the steel sheet and is directed from the first coated portion to one end edge of the steel sheet, the first coated portion, the first exposed portion, the second coated portion, and the end edge of the steel sheet are disposed in this order on at least one surface of the base steel sheet, and
wherein at least the first coated portion, the first exposed portion, and the end edge of the steel sheet are disposed in this order on the other surface of the base steel sheet in the first direction.

2. The steel sheet according to claim 1,
wherein the first coated portion, the first exposed portion, the second coated portion, and the end edge of the steel sheet are disposed in this order on the other surface of the base steel sheet in the first direction.

3. The steel sheet according to claim 1,
wherein in the first direction, the second coated portion exists in a range of 0.5 mm from the end edge of the steel sheet.

4. The steel sheet according to claim 1,
wherein the base steel sheet includes, as a chemical composition, % by mass,
C: 0.02% to 0.58%,
Mn: 0.20% to 3.00%,
Al: 0.005% to 0.20%,
Ti: 0% to 0.20%,
Nb: 0% to 0.20%,
V: 0% to 1.0%,
W: 0% to 1.0%,
Cr: 0% to 1.0%,
Mo: 0% to 1.0%,
Cu: 0% to 1.0%,
Ni: 0% to 1.0%,
B: 0% to 0.0100%,
Mg: 0% to 0.05%,
Ca: 0% to 0.05%,
REM: 0% to 0.05%,
Bi: 0% to 0.05%,
Si: 0% to 2.00%,
P: 0.03% or less,
S: 0.010% or less,
N: 0.010% or less, and
a remainder: Fe and impurities.

5. The steel sheet according to claim 1,
wherein an average thickness of the aluminum coating layer at the first coated portion is 8 μm to 40 μm, and an average thickness of the intermetallic compound layer at the first coated portion is 3 μm to 10 μm.

6. The steel sheet according to claim 2,
wherein the second coated portion is provided on only one surface of the steel sheet, and a width c μm of the second coated portion in the first direction and a thickness f μm of the aluminum coating layer in the second coated portion satisfy Expression (1)
385.48f⁻⁰⁹¹⁴≤c≤500 (1)

7. The steel sheet according to claim 2,
wherein the second coated portion is provided on each of both surfaces of the steel sheet, and a width of c μm of the second coated portion in the first direction and a thickness of f μm of the aluminum coating layer in the second coated portion satisfy Expression (2)
359.65f^{-1.129}≤c≤9368f^{-0.904} (2)

8. The steel sheet according to claim 1,
wherein in the first direction, a width of the second coated portion is smaller than a width of the first exposed portion.

9. The steel sheet according to claim 1,
wherein the second coated portion is provided in a lower region on the surface of the base steel sheet located on an inner side of the base steel sheet in a thickness direction from a virtual plane obtained by extending a surface of the first exposed portion in the first direction.

10. The steel sheet according to claim 1,
wherein the end edge of the steel sheet and the second coated portion are adjacent to each other in the first direction.

11. The steel sheet according to claim 1,
wherein in the first direction, a second exposed portion in which the base steel sheet is exposed is provided between the end edge of the steel sheet and the second coated portion.

12. The steel sheet according to claim 11,
wherein in the first direction, a width of the second exposed portion is smaller than a width of the first exposed portion.

13. The steel sheet according to claim 11,
wherein in the first direction, a width of the second exposed portion is 0.01 mm or more, and a width of the first exposed portion is 0.05 mm or more.

14. A tailored blank comprising:
a first weld metal portion; and
at least two steel sheet portions connected to each other through the first weld metal portion,
wherein each of the at least two steel sheet portions includes
a first coated portion in which an intermetallic compound layer and an aluminum coating layer are provided on a surface of a base steel sheet in order from the base steel sheet, and
a first exposed portion in which the base steel sheet is exposed, and
wherein in each of the steel sheet portions, in a second direction which is perpendicular to a thickness direction of each steel sheet portion and is directed from the first coated portion to the first weld metal portion, the first coated portion, the first exposed portion, and the first weld metal portion are disposed in this order on the same plane on both surfaces of the base steel sheet.

15. The tailored blank according to claim 14,
wherein a concentration of aluminum contained in the first weld metal portion is 0.05% by mass to 1% by mass.

16. A hot stamped product comprising:
a first intermetallic compound portion in which a first intermetallic compound layer is provided on a surface of a first base steel sheet;
a third exposed portion in which the first base steel sheet is exposed;
a second weld metal portion in which a concentration of aluminum contained is 0.05% by mass to 1% by mass;
a fourth exposed portion in which a second base steel sheet is exposed; and
a second intermetallic compound portion in which a second intermetallic compound layer is provided on a surface of the second base steel sheet,
wherein the first intermetallic compound portion, the third exposed portion, the second weld metal portion, the fourth exposed portion, and the second intermetallic compound portion are disposed in this order along the surface of the first base steel sheet and the surface of the second base steel sheet.

17. A steel pipe comprising:
a third weld metal portion; and
a third steel sheet which is formed in an open tubular shape in which two end portions in a circumferential direction face each other, and in which the two end portions are connected to each other through the third weld metal portion,
wherein each of the two end portions of the third steel sheet includes
a first coated portion in which an intermetallic compound layer and an aluminum coating layer are provided on both surfaces of a base steel sheet in order from the base steel sheet, and
a first exposed portion in which the base steel sheet is exposed, and
wherein in the circumferential direction, the first coated portion, the first exposed portion, and the third weld metal portion are disposed in this order.

18. The steel pipe according to claim 17,
wherein a concentration of aluminum contained in the third weld metal portion is 0.05% by mass to 1% by mass.

19. A hollow hot stamped product comprising:
a third intermetallic compound portion in which a third intermetallic compound layer is provided on a surface of a third base steel sheet;
a fifth exposed portion in which the third base steel sheet is exposed;
a third weld metal portion in which a concentration of aluminum contained is 0.05% by mass to 1% by mass,
a sixth exposed portion in which a fourth base steel sheet is exposed, and
a fourth intermetallic compound portion in which a fourth intermetallic compound layer is provided on a surface of the fourth base steel sheet,
wherein the third intermetallic compound portion, the fifth exposed portion, the third weld metal portion, the sixth exposed portion, and the fourth intermetallic compound portion are disposed in this order along each of both surfaces of the third base steel sheet and each of both surfaces of the fourth base steel sheet.

20. A method of manufacturing a steel sheet for manufacturing a steel sheet, the method comprising:
performing
a coated steel sheet production step of manufacturing a coated steel sheet in which an intermetallic compound layer and an aluminum coating layer are provided on a surface of a base steel sheet in order from the base steel sheet; and
a removal step of forming a first exposed portion in which the base steel sheet is exposed by removing a part of the aluminum coating layer and the intermetallic compound layer, a first coated portion in which the intermetallic compound layer and the aluminum coating layer remain on a surface of the base steel sheet in order from the base steel sheet, and a second coated portion in which the intermetallic compound layer and the aluminum coating layer remain on a surface of the base steel sheet,
wherein in the removal step, in a first direction which is perpendicular to a thickness direction of the coated steel sheet and is directed from a center portion of the coated steel sheet to one end edge of the coated steel sheet in plan view, the first coated portion, the first exposed portion, the second coated portion, and the end edge of the coated steel sheet are disposed in this order on at least one surface of the base steel sheet, and
wherein in the first direction, at least the first coated portion, the first exposed portion, and the end edge of the coated steel sheet are disposed in this order on the other surface of the base steel sheet.

21. The method of manufacturing a steel sheet according to claim 20,
wherein in the removal step, in the first direction, the first coated portion, the first exposed portion, the second coated portion, and the end edge of the coated steel sheet are disposed on the other surface of the base steel sheet in this order.

22. The method of manufacturing a steel sheet according to claim 20,
wherein in the removal step, a step of mechanically removing the aluminum coating layer and the intermetallic compound layer is performed.

23. The method of manufacturing a steel sheet according to claim 22,
wherein in the step of the mechanically removing the aluminum coating layer and the intermetallic compound layer, an elimination step of removing the aluminum coating layer and the intermetallic compound layer by cutting or grinding is performed.

24. The method of manufacturing a steel sheet according to claim 23,
wherein in the elimination step, the aluminum coating layer and the intermetallic compound layer are removed by cutting using an end mill.

25. The method of manufacturing a steel sheet according to claim 23,
wherein in the step of the mechanically removing the aluminum coating layer and the intermetallic compound layer, before the elimination step, a lower portion forming step of forming a lower region on a surface of the base steel sheet of the coated steel sheet by deforming a part of the coated steel sheet by cutting or compressing the coated steel sheet is performed,
wherein when a direction which is perpendicular to a thickness direction of the coated steel sheet and is directed from a center portion of the coated steel sheet to one end edge of the coated steel sheet in plan view is set to a first direction,
the lower region is a region located on an inner side of the base steel sheet in the thickness direction of the coated steel sheet from a virtual plane obtained by extending a surface of an undeformed portion of the base steel sheet in the first direction, and
wherein in the elimination step, at least the aluminum coating layer and the intermetallic compound layer existing on an outer side of the coated steel sheet in the thickness direction from the virtual plane are cut to form the second coated portion on the lower region.

26. The method of manufacturing a steel sheet according to claim 25,
wherein when a thickness per one surface of the aluminum coating layer is a μm,
a thickness per one surface of the intermetallic compound layer is b μm,
a thickness of the coated steel sheet is t μm,
a deepest lower portion depth of the lower region is x μm,
the lower portion depth represents a distance from the virtual plane to the surface of the base steel sheet in the lower region,
a depth of a region cut in the elimination step in the thickness direction of the coated steel sheet is y μm, and
a distance between the first coated portion and the second coated portion is N μm,
Expressions (5) to (9) are satisfied
10≤a+b<50 (5)
2%≤(x/t)≤15% (6)
a+b<y (7)
(y/t)≤7% (8)
N≥200 (9)

27. The method of manufacturing a steel sheet according to claim 25,
wherein in the lower portion forming step, the coated steel sheet is cut by shearing or blanking to form the lower region.

28. The method of manufacturing a steel sheet according to claim 25,
wherein in the lower portion forming step, the lower region is formed on each of both surfaces of the coated steel sheet.

29. A method of manufacturing a tailored blank for manufacturing a tailored blank including at least two steel sheets, at least one of which is the steel sheet according to claim 1, and obtained by butt-welding the at least two steel sheets and connecting the at least two steel sheets through a first weld metal portion, the method comprising:
butt-welding end edges having the second coated portion in the steel sheets, which are the steel sheets, to incorporate the entire second coated portion melted during butt welding in the first weld metal portion.

30. A method of manufacturing a hot stamped product comprising:
hot press-forming the tailored blank according to claim 14 to form a hot stamped product.

31. A method of manufacturing a steel pipe comprising:
forming the steel sheet according to claim 1 into an open tubular shape such that two end portions in a circumferential direction face to each other and the second coated portion is disposed in at least one of the two end portions; and
butt-welding the two end portions of the steel sheet to connect the two end portions through a second weld metal portion to incorporate the entire second coated portion melted during butt welding in the second weld metal portion.

32. A method of manufacturing a hollow hot stamped product comprising:
quenching the steel pipe according to claim 17 to manufacture a hollow hot stamped product.
